(19) United States
(12) Patent Application Publication
(10) Pub. No.: US 2011/0055209 A1
(43) Pub. Date: Mar. 3, 2011

(54) SYSTEM AND METHOD FOR DELIVERING CONTENT AND ADVERTISMENTS

(76) Inventors: Anthony Novac, Toronto (CA); Patrick Keefe, Halifax (CA); Suhail Mirza, Toronto (CA); Lucien Benacem, Toronto (CA)

(21) Appl. No.: 12/528,376

(22) PCT Filed: Feb. 22, 2008
(86) PCT No.: PCT/CA08/00354

§ 371 Date: Nov. 10, 2010

Related U.S. Application Data
(60) Provisional application No. 60/891,301, filed on Feb. 23, 2007.
(60) Provisional application No. 60/981,003, filed on Oct. 18, 2007.

(51) Int. Cl. G06F 17/30

(52) U.S. Cl. 707/737; 707/E17.089

(57) ABSTRACT

A processing system operable with a computing device, comprising one or more of a converter component for converting input data into a desired format for further processing, a parsing component for parsing input data into clusters having one or more desired characteristics, a notes component for receiving user inputs for insertion at desired locations within an input, an autosummary component for summarising input data, an ad component for adding advertisements to input data, a renderer component for displaying the resulting processed input data in various forms, and configurable settings to alter operation of the processing system.

### PRIORITY CLAIM AND INCORPORATION BY REFERENCE

This application claims the benefit of and incorporates by this reference U.S. provisional patent applications 60/891,301 entitled SYSTEM AND METHOD FOR PROCESSING ELECTRONIC TEXT and filed 23 Feb., 2007; 60/981,003 entitled SYSTEM AND METHOD FOR DELIVERING CONTENT AND ADVERTISEMENTS and filed 18 Oct. 2007; including all appendices and other documents attached thereto.

### FIELD OF THE INVENTION

The invention generally relates to improved techniques for advertising and in particular for delivering content and advertisements.

### BACKGROUND OF THE INVENTION

Word processing applications are well known and are becoming increasingly robust and helpful in performing everyday tasks. However, although these applications have greatly improved with respect to producing and modifying documents, they have not sufficiently developed with respect to enhancing a user's reading efficiency or note making with respect to such documents. Reading efficiency enhancement is particularly desirable for use with cell phones and PDAs where small screen sizes make it difficult to read documents. Note making in such applications is also highly desirable.

With respect to note making, known systems allow comments to be associated with particular portions of text by a particular user. However, such systems do not efficiently provide for notes to be made on a variety of input documents such as Word, Adobe or the like nor do such systems allow for notes to be added when using small portable devices such as cell phones and PDAs. Also, known systems do not optimally permit comments or notes to be made, organized, sorted, viewed and read in a hierarchical manner by different users and optionally separate from the text of the document. In short, although the raw ability to create comments and notes exist, prior systems fail to make these valuable notes optimally helpful to a user with a variety of document formats.

Cell phones, PDA's and other mobile devices are becoming increasingly popular as devices for personal communication, information retrieval and entertainment. One problem with such devices is how to deliver content and advertisements to the relatively small screens provided with such devices. An additional problem, both with mobile devices and personal computers, is providing a user with information relating to their location within a document when they are reading or viewing a document. Further still, it may be desirable to provide a summary of a document and/or identify key items within a body of given text, either to a mobile device or a personal computer, to facilitate review of a document.

It is therefore desirable to have systems and methods that improve upon known systems for processing and displaying electronic inputs for enhancing reading efficiency and for adding comments, notes and flags to electronic documents in a variety of formats. It is therefore also desirable to have systems and methods that improve upon known systems for processing and displaying electronic inputs and delivering such content together with advertisements for display on a display screen.

### SUMMARY OF THE INVENTION

In one aspect, the invention provides a processing system operable with a computing device, the system comprising a converter component for converting input data into a desired format where required for further processing, a parsing component for parsing said input data in said desired format into clusters having one or more desired characteristics and an advertising component for receiving and delivering advertising inputs for display together with said clusters on said computing device.

In another aspect, the invention provides a processing system operable with a computing device, the system comprising a parsing component for parsing input data into clusters having one or more desired characteristics and an advertising component for delivering advertising inputs to a display device together with said clusters.

In another aspect the invention provides an advertisement system operable with a computing device, the system comprising a content delivery component for receiving input data for delivery to a display device and for parsing said input data into clusters for display upon said display device and an advertising component for delivering advertising inputs to said display device together with said clusters.

In another aspect, the invention provides a signal comprising a content component for displaying content in clusters on a display device and an advertising component for displaying advertising on said display device contemporaneously with said content.

In another aspect, the invention provides a processing system operable with a computing device, the system comprising a converter component for converting input data into a desired format where required for further processing, a parsing component for parsing said input data in said desired format into clusters having one or more desired characteristics and a notes component for receiving user inputs for insertion at desired locations within said input data in said desired format.

In another aspect, the invention provides a processing system operable with a computing device, the system comprising a converter component for converting input data into a desired format where required for further processing and a parsing component for parsing the input data in said desired format into clusters having one or more desired characteristics.

In another aspect the invention provides a processing system operable with a computing device, the system comprising a converter component for converting input data into a desired format where required for further processing, and a notes component for receiving user inputs for insertion at desired locations within the input data in said desired format.

### BRIEF DESCRIPTION OF THE DRAWINGS

FIG. 1 is a block diagram of a system in accordance with an embodiment of the present invention.

FIGS. 2A, 2B and 2C show different display formats for a personal computer implementation of a system in accordance with an embodiment of the present invention with FIG. 2A showing a compact view, FIG. 2B showing a full scale view and FIG. 2C showing a compact view as a plug-in software component.

FIG. 3 shows a display for a personal digital assistant implementation of the system in accordance with an embodiment of the present invention.

FIG. 4 shows a display for a personal computer implementation of a system in accordance with an embodiment of the present invention showing a compact view with multiple clusters present on the display.

FIG. 5 is a flow chart of the functioning of the system in accordance with an embodiment of the present invention.

FIGS. 6-10 form a detailed flow chart of the system in accordance with an embodiment of the present invention.

FIGS. 11A, 11B and 11C are flow charts of the functioning of the notes component in accordance with an embodiment of the present invention, with FIG. 11A showing a process for creating a note or setting a flag, FIG. 11B showing a process for associating a flag or a note and FIG. 11C showing the operation of the notes user interface.

FIG. 12A is a display for a personal computer implementation of the notes component in macroscopic view in accordance with an embodiment of the present invention and FIG. 12B is a display for a personal computer implementation in notes view in accordance with an embodiment of the present invention.

FIGS. 13A, 13B and 13C show different displays of a computing device implementation of the notes component during three stages of reading and note making in accordance with an embodiment of the present invention.

FIGS. 14A and 14B show two different option screens for a computing device implementation of the system in accordance with an embodiment of the present invention.

FIG. 15 is a diagram of a system in accordance with an alternative embodiment of the present invention.

FIG. 16 shows a display device having content and advertising displayed on a display screen in accordance with an embodiment of the present invention.

FIG. 17 is a diagram of an advertising delivery system in accordance with an alternative embodiment of the present invention.

FIG. 18 is a flow chart showing an advertisement delivery process in accordance with an embodiment of the present invention.

FIG. 19 is a block diagram of an alternate embodiment of system 20 in accordance with an embodiment of the present invention.

FIGS. 20-23 are flow charts of a process for autosummarising a document in accordance with an embodiment of the present invention.

FIGS. 24-35 are flowcharts of a process for forming clusters from a document or portion of text.

FIG. 36 is a block diagram of system 20 in accordance with an embodiment of the present invention.

FIG. 37 is a block diagram of system 20 in accordance with an embodiment of the present invention.

FIG. 38 is a display for an implementation of the autosummary component in accordance with an embodiment of the present invention.

FIG. 39 is a display for an implementation of points of interest from in accordance with an embodiment of the present invention.

FIG. 40 is a display for an implementation of a system in accordance with an embodiment of the present invention.

FIGS. 41a and 41b show two different option screens for a computing device implementation of the system in accordance with an embodiment of the present invention.

### DETAILED DESCRIPTION OF THE INVENTION

### System Overview

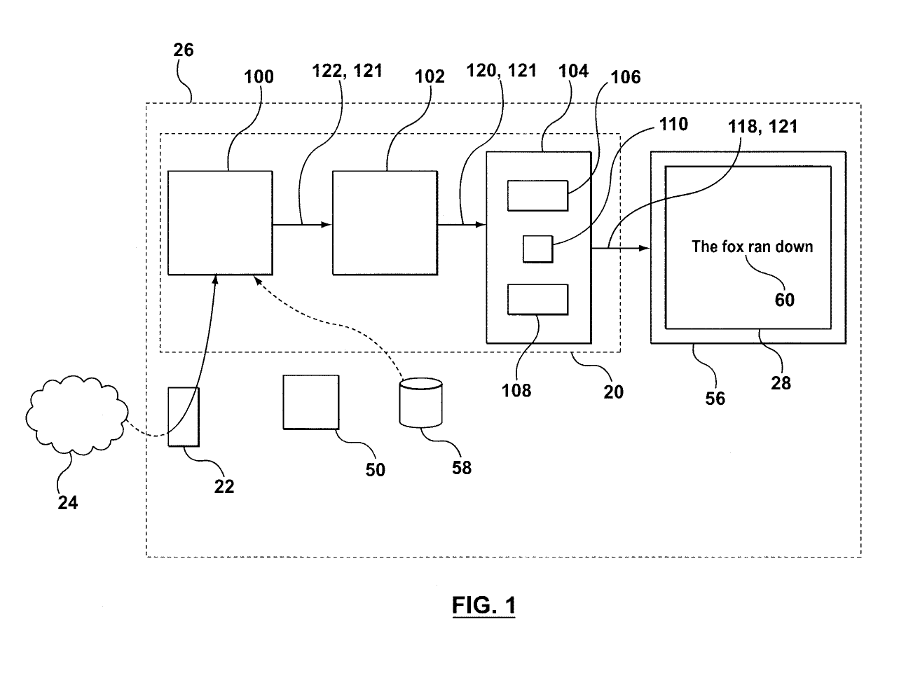

Referring to FIG. 1, a processing system in accordance with an embodiment of the present invention is shown generally at 20. The system includes a parsing component for parsing and displaying electronic text and a notes component for flagging text and making notes in association with electronic text. The parsing and notes components may be utilized together and be operable on a computing device 26 or each may be utilized as stand-alone components.

“Text” is defined herein to mean any input data that is capable of being processed in accordance with the present invention, including words, letters, numbers, symbols, punctuation, and any other characters as well as “identifiers” where identifiers are identifiers of files, attachments, links or the like, such as pictures, video clips, audio clips, hyperlinks, email addresses, and the like. “Text” and “input data” are used interchangeably within this application and are intended to have the same meaning unless noted otherwise.

“Input data source” is defined herein to mean a document, file, stream or any other source of text or input data. “Input data source”, “document”, “file” and “stream” are used interchangeably within this application and are intended to have the same meaning unless noted otherwise. Input data source file formats include, but are not limited to, Microsoft Word (trademark), Adobe Acrobat (trademark), web pages (HTML or other), email message files, text files, Rich Text Format files, and other system documents in various other formats. Input data source may be streaming data as well. Such streaming data may originate from web sites, TV broadcasts, radio broadcasts or any other streaming content providers. Input data sources may be obtained from storage, or from a communication network via a communication interface, or may be obtained, via a communication interface, from an external source that may include a USB device, a memory card, a CD-ROM or a peripheral device.

A “chunk” is defined herein to mean all or a portion of an input data source. A “cluster” is defined herein to mean all or a portion of a chunk once parsed in accordance with predetermined parsing rules.

Computing device 26 may include a variety of computing and/or display devices such as personal computers (PC) with monitors or displays, personal digital assistants (PDA), mobile devices, mobile phones, email reading devices, ePapers, eBooks, digital electronic displays (such as electronic paper, LCD, Digital Light Processing (DLP), Laser Projection Display, and/or plasma screen, Plasma Display Panel), analog electronic displays (such as Cathode Ray Tube (CRT) display monitor), televisions, digital projectors (also known as Digital Projection Display Systems, including LCD projection and digital light processing), projection displays (such as movie or slide projectors), electronic advertising/messaging medium (e.g. electronic billboards), holographic displays, portable media players (such as IPods (trademark)), kiosk displays, or any other electronic display devices. The invention thus provides for, among other things, the parsing of text into clusters for display using any of the above noted computing devices 26.

Computing device 26 preferably has a processor 50, storage 58 and input device 100 that allow operations to be carried out on the computing device 26 and for input data sources to be received, processed and (optionally) stored by the computing device 26.

Storage 58 may be, for example, a hard disk or ROM, RAM or a memory card introduced to computing device 26 via an expansion port or slot (not shown). Storage 58 may store an input data source or temporarily store a data source such as a stream that is to be converted to native format, and may store the native format file after the processor 50 has converted it. Storage 58 may receive, via the processor 50, a file or other input data source from a disc, scanner, USB connection, memory card, or a peripheral device (all not shown) or from a communication network 24. The manner by which storage 58 receives the file or other input data source depends largely on the various means of inputting data into the computing device 26.

Processor 50 may be a processor, microprocessor, or any other system providing logic or processing capability to a computing device 26. The choice of processor 50 for a given computing device 26 may be determined based on computational power desired, size, cost or compatibility with other components of computing device 26.

Processor 50 accesses a file, stream data or other input data source optionally from storage 58 (though it may be from a disc, scanner, USB connection etc as discussed above), and optionally converts it to a native format. The processor parses the text on the data source such as described below into clusters of information and displays the clusters (via UI 28 on display 56) in a manner that is intended to enhance reading efficiency, or displays the text, via UI 28 on display 56, and in addition or alternatively allows the user to flag text and add comments or notes directly into the text.

Input device 100 receives the input data source from, for example, storage 58 or from communication device 22 and provides it to converter component 102, via link 122/121. Input device 100 may assemble the input data source, or perform other operations for provision to converter component 102. It will be appreciated that input device 100 may be a hardware component or may be implemented largely in software. As such, the receipt of the input data source, from storage 58 or communication device 22, may similarly be hardware or software based. It is to be understood that although input device 100 acts to provide the input data source to converter component 102, in an alternate embodiment, storage 58 or communication device 22 may communicate directly with converter component 102 if the input data source is appropriate to directly provide to converter component 102.

Links 118, 120, 122/121 are used to communicate between various components of the system software components as shown. Such links 118, 120, 122/121 are preferably implemented in software and are therefore not physical links, but may be connections, sockets or the like. Links 118, 120, 122/121 are not required to be in software however, and may be used to connect components that are not geographically closely located or that may be viewed as being remote from the computing device 26 on which the system software components are located.

### Converter Component

All or a portion of any input data source or input data may be provided to converter component 102 via link 122/121 for example by highlighting a portion of the file that the user wishes to view using the system 20, by placing the cursor in any part of the document or input data at which point the system 20 will begin directly after the position of the cursor, or by the user dragging and dropping the file into a user interface component of the system software component architecture (not shown) or upon simply selecting a command for parsing text and then system 20 knows to begin the conversion process, if necessary, prior to initiating the parsing process.

Converter components 102 accept the input data source from link 122/121. Converter components 102 may then convert the input data source into system internal format 110 (such as SIF 9a) and provide the output, via link 120/121, to core components 104. System internal format 110 may be specific to the system or may be a known format, such as a Rich Text Format file (.rtf), XML file, or a text file (.txt). The process of conversion may be accomplished using custom developed software or available software tools such as Microsoft .NET (trademark) components including Microsoft.Office.Interop.Word or open source tools including PDFBox. The PDFBox may be used to convert Adobe (trademark) documents, the Microsoft.Office.Interop.Word may be used to convert Word (trademark) documents, and other known tools may be used to convert files of other types. Tools are commercially available for many document types. While such known tools are available for document conversion, they have not previously been utilized as part of an overall system for converting and further processing in a user-friendly manner.

After such conversion, the file may be put into a system internal format 110 such as with the .NET component Microsoft.Office.Interop.Word which may be used to save the file into Rich Text Format. Such conversion maintains the formatting of the text or document that was converted. Such maintenance of formatting may not be maintained when the file is being read using the parsing process. In such operation, the formatting may optionally be removed to improve readability.

The converter component 102 provides the converted file, now in system internal format 110, to core components 104. It may provide the entire converted file at one time, or it may provide the file in chunks with the core components receiving the converted chunks and assembling the file itself. Alternatively, the converter component 102 may provide chunks to the core components 104 and the core components 104 may immediately begin processing the chunks separately, to improve efficiency. While converter component 102 may be required prior to providing the input data to core components 104, the input data may already be in an acceptable format for core components 104, in which case converter component 102 may not need to be used.

### Overview of Core Components

Core components 104 process the system internal format 110 through the use of one or both of parsing component 106 and notes component 108. Core components 104 may be executed by and located on a computing device 26, and may be performed substantially by a software application or multiple software applications. Core components 104 are shown to include both parsing component 106 and notes component 108. However, parsing component 106 and notes component 108 may be separate applications or modules from each other. They also may be separate from core components 104 and do not rely on each other or core components 104 to function. An application of the present inventions could require the functionality provided by both parsing component 106 and notes component 108 or either separately.

In general terms, notes component 108 takes the system internal formatted text 110, presents it for display to the user via UI 28 on the display 56 of the computing device 26, and provides various methods by which a user can add notes, comments or flags to the system internal formatted text 110.

In general terms, parsing component 106 takes the system internal formatted text 110 and begins parsing the text. This means reading a chunk of text and separating the chunk into clusters that will be displayed to the user via UI 28 on the display 56 of the computing device 26. Note that parsing may only result in displaying certain forms of text. The parsing process recognizes specific identifiers of certain other information such as an image, icon or chart and displays such information in the form of an indicator such as “<image omitted—refer to macroscopic view now>”. Alternatively, information of this nature may be presented to the user in a separate pop-up window, or on the display 56. It may then be hidden once the user has read past the location of the information. The parsing component 106 optimizes the size of the clusters based on the parsing rules, to make the file easy to read quickly and comprehend. This also involves parsing characters including punctuation, images, tables etc, to make the final text readable. When the system internal formatted text 110 is being processed by the parsing component 106, the parsing component 106 may provide the core components 104 with clusters of information that the core components 104 may send to the UI 28. Alternatively, the core components, upon receiving clusters of information from the parsing component 106, may store the clusters until the complete file has been converted, at which time the core components 104 may send the file to UI 28. In a further embodiment, the parsing component 106 may store the clusters of information until the entire file has been parsed. In such an embodiment, the parsing component 106 may store the clusters in variables in the software application, or may create a new file that the clusters are successively written to. Such a new file may be stored in storage 58 or in the core components 104 or at another location in the computing device 26 on which core components 104 are operating. Various other aspects of the parsing component 106 will be described below, and include, but are not limited to, including pauses between clusters, inserting references to tables, images and hyperlinks, and providing formatting information.

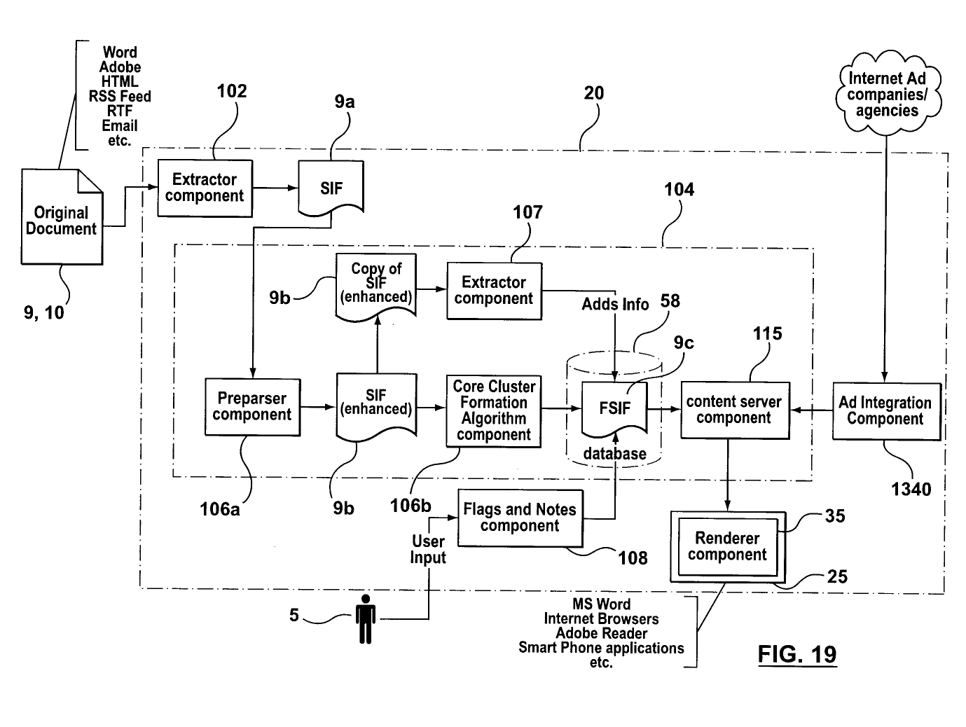

Core components 104 may further comprise content server 115 (not shown). Content server 115 may facilitate communication between software components, hardware components, server component 1200, computing device 26, content provider 1320, ad integration component 1340, storage 58 and among and between other elements of system 20, including over communication network 24, clients (such as renderer component 35, and notes component 108), other servers and data-stores. Content server 115 may serve content to clients (which may be software components), assist in flagging text or attaching notes to text, and facilitate the inclusion of ads into a file such as FSIF 9c in FIG. 19.

Content server 115 may access storage 58, that may have databases or file systems that house existing input data streams, files or objects. For example, content server 115 may handle a request for a file by retrieving the desired file from storage 58 and serving it to the calling client (such as renderer component 105).

Content server 115 may be, for example, a web server such as Microsoft Internet Information Server (IIS) (trade-mark) or Apache Web-servers (trade-mark), application or component servers such as COM+ (trade-mark) or .NET (trade-mark) application servers.

Content server 115 may serve content to clients by way of a renderer component 35. A user, using a device application 25 and/or renderer component 35 may request to read an article that may be, for example, in storage 58 on server component 1200, computing device 56 or at content provider 1320. This may initiate a call to content server 115, which gets a copy of the requested content or file in a data-store, such as memory accessible by content server 115. Content server 115 will then serve the document to renderer component 35 of the calling device application 25.

If a file or document is large and may fail (timeout) in a single operation, content server 115 may break the file into sequentially-organized portions text and send the portions one by one until the whole file is received. Renderer component 35 may re-assemble the portions together to rebuild the original file. A user will then not have to wait for an extended period of time to view text, and can view the text seamlessly without any knowledge of the mechanism for creating and sending portions of text that may be taking place. This may be accomplished by opening a socket connection and streaming the file from content server 115 to renderer component 35. This may alternatively be accomplished, for example, using technologies such as AJAX. An AJAX solution, deployed as part of a website solution may proceed according to the following:
A user requests a large file or article to read through renderer component 35
Renderer component 35 requests the file from content server 115
Content server 115 retrieves the file (optionally from, for example, content provider 1320 or storage 58) and determines that it is too large to send back in its entirety. A file may be determined to be large depending on a size threshold which may vary based on configurations and characteristics of system 20, bandwidth, device application 25, etc.
Content server 115 divides the document into a number of portions of text, the size of which may be determined and set based on configurations and characteristics of system 20, bandwidth, device application 25, etc.
A first portion may be sent to renderer component 35 so that it may be presented immediately to the user. It is worth noting that the top level nodes of a file (that has been converted into the appropriate internal format) may have all the information available for renderer component 35 to immediately start presenting text to a user.
The next portion of the file may be requested, received and appended to the first portion. Such may occur simultaneously with text presentation. This may be repeated until all of the chunks, comprising the entire file are present at the client (in the present case renderer component 35).

To add a flag or a note to a portion of text, a user may indicate they wish to do so using, for example, renderer component 35. Renderer component may provide this information to content server 115, which may provide access to functionality of notes component 108, such as via one or more Application Programming Interfaces (API). This may allow a user to specify, for example:
The sentence the note is to be associated with;
The text of the note, if any;
   The username of the user, if provided;
   The date the note was created;
   The username of a user who modifies a note; and
   The date the note was modified, if modified.

To facilitate the inclusion of ads, content server 115 may communicate with ad integration component 1340 and/or third-party providers 1330 to retrieve advertisements by calling API of the ad integration server 1340 and providing it with an FSIF 9c to be processed. Once the ads are determined, such as via third party ad provider 1330, the ads are inserted into the enhanced intermediate file resulting in a enhanced intermediate file with new advertisements added therein. Content server 115 then serves the ad-filled enhanced intermediate file to renderer component 35, which can interpret the ads and place them on UI 28 of display 56—either embedded somewhere within the UI of device application 25 or elsewhere.

### Parsing Display Formats

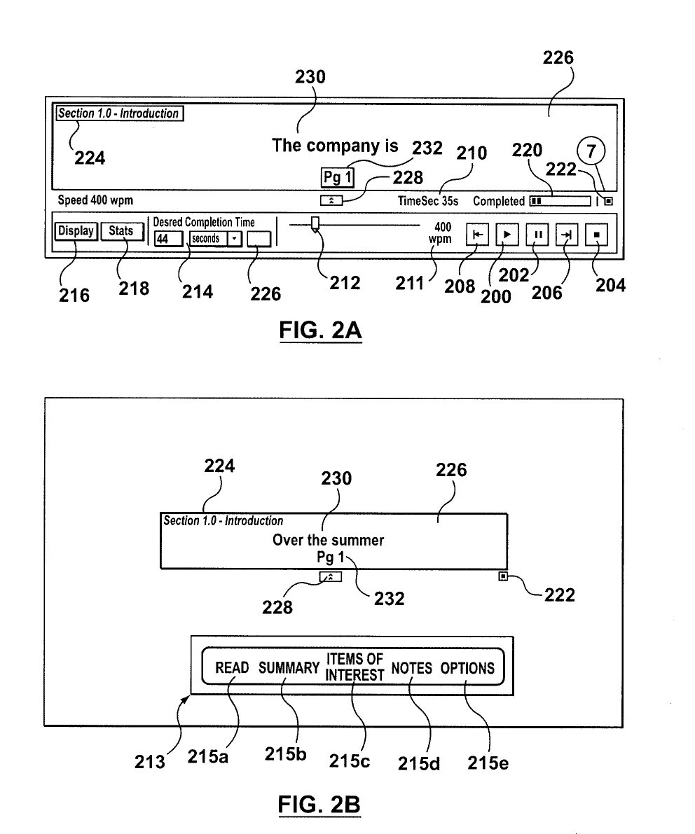

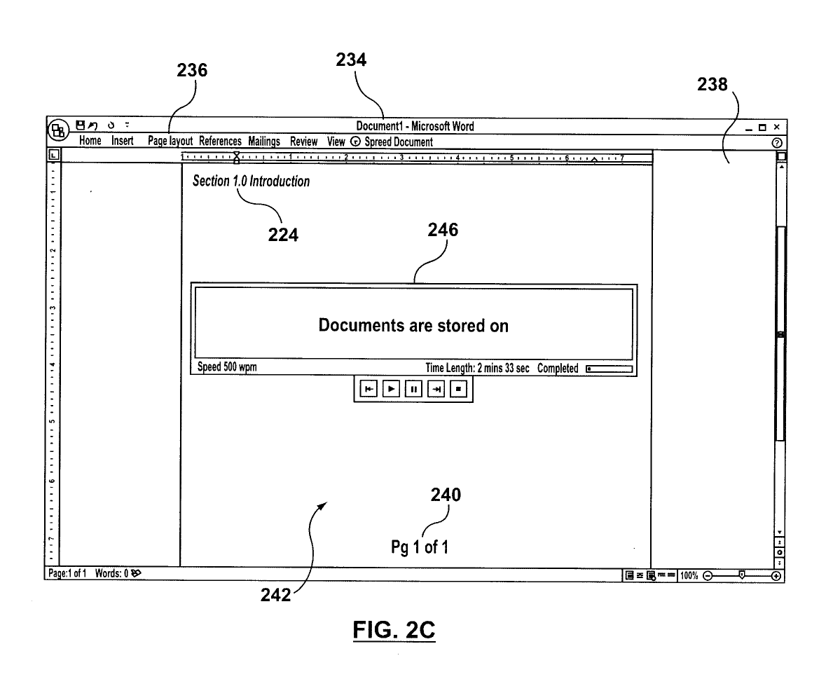

Referring now to FIGS. 2A, 2B and 2C, different formats for displaying electronic text in accordance with the invention are shown.

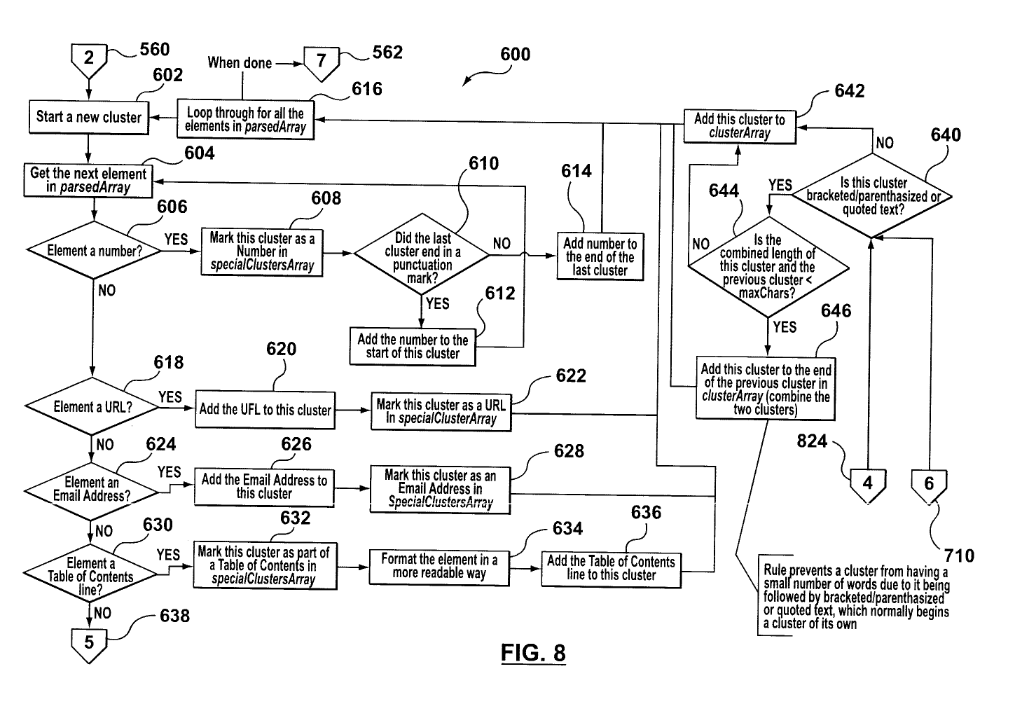

In FIGS. 2A and 2C, the system 20 is being used in ‘microscopic’ view in “compact mode”. ‘Microscopic’ refers to the fact that only a small portion of the text is visible at a time—essentially this means that the user is reading the displayed portions of the document after it has been parsed into clusters by the parsing component 106 (as further discussed below with reference to FIGS. 8-13). For non-textual file content, the user may be displayed an option of switching to the macroscopic view (where the entire document may be viewed), where the non-textual information is highlighted or otherwise made to stand out, bypass this information completely and continue, or have the information displayed, on a pop-up window for example. “Compact” mode means that the UI 28 is not using the entire display 56, making other applications visible to the user of the computing device 26. In FIG. 2B, the system 20 is being used in ‘microscopic’ view in “full screen” mode. “Full screen” mode refers to the fact that the UI 28 is using the entire display 56, and other applications are not visible to the user of computing device 26.

The compact mode and full screen mode are beneficial for different reasons. The compact mode allows a user to read a text file while optionally viewing the file itself or viewing other material on their screen (not shown). However due to limited space that the application is using, reading may be more difficult. Further, there may be more distractions with other applications in the view of the user. In contrast, in full screen mode the user is able to utilize the entire display for the application. Note that this does not necessarily influence how much text is presented to the user at a time. It simply allows greater clarity and enhanced contrast with the background of the display. This results in the user achieving greater reading speed, and greater comprehension, as a result of fewer distractions.

In FIG. 2A, a display that may appear as a window or a portion of a display screen (or optionally with other windows applications displayed) for a personal computer implementation of the system 20 is shown. As will be further discussed below, clusters, formed by parsing component 106, are displayed. The displayed cluster is intended to display words or word strings that a user would read at one time if reading a document normally, while removing other distractions from the user's field of view. This enhances the ability of the user to read the information more quickly with better comprehension. The display includes a play button 200, a pause button 202, a stop button 204, a move forward button 206 and a move backwards button 208, a time remaining text field 210, a speed display 211, a speed slider bar 212, a desired completion time text and selection box 214, a display button 216, a stats button 218, progress bar 220, a toggle button 222, a display component 224 relating what section of the document a user is reading, text display 226, expand/contract button 228, cluster from file 230 and page indicator 232.

The display component 224 indicates to the user what section of a document they are currently reading. If there are no sections, headers or chapters in the document being read this portion of the display may be blank and/or not visible. The play button 200, pause button 202 and stop button 204 may operate as typical play, pause and stop buttons for media file players. ‘Play’ and ‘Pause’ toggle between the system parsing text and not, while maintaining the current location within a file. ‘Stop’ causes the parsing to stop and the user's location within the file they were reading may be lost or maintained. The move forward button 206 and move back button 208 change the text that is displayed in UI 28 to be either the next cluster that is to be displayed, or the previous cluster—such clusters will be described with reference to the parsing process in FIGS. 5-10. The ability to move forward and backward in the clusters may be a manner to further control the speed of the text that is being presented and allows a user to re-read a cluster if they wish to, perhaps because they did not understand it on first reading. An exemplary use of these buttons is if a very complex file is being presented slowly to a user, but a simple cluster appears, the user may select the move forward button 206 to proceed to the next cluster. Alternatively, if a reader is reading a document quickly and a more complex cluster appears, the user may select the move back button 208, to review the complex cluster.

The speed slide bar indicates to the user how quickly the system is moving through a text file. In one embodiment of the invention the slider bar 212 is used to adjust the speed, such speed being shown by speed display 211, and indicated in words per minute (WPM). Instead of slider bar 212, other manners may be used to adjust speed, such as buttons with “+” and “−” signs. Other manners of indicating speed may be used as well, such as percentage (where 100% means the fastest possible reading speed). The desired completion time text and selection box 214 presents another way for the user to determine how quickly they would like to move through the file. By setting the exact completion time using the user interface components and selecting the okay button 226, the user is indicating that they wish to have the system present the entire file to the user within the user selected amount of time. Progress bar 220 provides a running indication to the user of how far through the text file they have gotten. The display button 216 displays a text box (not shown) that presents configurable options to the user such as options relating to the microscopic view font, font size, foreground color, and background color, and provides the user with progress indicator choices such as the percentage completed bar or a “words completed/total number of words” option. The stats button 218 is used for displaying reading statistics for the user's current reading session such as average reading speed between start/stops and changes of speed, amount of text completed, total time spent, and other statistical information. Maintaining statistics, and providing them to the user enhances the systems ability to function as a reading-improvement tool, or speed reading tool. These statistics may be stored between sessions of using the system, to allow comparisons between sessions. The toggle button 222 allows the user to toggle between compact mode and full screen mode. Expand/contract button 228 is used to expand or contract the view, allowing a plurality of buttons to be hidden from view when they are not needed. This may be accomplished by using a “control panel” (not shown) which contains most of the aforementioned buttons and that can be moved to the background or made invisible. It is to be appreciated that expand/contract button 228 may have different icons, or may be replaced with, for example, a menu item to hide the plurality of buttons.

Referring to FIG. 2B, a display for a personal computer implementation of the system 20 having a full-screen view is shown. Display includes a toggle button 222, a display component 224 relating what section of the document a user is reading, text display 226, expand/contract button 228, cluster from file 230, and page indicator 232. These elements are all substantially similar to the elements shown in FIG. 2A. It is worth noting that many elements present in the compact mode of FIG. 2A may be removed in the full screen mode of FIG. 2B or the screen in FIG. 2A. This simplifies the user's view and allows them to focus on reading and comprehending the text. In addition, the user's view is simplified in full-screen view as everything else that is present on the user's desktop, or home screen is blocked from view. Alternatively, other items on the user's display screen may remain visible but sufficiently faded so as not to be a distraction to the reader. This feature could be adjusted by the user. Toggle button 222 is provided should the user wish to switch to compact mode. A user would then be able to see more of their desktop and may then have further elements, and hence functions, available.

Referring to FIG. 2C, another embodiment of a display for a personal computer implementation of the system 20 is shown. Display is intended to visually represent a full page of a representative document as normally displayed on a screen and also includes display component 224, software application 234, menu options 236, sidebar 238, page indicator 240, software application UI 242, scroll bars 244, and parsing display 246.

In this embodiment the parsing display 246 would be substantially the entirety of the display in FIG. 2A or 2B and would be presented to the user with software application 234 visible behind it. The software application 234 would preferably be an application that presents the document, being parsed and shown in parsing display 246, in macroscopic view. This may be substantially similar to the screen as depicted in FIG. 2A or may be from an application known in the art such as Adobe Acrobat (trademark) or Microsoft Word (trademark), as shown. In this embodiment, parsing display 246, and its functionality, could be integrated directly into the software application. Parsing display could then be run (and stopped), at the option of the user, from the software application, in a manner similar to a plug-in software component.

In one embodiment of the software application 234, it is in print layout view, indicating how the document would look if printed on paper, where the screen may have sidebars 238 on either side of the software application screen 240. Software application screen 240 may show the portions of the document in macroscopic view that are not covered by parsing display 246. Such portions may be altered to avoid confusing or distracting the user. This may be accomplished by making the text grey or translucent for example. Alternatively, the text may be hidden from the user to avoid distraction, as shown in FIG. 2C. Parsing display 246 may present clusters to a user in the same font that such text appears (or would appear) on the software application screen 240, to mimic what the user's experience would be in reading the document normally.

Page indicator 240 may show the number of the page that the user is currently reading from and may also show the total number of pages in the document. The location of page indicator 240 is chosen to ensure visibility while minimizing distraction. Display component 224 is substantially similar to display component 224 in FIG. 2A and FIG. 2B, however, it may be shown in software application screen 242 to ensure visibility while minimizing distraction. Display component 224 and page indicator 240 may be combined instead of separate, and may be used to provide the user any information about the location of the user in the document being read.

As the parsing component parses and displays clusters from the document, the corresponding position in the underlying document may be maintained by the software application 234. Cursor 244 may then move accordingly to ensure any visible portions of text in software application screen 242 reflect where the user is reading. Cursor 244 may also remain in position until the user stops reading using the parsing display 246. At that time, the cursor 244 may automatically move so the software application screen 242 is showing the portion of the document the user ended at. Maintaining the corresponding position also allows accurate indication of page numbers or section headings using display component 224, page indicator 240, or both. It is to be understood that this embodiment of the underlying software application 234 and software application screen 242 is designed to mimic a user's usual experience with reading a document, with the added benefit that reading and comprehension is improved through the use of the parsing display.

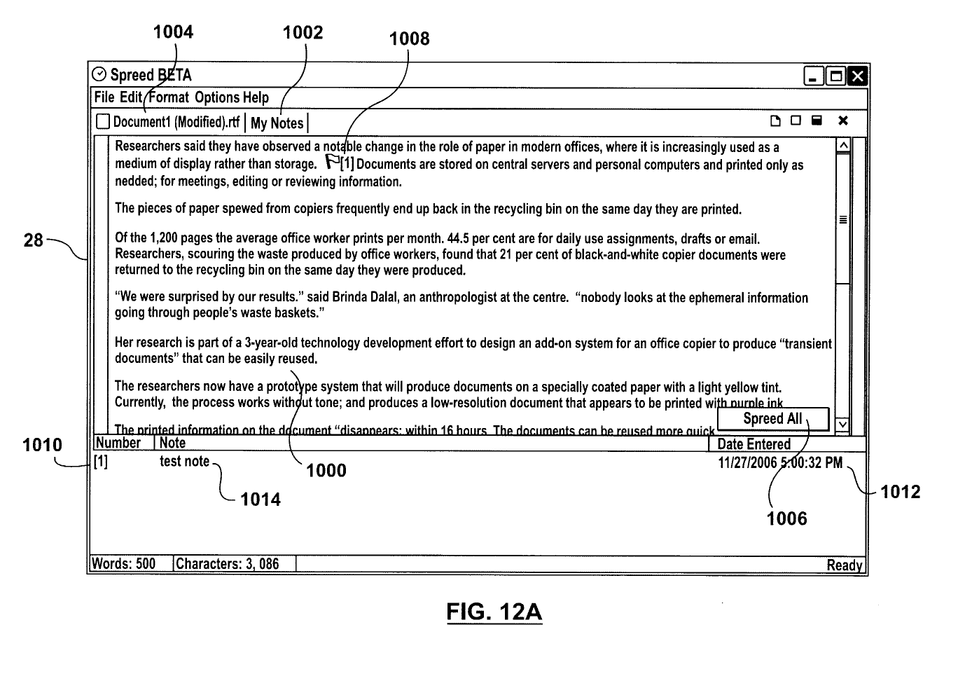

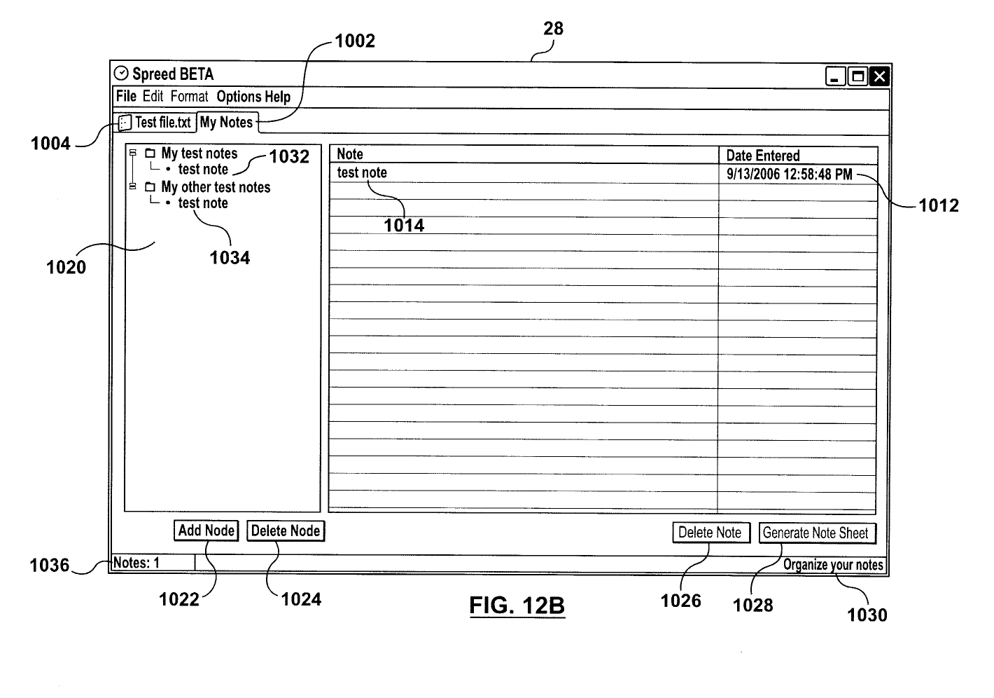

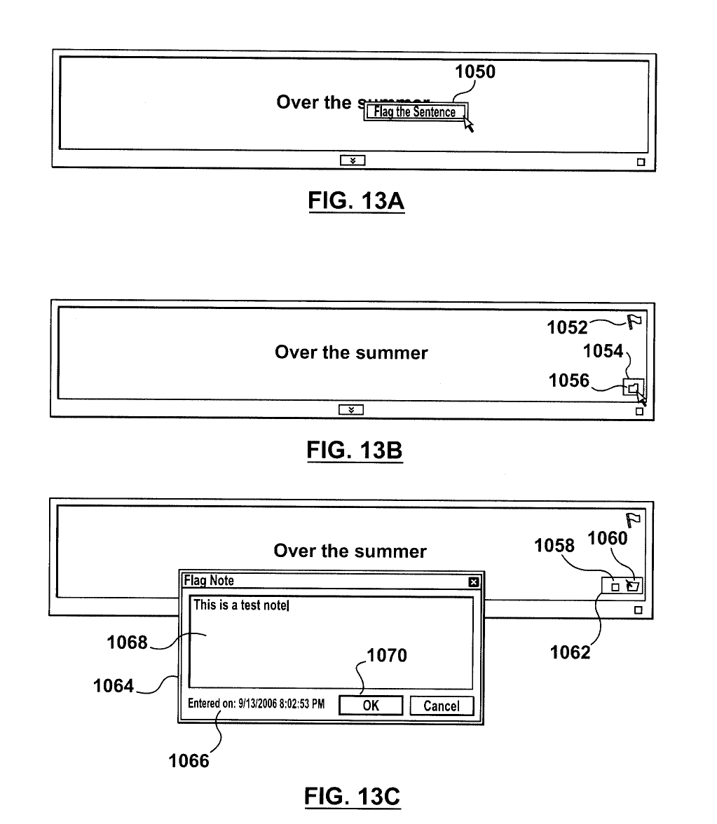

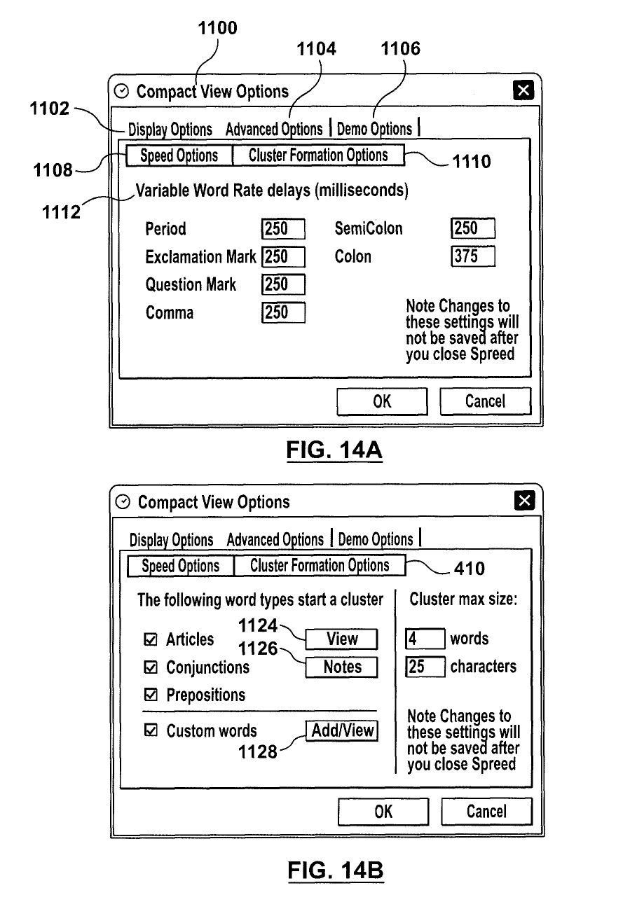

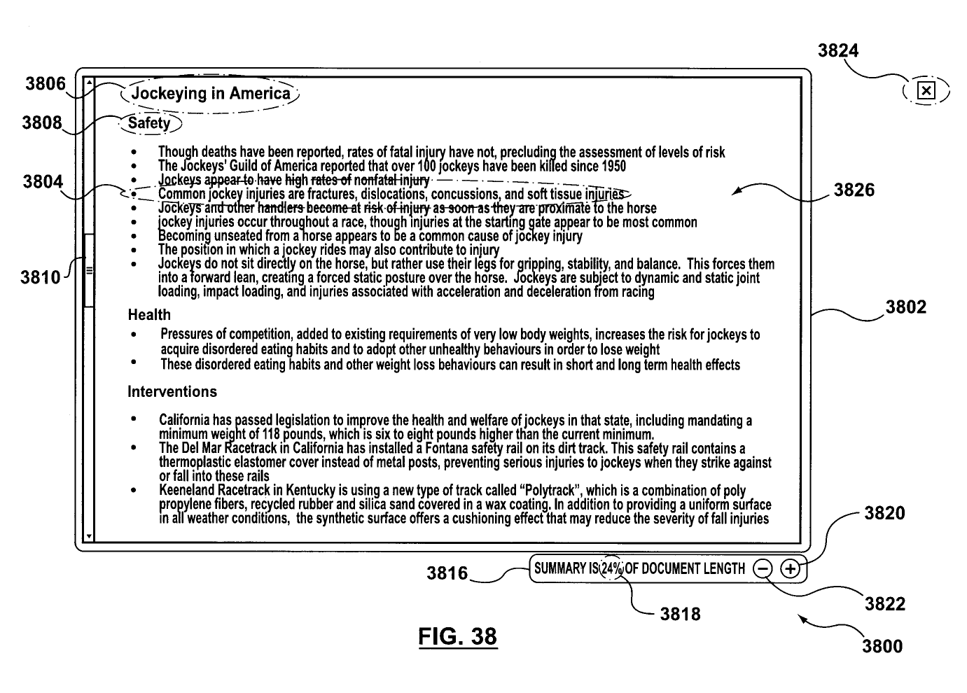

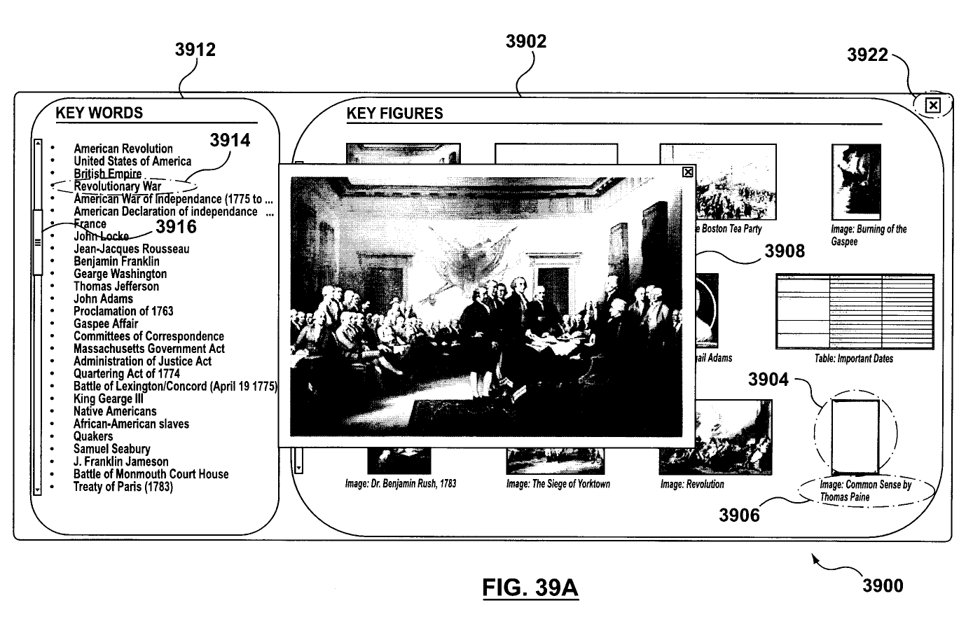

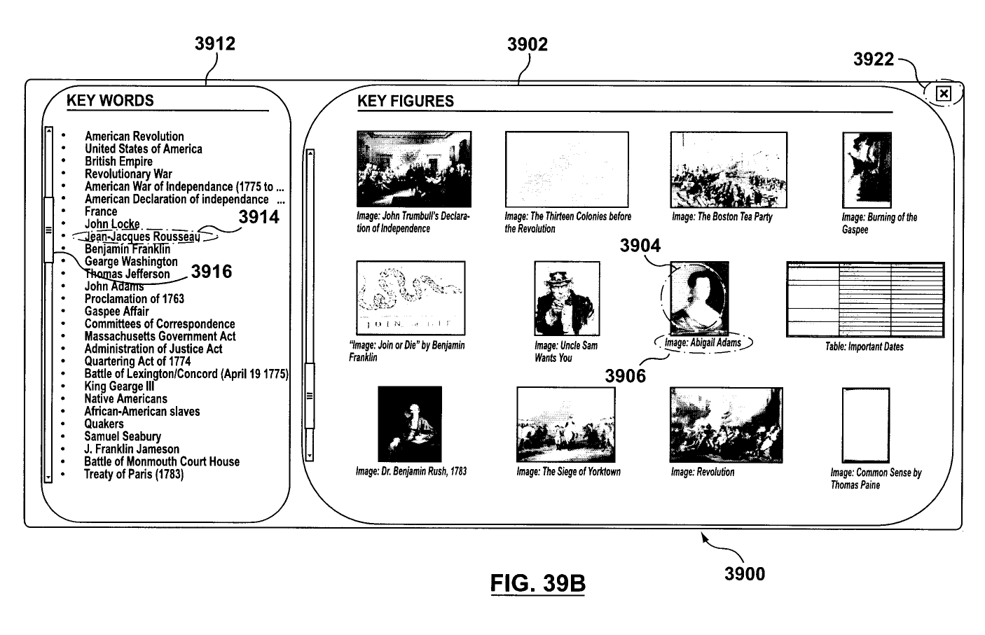

FIGS. 2A-C may further comprise navigation bar 213, which may further comprise navigation tabs 215 a-e. Navigation bar 213 may allow a user to select which view they would like on display 56 and UI 28. By selecting one of navigation tabs 215a-e on navigation bar 213 user 5 may select between viewing a text display screen or display (navigation tab 215a, exemplary screens at FIG. 2a-c), an autosummary screen or display (navigation tab 215b, exemplary screen at FIG. 38), an items of interest screen or display (navigation tab 215c, exemplary screen at FIG. 39), a notes screen or display (navigation tab 215d, exemplary screens at FIGS. 12-13) and an option screen or display (navigation tab 215e, exemplary screens at FIGS. 14a-b).

It is to be understood that although navigation bar 213 is shown only in FIG. 2B it may be present in any of the figures that may display any of the screens a user may wish to view, including those figures referred to above that are exemplary screens for navigation tabs 215A-E. The location, color, font, size, orientation, and other details of navigation bar 213 and navigation tabs 215a-e are exemplary only. Variations thereto are considered within the scope of the present invention and may be configured and used to improve usability, contrast with other elements on display 56 or other purposes.

Use with Portable Devices

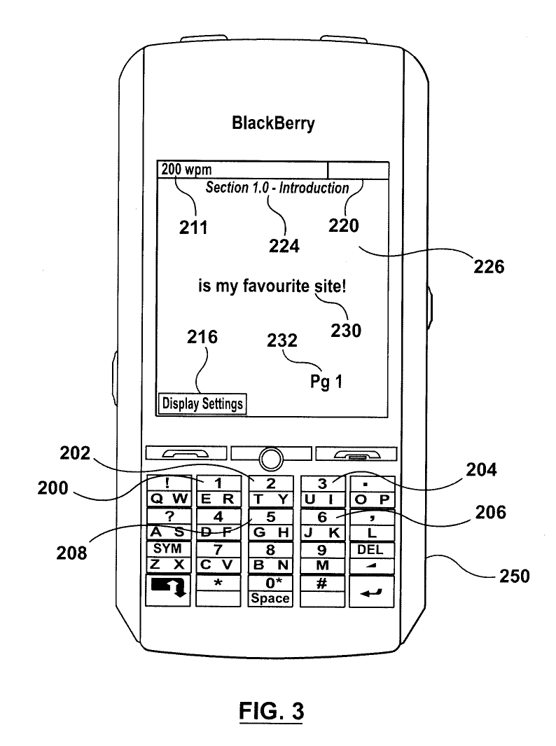

Referring to FIG. 3, a display for a cell phone or personal digital assistant implementation of the system is shown, comprising a computing device 26 with a smaller display screen size than many of the displays mentioned previously. Such smaller display screens may be in the range of 6 cm. or less in width or height. Device 26 further includes play button 200, pause button 202, stop button 204, move forward button 206, move backwards button 208, speed display 211, display button 216, progress bar 220, toggle button 222, display component 224 relating what section of the document a user is reading, text display 226, cluster from file 230, page indicator 232, and keypad 250. All elements are substantially the same as in FIG. 2A.

Play button 200, pause button 202, stop button 204, move forward button 206 and move backwards button 208 may be located and implemented on any keys on keypad 250 for computing device 26. The choice of keys to implement these buttons is preferably made to make them as intuitive and useable as possible. When implementing the buttons on keypad 250, the buttons used may not show icons that relate to the play, pause, stop and movements but may continue to show their customary number or letter. Alternatively, these buttons may be implemented as icons on text display 226. In such case, the user is able to highlight and use an icon (invoking the button's functionality as described herein) with user input functionality of the cell phone or PDA, such as stylus pen for touch screens, a thumbwheel or ‘pearl’ as with Blackberry (trademark) devices (not shown). It is also possible for both icons and keypad 250 to be used to implement the buttons. Alternatively, these buttons may be implemented as icons on a touch-screen enabled device such as the Apple iPhone (trade-mark).

Computing device 26 with a smaller display screen size operates in substantially the same ways as described above for other computing devices 26, including PC 18. Elements shown may not all fit on the display of computing device 26 or may be re-sized in order to fit. Functionality not as imperative to the functioning of the system may be removed to accommodate the reduced display, such as page indicator 232 or speed display 211. In addition, computing device 26 with a smaller display screen size may be operable to switch orientation of displayed text. This would be akin to switching between ‘landscape’ and ‘portrait’ orientations. Such a switch may be initiated by the system 20 or the computing device 26, for example in response to a file containing many long words or a screen display 226 that is taller than it is wide. Alternatively, a user may initiate a switch in orientation, for example by turning the computing device 26 with a smaller display screen size over to the desired orientation (assuming it has sensing means, not shown, to determine such an occurrence) or by the user's selection of a button or otherwise interacting with the limited display device to initiate such a switch.

### Multiple Clusters

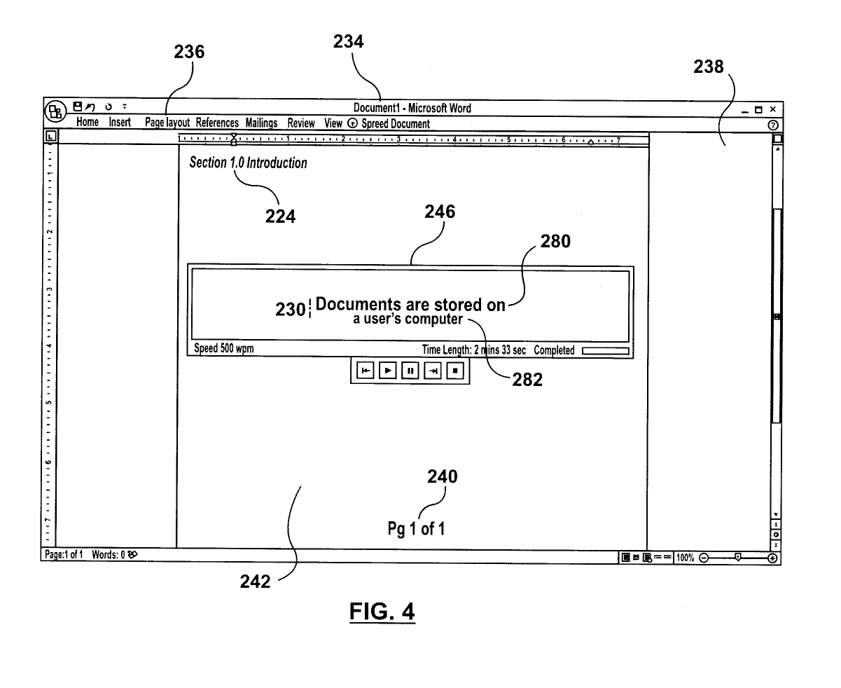

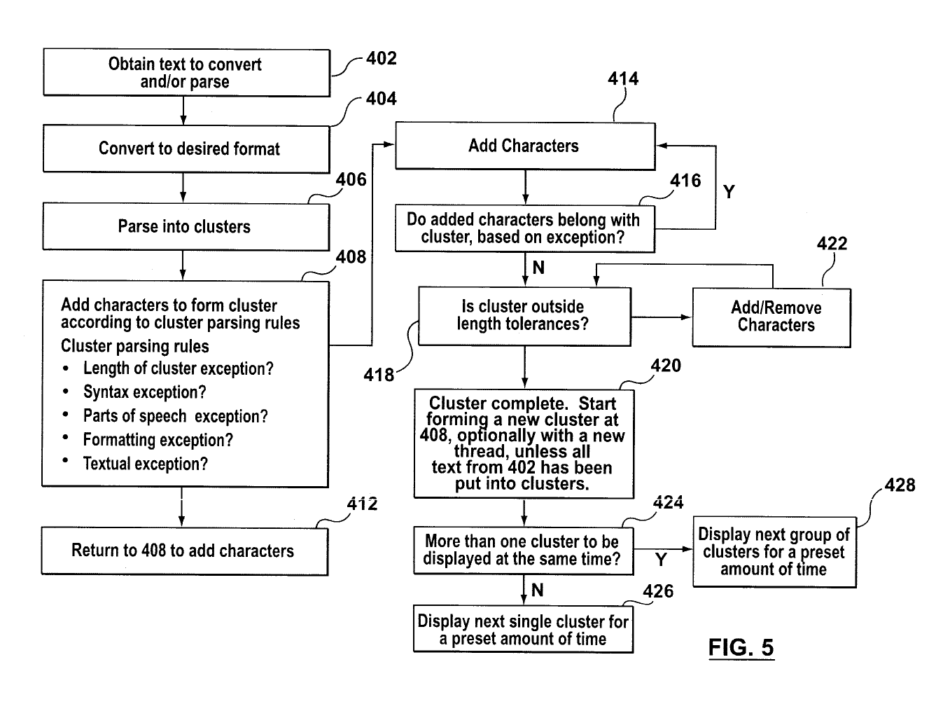

Referring to FIG. 4, an alternative embodiment of FIGS. 2A-2C is shown wherein cluster from file 230 consists of two (or more) clusters, shown as clusterA 280 and clusterB 282, that are presented with one cluster on top of the other. Other display orientations are also possible, such as one cluster being presented in the same line as one or more other clusters. In a multiple cluster display embodiment, the user may be able to read and comprehend even more quickly than simply one cluster being presented at a time. Another reason for having two or more clusters displayed is for the visual comfort of the reader (ie there would be no rapid flashing for increased reading speed as more information could be displayed with each ‘flash’). ClusterA 280, being first before clusterB 282 in the file, is presented above, in front of or to the left of clusterB 282. Displaying of clusterA 280 may occur at the same time as displaying of clusterB 282 or may be slightly before clusterB 282 to ensure that the proper reading sequence is observed. Other manners to ensure the proper reading sequence is observed may include different text sizes and fonts (as shown), colors, translucency, fading text in or out or other methods to differentiate and alter emphasis. The time between clusters being displayed on one another, and the number of clusters displayed at one time may be configurable options for the user.

### Parsing Component Process

Referring to FIG. 5, a flow chart showing one embodiment of the functioning of the system is shown.

Process 400 begins at 402 with the system being provided text to convert and/or to parse. Such text may be provided via a stream, a document, or any other means as contemplated in reference to the description and figures provided herein.

The provided text is then converted, if necessary, to a desired format at 404, using conversion components substantially as described with reference to FIG. 1. Such format may be, for example, Rich Text Format, XML, a proprietary format, or any other desired format. Conversion may be accomplished with commercially available converters, particularly if the provided text is in a proprietary format, such as Adobe PDF (trademark). Although many formats may need to be converted, it is also contemplated that some formats need no conversion and may proceed directly to 406.

At 406, text begins being separated into clusters; this leads to 408 where one or more characters are read from the converted file and added to the cluster. One approach is to add the next word from the text to the cluster. This would mean that a character stream representing the word would be added to the cluster until the end of the next word, often indicated by a space in the text. Third party tools such as Microsoft's .net tool may be used for the purpose of identifying and selecting “words”. However there are many alternatives to a word being the next addition to the cluster and to a space being an indicator of a word end. Some of those alternatives include punctuation (such as at the end of a word), an email address, or a URL. In such cases, these items, when they are completely obtained as character streams, are added to the cluster. For simplicity of description, the term ‘word’ will be used to describe the character stream read in and added to the cluster; this is not intended to constrain the generality of the above discussion.

At 408, cluster parsing rules are checked to determine whether an exception has occurred, warranting a cluster be ended. Although the rules in 408 are listed in an apparent hierarchical manner and as separate exception triggering rules, it is to be understood that such exceptions may be applied in any desired order and may operate together in any capacity. The goal is simply to achieve a more readable, comprehensible set of clusters. Further, although some of the exceptions are shown as indicating that a cluster should end, such exceptions may be implemented instead to indicate that a new cluster should start or that the current cluster should be continued. At 408, if none of the cluster exceptions are triggered, the process continues to 412 and the process returns to 408 to add more characters. If an exception is triggered at 408, the process continues to 414, as will be more fully described below.

Length of cluster exceptions may include the length of the cluster and the amount of text, typically the number of characters and words, in the cluster being compared to the predetermined maximum and minimum amount for a cluster. The exception may be triggered when the cluster's length is outside of the predetermined minimum and maximum number. Preferably at 408, only exceptions caused by a cluster that is too long (and violating maximums) causes the exception to trigger as minimums may be caught later in the process. The minimums and maximums may be configurable by different users, user types or applications.

Syntax exceptions may suggest that a cluster be ended based on the existence of, for example, punctuation like a period or semi-colon, a tab character, a new line/carriage return characters, capitalization etc.

Parts of speech exceptions may include the presence of articles, conjunctions, prepositions, and specially-defined custom words (as may be defined by users, programmers, administrators etc). Such parts of speech may suggest that a cluster should not be ended (as in the presence of the word ‘the’ at the end of the cluster) or may suggest that a cluster should be ended.

Alternatively, parts of speech exceptions may be triggered, in conjunction with other exceptions (such as length exceptions) if a noun is at the end of the cluster and the cluster has substantially reached the maximum word number or character number.

Specially-defined words may be any words that a person decides should end a cluster. This may vary, for example, between people, applications, and user types. By way of example, users in the legal community may determine that the word ‘plaintiff’ should always be the first word in a cluster.

Formatting exceptions may suggest endings to clusters based on, for example, whether the new word has a different font type, font size, font color, bolding, italicizing, underlining or highlighting relative to the rest of the cluster, whether the justification for the new word is different from the rest of the cluster, or any combination thereof. In one embodiment, it is both the formatting itself and the formatting relative to the words surrounding the current word that is taken into account when determining whether a cluster should end. Further, formatting changes may cause the cluster to be ended, providing a certain length of cluster has already been reached.

Textual expression exceptions may suggest endings to clusters in many ways. For example, numbers may be desirable to have in a new cluster, so they may not be added to the end of a cluster. Alternatively, in some applications, numbers may desirably be kept at the end of a cluster, in which case the exception would not be triggered.

Abbreviations may result in a cluster being ended (due to the period at the end), despite the fact that they need not necessarily suggest a cluster end. In such a case, and generally with any combinations of exceptions discussed herein, exceptions may operate as ‘exceptions to exceptions’. In the case of abbreviations then, the existence of the abbreviation would provide an exception to the triggering of the cluster ending punctuation exception.

Subscripts and superscripts may desirably be kept with the current cluster, but may also desirably be a cluster ending word. This may make the word that the subscript or superscript relates to easier to read.

Proper nouns may also suggest a cluster ending and that the proper noun should start the next cluster. Alternatively, it may be desirable to have a proper noun indicate, and be placed at, the end of the current cluster.

Lists or tables of contents (which may be special items or items of interest) may also indicate cluster endings. Bullets in lists may desirably be at the start of a cluster; any cluster that would be adding a bullet in the middle would be ended and a new cluster started. Numbered lists, or other such lists may operate similarly. Each new item of a table of contents may preferably be the start of a new cluster, and any indicators of the end of an item could trigger an exception that indicates the end of a cluster. Further, a user may be given the option of viewing items of interest as they appear in the document, or wait and view them at the end.

In a similar fashion, open quotation marks, brackets or parentheses may indicate that a cluster should be ended and a new one started. On the other hand, close quotation marks, brackets or parentheses may indicate that they should be added to the cluster, and the cluster should be ended after the addition.

Links contained in the document, such as URLs, email addresses, links internal to the document, and any other such links within the document may trigger a cluster ending. When the full link is added to the cluster, the cluster may be ended to ensure that the content and its meaning (for example what type of link it is) is properly understood. Optionally, a link may always be its own cluster, to further aid in understanding, and optionally to allow a user to follow such a link.

Further examples of textual structures may include dollar signs, header and footer information, and titles. Dollar signs may be kept with the number it refers to, for example. Headers and footers could be displayed on the display 56 in a manner or location indicative of the information being from a header or footer; such information remaining constant until the header or footer changes. A person's title may be displayed all in one cluster, thus keeping “Mr.” with the name after it, for example.

Finally, other defined textual exceptions may be created by the user, programmer or administrator. Such defined textual exceptions may, for example, be directed at textual structures which have a special meaning to the particular person, application or user type (such as lawyer, doctor, engineer etc) or which would otherwise break the natural reading flow.

Update exceptions or other exceptions may include language based exceptions (non-English for example), user-based or user-configurable exceptions, exceptions based on the user type, or may simply be updated exceptions that have been developed that improve readability and comprehension (much like common software updates). Such updates may also include combining existing exceptions in novel ways to improve readability. Some of such combinations are referred to above as examples of combining the exceptions.

At 412 a word has been added to the cluster, but no exceptions have been triggered. Therefore, the process returns to 408 and further text is added to the cluster and the process repeats through the exceptions.

If any exception is triggered, the process continues at 414 where further text is added, similar to 408. At 414 however, the process is attempting to determine whether, after an exception has been triggered, the text after the exception goes with the exception and thus should be added to the cluster. At 416 such a determination is made, and the next portion of text is added if they accompany the exception. Such may occur if the exception is an italicized word that is added near the middle of a cluster and the next word is also italicized. In such case, it may be desirable to have the second italicized word in the current cluster. In such a case, the process returns to 414 until the next word to be read does not go with the exception, in which case the process proceeds to 418.

At 418, the cluster is further checked to ensure the length is within cluster length tolerances. Such tolerances may be substantially similar to the length maximums and minimums as discussed at 408, or may be different. If the cluster falls outside the tolerances, at 422, text is either removed (if the cluster is too large) or added (in substantially the same fashion as at 414 if the cluster is too short) until the cluster is within tolerances.

When the cluster is within tolerances at 418, the process continues at 420 where the cluster is complete, a new cluster is started, and the process returns to 408. The cluster that was completed at 420 may be displayed, stored or in any other way operated on or processed. Such operation or processing may occur on clusters separately or they may be kept together and operated on or processed together. From 420, a thread of processing may return to 408, while a thread may proceed to 424 to display the clusters, first determining at 424 whether to display one cluster at a time, or more than one. If more than one cluster is to be displayed at a time, the process continues to 428 where the next group of clusters gets displayed. This may involve a pause between each cluster in the group being displayed on the screen, or they may all be displayed at the same time. The reading order for groups of clusters may be top to bottom, as in normal reading.

It is to be understood that the process as described in FIG. 5 is merely an embodiment of the parsing component that may be used to create clusters that increase readability and comprehension. Such description is not meant to limit the process or the exact implementation details or exception ordering.

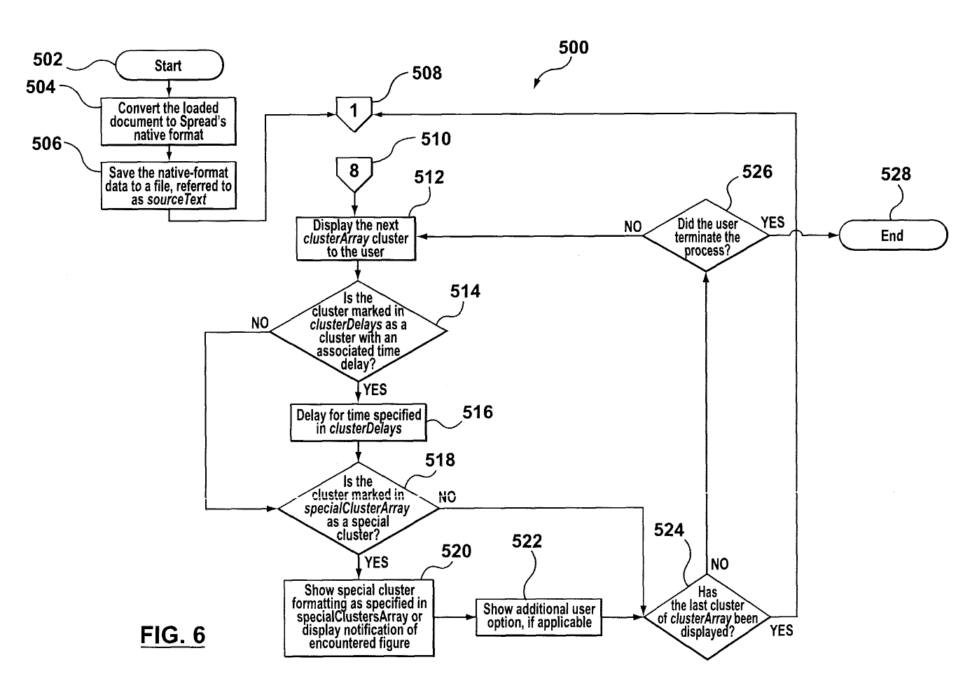

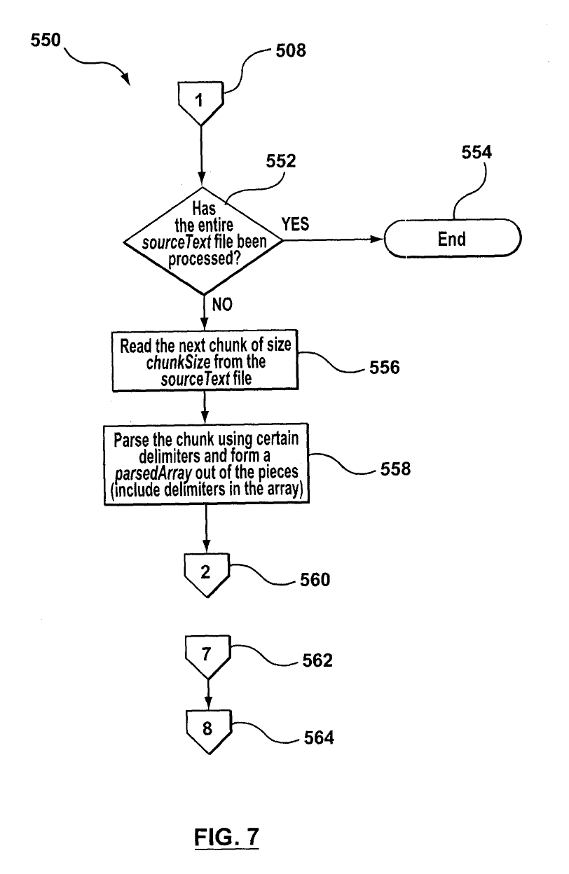

FIGS. 6 through 10 provide a detailed alternative embodiment of the parsing process. Referring first to FIG. 6, process 500 is shown. The process 500 starts at 502 and proceeds to 504 where a document is loaded and converted to the system's native format. At 506 the native format file is saved as a file referred to as “Sourcetext”. At 508 process 500 leads to process 550 of FIG. 7.

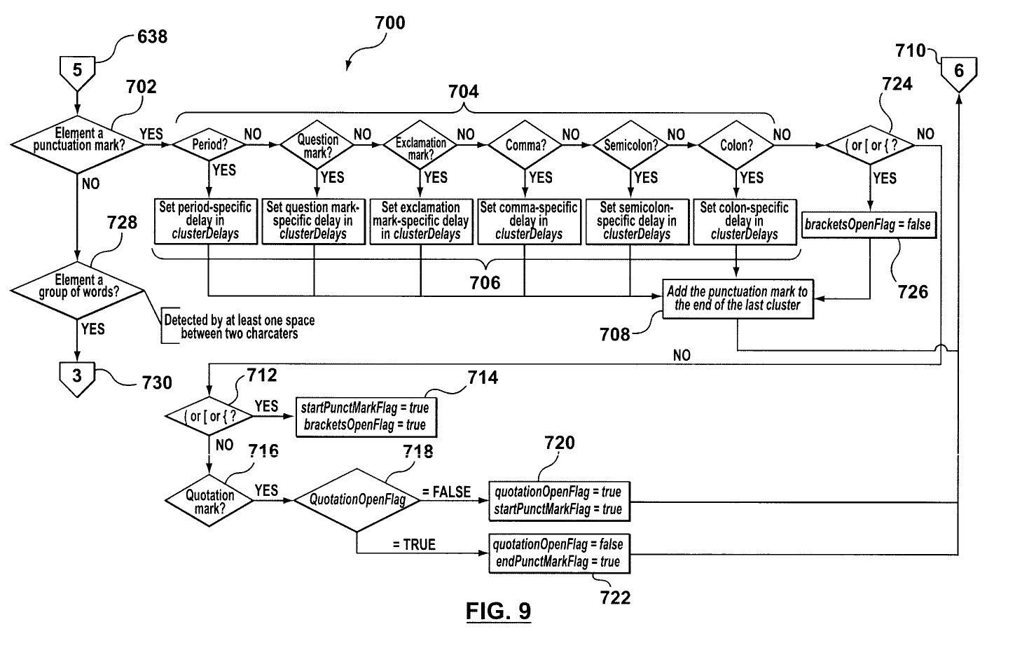

Referring to FIG. 7 process 550 begins at 508 and proceeds to 552 where a determination is made whether the entire Sourcetext file has been processed. If yes, process 550 proceeds to 554 and ends. If no, process 550 proceeds to 556 to read the next chunk of text from the Sourcetext file. At 558 the chunk that was read from the Sourcetext file is put into an array called ParsedArray. Process 550 then proceeds to 560 where the process continues on FIG. 9 in process 600.

Referring to FIG. 8 and starting at 560, at 602 a new cluster is started and at 604 the next element in ParsedArray is obtained. At 606, if the element is a number, the process continues to 608 where the cluster is marked as a number in the SpecialClustersArray. At 610 if the last cluster ended in a punctuation mark the number is added to the start of the current cluster at 612 and the process 600 returns to 604 to get the next element in the ParsedArray. Returning to 610, if the last cluster did not end in a punctuation mark, the number is added to the end of the last cluster at 614. Process 600 continues to 616 to loop through all the elements in the ParsedArray. If all the elements in the ParsedArray have been looped through, process 600 continues to 562. Returning to 606, if the element is not a number, process 600 continues to 618 where if the element is a URL, the URL is added to the cluster at 620, the cluster is marked as a URL in SpecialClustersArray at 622 (this may indicate that the URL should be presented, for example, in color to the user) and the process 600 continues to 616. Returning to 618, if the element is not a URL and the element is an email address at 624 then at 626 the email address is added to this cluster, at 628 this cluster is marked as an email address in SpecialClustersArray (this may indicate that the email address should be presented, for example, in color to the user), and process 600 continues at 616. Returning to 624, if the element is not an email address, if the element is a table of contents line then at 632 the cluster is marked as part of a table of contents in SpecialClustersArray. The element is formatted in a more readable way at 634 and at 636 the table of contents line is added to this cluster. The process 600 then continues at 616. Returning to 630, if the element is not a table of contents line, process 600 continues at 638.

Reference is now made to FIG. 9, and process 700. Process 600, having ended at 638 continues in process 700, where at 702 if the element is a punctuation mark then at 704 the process 700 determines what punctuation the element is (a period (“.”), question mark (“?”), exclamation mark (“!”), comma (“,”), semi-colon (“;”) or a colon (“:”)), proceeds to 706 and sets the appropriate delay in cluster delays, continues to 708 and adds the punctuation mark to the end of the last cluster, and continues to 710. The delay is added so that when the file is being displayed, there is a delay, making the file easier to read and comprehend. Studies have shown that different punctuation requires different amounts of time to process—these delays provide that appropriate time. Returning to 702 if the element is a punctuation mark but is not one of the above-mentioned punctuation marks, then at 724 the element is checked to see if it is a close bracket (“)”, “]”, “>” etc.). If the element is a close bracket, process 700 continues to 726 where BracketsOpenFlag is set to false, the punctuation mark is added to the end of the cluster at 708, and process 700 continues to 710. Returning again to 702, if the element is not a punctuation mark at 728, the element is checked to see if it is a group of words. If the element is a group of words the process 700 continues to step 730. Returning to 724 if the element is a punctuation mark and is not a close bracket, process 700 continues to 712 where if the element is an open bracket then at 714 SetPunctuationMark flag is set to true, and the BracketsOpenFlag is set to true. At 712 if the element is not an open bracket then at 716 if the element is a quotation mark then QuotationOpenFlag is checked at 718. If the QuotationOpenFlag is false at 720 the QuotationOpenFlag is set to true and the StartPunctuationMark flag is set to true. If at 718 the QuotationOpenFlag is true, then at 722 the QuotationOpenFlag is set to false and the EndPunctuationMark flag is set to true. After 720 and 722 the process 700 continues at 710.

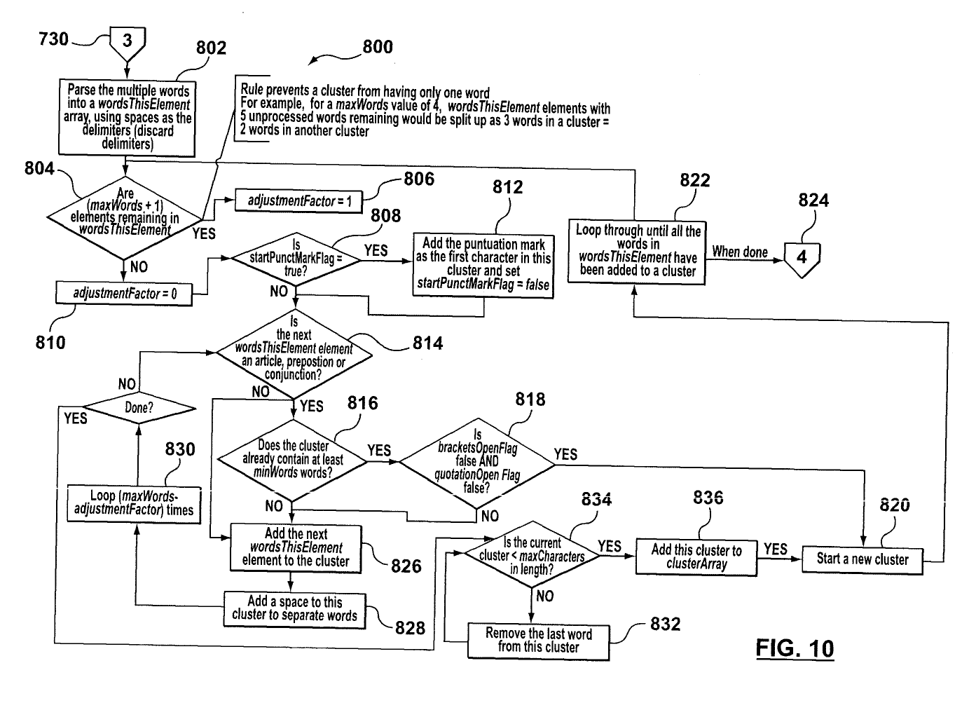

Referring now to FIG. 10 and process 800 beginning at 728 and proceeding to 802 where the multiple words are parsed into a WordsThisElement array. At 804 if max words plus one elements remain in WordsThisElement array, as created in 802, then at 806 the adjustment factor equals one. If not, at 810 the adjustment factor equals zero and process 800 proceeds to 808. At 808 if the start punctuation mark flag is true then at 812 the punctuation mark is added as the first character in the cluster and the start punctuation mark flag is set to false. The process 800 then continues at 814. If the start punctuation mark flag equals false at 808 the process continues at 814 as well. At 814 if the next element in WordsThisElement is an article, preposition or a conjunction then process 800 continues at 816 where if the cluster already contains at least the minimum number of words then process 800 continues at 818 and if the bracketsOpenFlag is false and the QuotationOpenFlag is false then process 800 continues at 820 and a new cluster is started. If the next element in WordsThisElement is not an article, preposition or conjunction then the process 800 proceeds directly to 826. Returning to 816 if the cluster does not contain a minimum number of words then at 826 the next element from WordsThisElement is added to the cluster, a space is added to the cluster at 828 and the process 800 continues at 830 where the process encounters a loop. The loop occurs a maximum number of words minus the adjustment factor number of times returning to 814 each time. Returning to 830 when the loop has completed the process 800 continues at 834 where if the current cluster is smaller than the maximum characters the process continues at 836 to add the cluster to the cluster array and start a new cluster at 820. Returning 834 if the current cluster is larger than the maximum characters then at 832 the last word is removed from the cluster and the process returns to 834.

After starting a new cluster at 820, process 800 continues at 822 where if all words in WordsThisElement have been added to a cluster, the process 800 has completed, and process 800 continues to 824. If not all words in WordsThisElement have been added to a cluster at 822, the process returns to 804 to remove words from WordsThisElement.

Returning to FIG. 8 and continuing at 824 or 710 (which came from process 800 in FIG. 10 and process 700 in FIG. 9 respectively), process 600 continues at 640. If the cluster is bracketed, parenthesized or quoted then if the combined length of the cluster and the previous cluster is greater than the maximum characters at 644 then the cluster is added to the cluster array at 642. If the combined length of the cluster and the previous cluster is less than the maximum characters then at 646 the cluster is added to the end of the previous cluster meaning that the two clusters are combined. The process 600 continues from both 646 and 644 to 642.

Returning now to FIG. 7 at 562 (which came from process 600 in FIG. 8) the process 550 continues to 564, leading to process 500 in FIG. 6.

Referring now to FIG. 6, process 500 continues from 510 to 512 where the next cluster from ClusterArray is displayed to the user. At 514 if the cluster has a time delay then at 516 the delay is implemented and process 500 continues to 518. If there was no delay at 514 the process 500 continues immediately to 518 where if the cluster is marked as a SpecialCluster then the SpecialCluster formatting as specified in SpecialClustersArray, or notification of the existence of a figure is displayed at 520. At 522 additional user options are displayed (such as hyperlinking, viewing an image, jumping to the full document, etc.). The process 500 then continues at 524 where if the last cluster has been displayed the process 500 continues to 526 and if the user terminated the process the entire parsing process ends at 528. At 526, if the user did not terminate, the process returns to 512 and the next cluster is displayed to the user. Returning briefly to 518, if the cluster is not marked as a SpecialCluster then the process 500 continues at 524 and proceeds from that point on as if the cluster was a SpecialCluster.

As will be appreciated with reference to the parsing process described in FIGS. 5-10, and the architecture according to FIG. 1, there are many ways to implement the parsing process. In FIG. 1, it is contemplated that the parsing process may consist largely of separate processes to convert the file to system's 8 native format, parse the native format file and then display the file to the user. These processes may not necessarily occur in series, but could occur in parallel (the user being presented some of the file as other parts of the file are being converted or parsed) or may be pipelined (where a pipe is always kept full of work). Such an example is described in FIGS. 5-10. Further, these three main processes may be occurring in different applications or at different geographic locations depending on the requirements of the user and the limitations such as those of the computing device 26, the communication network 24. Such embodiments are considered to be within the scope of the present invention. It will also be understood that necessary modifications to the parsing process may be made to address sentence structures and punctuation of other languages. Such modifications are intended to be within the scope of the invention discussed herein.

### Parsing Component Example

The process shown in FIGS. 6-10 may be further understood with reference to an example, where the text below is applied to process 500 at 504. The text below will be referred to as the sourceText for consistency with FIGS. 6-10.

“Ontario's provincial police force will no longer use media-friendly roadside traffic “blitzes”—long a staple of long weekend newscasts—as part of their effort to get dangerous drivers off the road, says OPP Commissioner Julian Fantino.

Instead, provincial police will simply be “unrelenting” in their pursuit of aggressive and irresponsible drivers, Fantino writes in an open letter on the force's website—a change in tactic that reflects his tough, no-nonsense approach, but appears to have caught the provincial government off guard.”

We assume at 556 that the two sourceText paragraphs shown above constitute a single chunk.

### Execution Proceeds as Follows:

At 556, the entire sourceText is read as the only chunk making up the source document. This assumes that the sourceText is small enough for only one chunk to be formed.

At 558 the following parsedArray (“PA”) is formed:
[PA0] “Ontario's provincial police force will no longer use media-friendly roadside traffic”
[PA1] “\″”
[PA2] “blitzes”
[PA3] “\″”
[PA4] “—long a staple of long weekend newscasts—as part of their effort to get dangerous drivers off the road”
[PA5] “,”
[PA6] “says OPP Commissioner Julian Fantino”
[PA7] “.”
[PA8] “Instead”
[PA9] “,”
[PA10] “provincial police will simply be”
[PA11] “\″”
[PA12] “unrelenting”
[PA13] “\″”
[PA14] “in their pursuit of aggressive and irresponsible drivers”
[PA15] “,”
[PA16] “Fantino writes in an open letter on the force's website—a change in tactic that reflects his tough”
[PA17] “,”
[PA18] “no-nonsense approach”
[PA19] “,”
[PA20] “but appears to have caught the provincial government off guard”
[PA21] “.”

Note that the contents of element PA1 is “\″”. The backslash has been added by the algorithm as a special escape sequence to indicate that this element is only comprised of a single quotation mark.

At 602 a new cluster is started and at 604 element PA0 is accessed. At 606, 618, 624, and 630, the conditions all go to their NO branches and execution continues to 638 and 702. Execution takes the NO branch and continues to 728 where it takes the YES branch and proceeds to 730.

At 802 the following wordsThisElement (“W”) array is produced:
[W0] “Ontario's”
[W1] “provincial”
[W2] “police”
[W3] “force”
[W4] “will”
[W5] “no”
[W6] “longer”
[W7] “use”
[W8] “media-friendly”
[W9] “roadside”
[W10] “traffic”

At 804 and 808 the NO branches are taken. At 814, NO branch is taken because element W0 is not an article, preposition, or conjunction. At 826 element W0 is added to the current cluster, which was empty prior to this step. The cluster is now “Ontario's”. A space is added at 828; the cluster is now “Ontario's”.

The process then loops through 814-816-826-828-830 until the maxWords number of words (assumed to be 4 in the present example) have been added to the cluster. The cluster is then: “Ontario's provincial police force”.

The process continues to 834. Since the length of the cluster is 34 characters, which is less than the maxCharacters length (assumed to be 40 in the present example), the cluster is added to clusterArray (“CA”) at 836.

Once all the wordsThisElement elements have been added to clusters in clusterArray, execution proceeds to 824. At this point the process returns to 602 and 604 where a new cluster is started and the next parsedArray element is accessed. These steps continue in a similar manner until all parsedArray elements have been processed at 562. The finished clusterArray appears as follows at 562:
[CA0] “Ontario's provincial police force”
[CA1] “will no longer use”
[CA2] “media-friendly roadside traffic”
[CA3] ““blitzes””
[CA4] “—long a staple”
[CA5] “of long weekend newscasts”
[CA6] “—as part”
[CA7] “of their effort”
[CA8] “to get dangerous drivers”
[CA9] “off the road,”
[CA10] “says OPP Commissioner”
[CA11] “Julian Fantino.”
[CA12] “Instead,”
[CA13] “provincial police will”
[CA14] “simply be “unrelenting”
[CA15] “in their pursuit”
[CA16] “of aggressive and”
[CA17] “irresponsible drivers,”
[CA18] “Fantino writes in”
[CA19] “an open letter”
[CA20] “on the force's website”
[CA21] “—a change”
[CA22] “in tactic that reflects”
[CA23] “his tough,”
[CA24] “no-nonsense approach,”
[CA25] “but appears to have”
[CA26] “caught the provincial”
[CA27] “government off guard.”

Next, at 510, clusters from clusterArray are displayed to the user with associated delays, if applicable and/or with special formatting, if applicable. At 524, after displaying the final cluster of clusterArray to the user, execution would continue to 508 for longer documents, at which point another chunk would be read from the source document and processed by the algorithm. Using the sourceText provided in the above paragraph however, only one chunk was required and hence the process ends on its own at 554.

### Notes Component

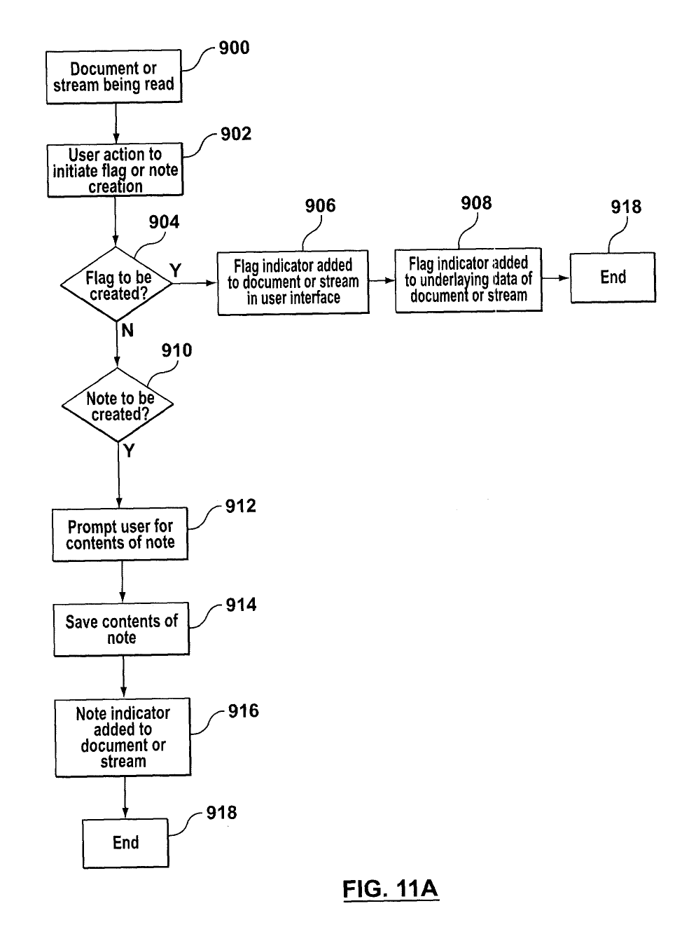

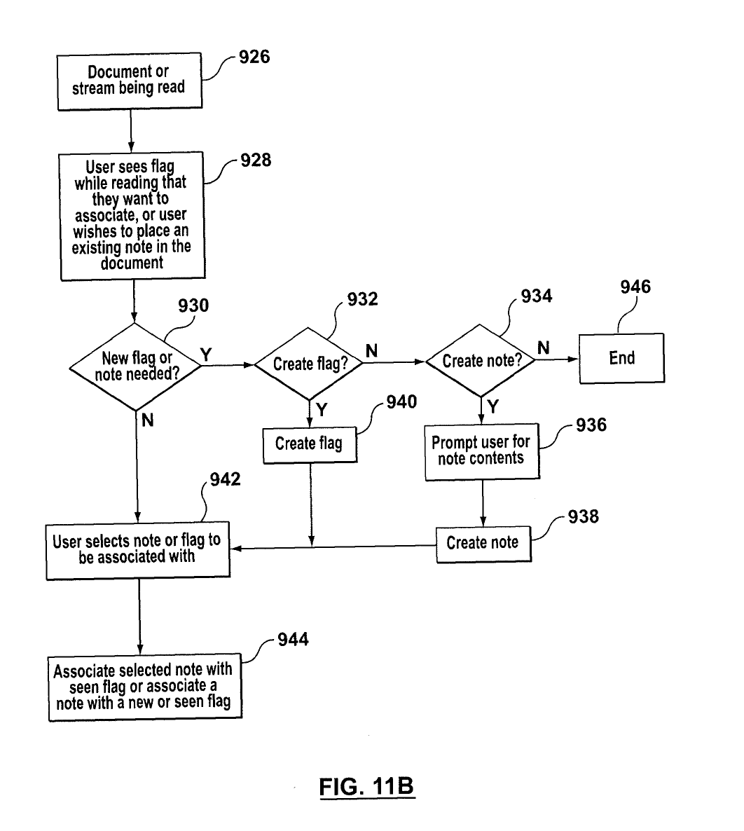

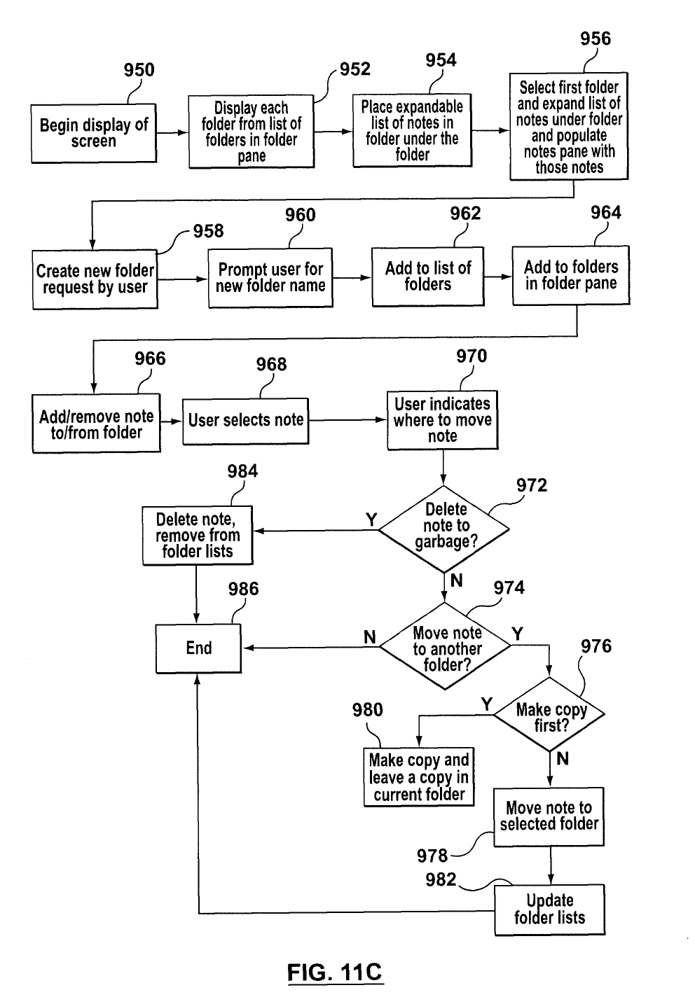

FIGS. 11A, 11B and 11C are flow charts depicting embodiments of process steps for the operation of the notes component 104. Referring first to FIG. 11A, there is shown a process for setting a flag (or note indicator) or creating a note.

The process begins at 900, where text or a file is being read by a user. It is to be understood that at 900 the text or file is in a format that is supported by the notes component 108. This may be after converter component 102 converted the text, but may simply be because the text was provided in a suitable format. Further, the text or file may be FSIF 9c or SIFE 9b, as described herein. The process continues to 902 where a user action occurs to initiate flag or note creation. The user action may involve pushing a button on a keyboard or clicking a mouse button, or any other manner of providing a user input to a computing device 26. At 902, the user indicates whether a flag or note is to be created. This may be implemented, for example, using a menu, or may be implemented using multiple icons that a user can select. The process continues at 904 where if a flag is to be created the process continues to 906. At 906, a flag is added to the text or file in the user interface, and is optionally located at the present location of the cursor. A user may be able to flag a paragraph, a sentence, or a part thereof. The flag that is added to the user interface may be different in each case. This flag is then visible in the user interface until the portion of the text or file having the new flag is no longer being displayed. The process then continues at 908 where the flag is added to the underlying data of the text or file, such as being written directly into FSIF 9c. When the flag is added to the underlying data, the text or file then permanently (or until the flag is deleted) has an indicator embedded in it that allows a computer application to recognize that a flag is present at that specific position. The process for creating a flag then ends at 918.

Returning to 904, if a flag is not to be created the process continues at 910. At 910, if a note is not to be created either then the process for creating a note ends. If a note is to be created at 910 then the process continues at 912 and the user is prompted for the contents of the note. The prompt at 912 may be accomplished, for example, by a window or dialog box that has space for the user to add text and then select an ‘OK’ button to indicate that the added text is to be the content of the note. The process continues at 914, where the contents of the note input by the user are saved into the note. Saving the note at 914 may be accomplished by saving the data into, for example, a data structure such as an array of characters or a linked list of string variables. Saving the note may further, or alternatively, involve writing data into FSIF 9c that may have the note's content and be in the appropriate location. Saving the note may also involve adding the new note to a linked list of notes that may be a folder. The process then continues at 916 where a note indicator is added to the text or file. This allows an application that opens the text or file to know that a note is present, and provides information to allow the contents of the note to be accessed. After 916, the process for creating a note ends at 918.

Referring to FIG. 11B, a process is shown to associate a flag or a note. Beginning at 926, a text or file is read. At 928, a user may see a flag, while reading, that they want to associate a new or existing note to. For example, the user may have previously put a flag in the text where they failed to understand something, or they thought that a term in the document would later be defined, or where they were particularly interested in the document. After further reading, the user may have developed an understanding of the text they misunderstood and so they wish to add a note to describe their new understanding. They could then associate the note with the flag they previously set so that they can read the note to understand the text. This may involve writing further data into FSIF 9c to associate the note and flag together. Alternatively, when they find a definition of the term they flagged, they could copy the definition into a note and associate it with the flag located at the term. In a further alternative, the area they had a particular interest in could be discussed later. The user could then create a note to describe where else the interesting information is discussed. Associating the note with the original flag would allow a user to remind themselves, or future readers of the document, where the further discussion is.

Also at 928, a user may wish to place an existing note in the text or file, using an existing flag or a flag that is to be created. By way of example, a user could be reading and wish to make a comment about the text or file. This could be a specific comment about an area of the text, in which case a note could be created and immediately associated with a flag that would then be created. Alternatively, the user may wish to make a general note that says “When mitochondria are discussed in this document, remember that there is another document to read that will be assistive.” The user may then continue reading the document and come to the discussion about mitochondria. They may then wish to associate the existing note that was not associated with a particular area but only with the document, with the newly found discussion about mitochondria. A new flag could then be created and the note could be associated with it. This may involve writing further data into FSIF 9c to associate the note and flag together. In a further alternative, the user may want to make a note about the section of the document that best describes the technical features of a particular invention—though they have yet to find that section. They may then create a note that says “This is the best discussion, be sure to read this carefully to obtain a full understanding.” As the user reads the document, they may flag multiple locations where the technical features are discussed. When they are finished reading, the user may have multiple flags at locations where technical details are discussed. The user may then choose which flag has the best discussion, and associate the note they had created with that flag.

Continuing at 930, the process determines whether a new flag or note is needed and if so, the process continues to 932 to consider whether a new flag is to be created. If a new flag is not to be created at 932, the process continues to 934 to determine whether to create a note. If a note is not to be created the process ends at 946. However if a note is to be created then at 936 the user is prompted for the note contents. This is substantially similar to 912, where a window or dialog box may be presented to the user. The process then continues at 938 and a note is created. Returning to 932, if a new flag is to be created then at 940 a flag is created which may involve the creation of a new flag data structure object.

After 938 or 940, or if a new flag or note is not needed at 930, the process continues to 942, where a user selects the note or the flag to be associated with. If the user wants to associate a note with a flag, then at 942 the user will select the desired note from a list of notes. This list of notes could include notes created by any reader of the document and could provide, for example, explanations of the text, references to other important documents that should be read, or other portions of the current document that should be read together to improve understanding. If however, the user wishes to place an existing note at a specific position in the document, then at 942 the user would select the flag to associate the note with or would select where the newly created flag should be placed. After the user has selected the note or flag at 942, the process continues at 944 where the association occurs. This may be accomplished using data structures for the flags or notes that have pointers to the associated flag or note. Further, this may be accomplished by writing data into FSIF 9c to associate the note and flag together.

Referring now to FIG. 11C a process is shown for the operation of the user interface for the display of notes. The process in FIG. 11C may be utilized to assist in creating the display in FIG. 12B. The process begins at 950 where the display of the screen begins. This continues at 952 where each folder from a list of folders is displayed in a folder pane. The list of folders may be implemented, for example, with a linked list of data structures representing folders. Thus, to display the folders would involve moving through the linked list and accessing folder names or other characteristics that are to be displayed. The folders, or bins, of notes may include folders named after readers of the document, where each note in the folder was created by the named reader. Alternatively, the folders may be content-specific, where each folder contains notes that relate to a specific aspect of the document. In a further alternative, the folders may contain a set number of notes each, and the notes may be added to folders, with a new folder being created when the current folder has reached its maximum number of notes. Such folders may be named after the notes in them (ie. “Folder 1—Notes 1 to 10”). It is to be understood that these folder naming options are simply exemplary. The folders, and their functionality, allow notes to be organized in any way a user desires, and allows for more efficient note-making and note-reviewing—not only for a single user of a given document, but between multiple users of a given document as well.

The process then continues at 954, where an expandable list of notes for each folder is placed under that folder in the folder pane. By way of example, a folder could be named “John's Notes” and could contain all the notes that John created in the document. At 954, when the “John's Notes” folder is added to the folder pane, an expandable list of John's notes would be added below it. This could be substantially similar to the way a folder, with further folders or files beneath it, are handled in Windows Explorer (trade mark). At 956, the first folder in the folder pane may be selected and expanded to reveal the list of notes under the folder. A notes pane may be populated with the notes from the list of notes for the first folder. Continuing with the “John's Notes” example, at 956, a separate notes pane may be populated with the notes (their content, name, creation time/date or other characteristics) that John created as he read the document. A user could then see that “John's Notes” folder is currently selected (as shown in the folder pane) and could see the notes that are in that folder (as shown in the notes pane). At the end of 956, the display screen may be essentially completed with respect to the folders and the notes in the folders. The display may therefore look, for example, similar to a folder view of Windows Explorer or the display in FIG. 12B.

The process then continues at 958 where the user may request to create a new folder. At 960, the user is prompted for a new folder name. This may involve a window or dialog box being presented to the user that has a section where they may edit or add text, then select an ‘OK’ button. At 962, the newly created folder with the new folder name is added to the list of folders. At 964, the folders, with the new folder, are added to the folder pane.

The process then continues at 966, where the user has the option of adding or removing a note to or from a given folder. At 968, the user selects the note and at 970, the user indicates where to move the note. At 972, if the note is to be deleted to the garbage then at 984, the note is deleted and removed from all folder lists. This may involve removing pointers to the note's data structure in various linked lists. If at 972, the note is not to be deleted to the garbage, then at 974 the process determines if the note is to be moved to another folder. At 976, the process determines whether a copy is to be made first. If so then at 980 a copy is made and the original is left in its current folder. The decision regarding whether to make a copy may involve receiving user input at 976. If no copy is to be made or if the copy has already been made at 980 then at 978 the note is moved to the selected folder and at 982, the list of notes in the folders is updated. The updated list may then be displayed so that the user interface is kept up to date.

It is to be understood that 958 and 966 are the beginning stages for large aspects of the functionality for this process. Although they are shown in chronological order where 958 occurs before 966, it is to be understood that 966 may occur before 958. Further, although the functionality beginning at 950 is depicted and described as occurring prior to 958 and 966, it may occur at any time and may reoccur through the process in FIG. 11C in order to maintain the accuracy of the displayed information.

As a further example of the functioning of notes, flags, and the screen that may implement them, FSIF 9c may be extensively used. FSIF 9c may have embedded information that allows a software component, such as renderer 35, to identify for example, notes and flags and the authors thereof. This may allow folders to be assembled as described above, and filled with appropriate notes and flags. Notes and flags information that may be embedded in FSIF 9c may further comprise folder information that may allow software components such as renderer 35 to create the folder structure as described herein.

Referring to FIG. 12A, a system utilizing notes component 108 is shown. The system includes UI 28 for a PC implementation of the system 20 comprising text display 1000, note tab 1002, file tab 1004, all button 1006, notes window 156 and note indicator 1008. In this embodiment, text display 1000 comprises substantially all of the UI 24, which comprises substantially all of computing device display 56.

Text display 1000, in response to the user of the PC 18 selecting to open the file from storage on the PC (not shown), shows the file that was received by the PC over link 118/124 from the core components, from FIG. 1. Such operation results in the file tab 1004 window being visible at the front and the text display 1000 containing the file. Notes window 156 is visible at the bottom of UI 28, and presents a list of notes for the file. The notes window may be removed when file tab 1004 is selected, if the user prefers. The all button 1006 provides one way for the user to begin parsing the file. Additionally, the user could highlight part of the text, right click and select a “parse” option (not shown) or place the cursor in the file, right click and select a “parse” option (not shown). The embodiments above are meant to be demonstrative only. If the user does select the parsing option, the relevant text begins to be presented to the user according to an output display process. The UI 28 and the output display process for such functionality will be described below. The UI 28 also comprises typical Windows (trademark) user interface functionality—a file menu, an edit menu, options menu, help menu, minimize, maximize and close buttons. The UI 28 may also present the user with information about the file that is open, including a word count, character count, and shortcut toolbar to perform typical operations such as saving the file and printing the file. Such functionality may be substantially similar to the functionality provided by other word processing applications such as Microsoft Word (trademark).

While reading the file in the text display 1000, system 20 provides that the user may insert a note or comment into the text. This can be done, in one embodiment, by right clicking in the text display 1000 and selecting an “Add a Note” option (not shown). When this option is invoked, the user may be presented with a text box to enter the note (see FIG. 13C). When finished entering the note, the user may click an “accept” or “OK” button and the note is saved. The note would be saved in the text in the location of the cursor before the user invoked the option. The newly created note would appear in the notes window 156 and a note indicator 1008 may be placed in the file, visibly in the text window 1000. The user may then be able to open or edit the note by selecting the note indicator 1008. Although the note indicator 1008 appears as a flag in FIG. 12A, it will be appreciated that many types of indicators could be used, including any shapes or coloring of the text or background or animation of the text having an associated note. If the user wanted to save the note, but not place it in a specific area of the file, a note could be created and saved to the file. If the user later wished to associate the note with a particular place in the file, it could be later associated with that place. By way of example, a user may create a note, prior to reading the file, that says “There must be a discussion about ‘squash’ in the file, do not forget to find it.” When the user reads the file and finds the appropriate reference, the flag can be associated with the location of the discussion about squash.

If the user selects note tab 1002, the user is presented the user interface as in FIG. 12B. Referring then to FIG. 12B, the UI 28 comprises note tab 1002, file tab 1004, notes window 156, note explorer window 1020, add node button 1022, delete node button 1024, delete note button 1026, generate note report button 1028 and organize notes bar 1030. In this embodiment, notes window 156 and note explorer window 1020 comprise substantially all of the UI 28, which comprises substantially all of computing device display 56.

Note explorer window 1020 and notes window 156 provide the core of the UI 28. Notes explorer window 1020 presents notes according to their folders, similar to Windows Explorer (trademark). The notes in notes window 156 may be placed in folders that are visible in notes explorer window 1020. Users can perform many operations, like with Windows Explorer, including adding folders, renaming folders, putting folders in folders, and moving notes between folders. This allows notes to be organized in many different ways, including by creator of the note. Although notes explorer window 1020 may preferably be on left side of UI 28, it may remain on the bottom, as in FIG. 12A.

Add node button 1022 allows a user to add a node, or folder, to the notes explorer window 1020. Delete node button 1024 allows a user to remove a node, or folder, from the notes explorer window 1020. Delete note button 1026 allows the user to delete the note that is currently selected in notes window 156. The generate note report button 1028 provides the user the option of producing a report of all the notes with a particular file or text. This report (not shown) may be printed, saved, emailed or handled in any way a user may wish. The organize notes bar 1030 provides general information, or status information, like a title.

### Notes Component and Parsing Component Combined

Referring to FIGS. 13A, 13B and 13C, a display of a computing device implementation of the notes system is shown comprising a toggle button 222, a display component 224 relating what section of the document a user is reading, text display 226, expand/contract button 228, cluster from file 230, page indicator 232, flagging option 1050, flag 1052, note associator box 1054 having notes associated icons 1056, 1058, 1060, note text box 1064 having note date 1066, note text input 1068 and OK button 1070. Toggle button 222, display component 224, text display 226, expand/contract button 228, cluster from file 230, and page indicator 232 are substantially the same as in FIGS. 3A and 3B and may optionally be removed.

Flagging option 1050 is a user interface menu item that allows a user to flag a sentence. In one embodiment of the invention, flagging option 1050 is presented via right-clicking on the mouse. It is to be understood that flagging option 1050 may be presented via many methods within the scope of the present invention, such as short-cut keys or other user inputs to a computing device 26. Further, the flagging option 1050 need not be implemented using a menu item that must be selected. In an alternative embodiment, flagging option 1050 may be implemented using short-cut keys alone, or via another user input that does not require a user interface component. Further, although flagging option 1050 is the only menu item that is visible in FIG. 5A, it is understood that other options may be presented at the same time, such as “Follow Hyperlink” or “Send Email to this Address”. Such other options may depend on the context of, for example, the contents of the file, the device being used, or the network that is enabling the communication.

Flagging option 1050 allows a user to flag the cluster from file 230 that is currently visible to the user. This may be employed to remind the user to re-read a section or sentence, or any purpose a user might have in flagging a portion of text. Although the flag that will be added to that cluster from file 230 may not be visible, or visible with that cluster from file 230, after that text leaves the screen, the flag will remain with, or remain associated with, that cluster from file 230. Hence, if a user were to switch to macroscopic view, there would be flag with that cluster from file 230. Additionally, during the time that cluster from file 230 is visible on the screen after invoking the flagging option, the flag may be visible (not shown in FIGS. 5A-C).

Flag 1052 is shown in FIG. 5B, after the flagging option 1050 has been invoked. Flag 1052 is shown as a flag in the upper right hand side, but may be implemented using any icon, placed in any location on the screen. Alternative ways to show the presence of a flag may include omitting flag 1052 and indicating the presence of a ‘flag’ by changing the appearance of the text having the flag, or the screen or background of the screen where the flag is located. Flag 1052, as shown, may be an embodiment to bring sufficient, but not too much, attention to the existence of a flag with a cluster from file 230. In one embodiment, the flag 1052 may be present in response to the user invoking flagging option 1050 or may be presented if, in parsing the file, a cluster from file 230 already has a flag associated with it. Further, the flag 1052 may become visible at substantially the same time, or at a different time from when the cluster from file 230 becomes. Flag 1052 may be removed at substantially the same time as, or at a different time from when the cluster from file 230 is removed.

Note associator box 1054 having notes associated icons 1056, 1058, 1060 is visible in FIGS. 5B and 5C. Note associator box 1054 provides a user interface component that may be used to show whether the flagging indicator 1052 has a note associated with it, such as the note displayed in note text box 1064 in note text input 1068. Note associator box 1054 may be visible only when a flagging indicator 1052 is visible, or may be persistently visible but preferably indicates the presence of a flag 1052 with a given cluster. Notes associated icon 1056 indicates that no note is associated with the currently displayed cluster that has a flag. In FIG. 5C, notes associated icon 1056 has been clicked, resulting in note text box 1064 being displayed, showing a blank note text input 1068 to add a note. This allows a note to be added to the flag 1052 that is associated with the currently displayed cluster. After the user adds text to note text input 1068 and selects the “OK” button 1070, notes associated icon 1058 and note associated icon 1060 are displayed in note associator box 1054, while note associated icon 1056 has been removed to the new presence of a note. Notes associated icon 1058 indicates that a note exists for the flag 1052 with the visible cluster and allows a user to view the contents by clicking on it. Notes associated icon 1060 allows a user to delete the note that is associated with the flag 1052. In addition, the ‘+’ sign in notes associated icon 1056 has been removed, resulting in notes associated icon 1058. It is to be understood that this is simply one way of displaying notes while parsing and enabling associating a note with a flag.

### Parsing Component Control Screens

Referring to FIGS. 14A and 14B, option screens for a computing device implementation of the system are shown, comprising options window 1100 further comprising tabs 1102, 1104, 1106, 1108, 1110. Each of tabs 1102, 1104, 1106, 1108, 1110 further comprise user interface elements that enable the user to configure operation.

As shown with tab 1108, speed options may be set, such as the amount of delay when presenting various punctuation. In FIG. 14A, the user may enter an amount of delay time, in milliseconds, for periods, exclamation marks, questions marks, commas, semicolons, and colons. Although such punctuation is shown, it is understood that other punctuation may be presented. Further, other manners of setting such time delays are considered, such as scroll bars. Additionally, these settings need not be configurable by the end user and may alternatively be preset in the software or adaptable by the software. For instance, such time delays may be a linear function of the reading speed, comprising an absolute minimum delay plus a percentage of the reading speed, such that users reading the document more quickly do not need to pause as long for mental absorption as those reading more slowly.

In FIG. 14B, tab 1110 has been selected, allowing cluster formation options to be set. Exemplary options include the number of words or characters that can form a cluster, and the types of words (such as articles, conjunctions, prepositions and customer words) that can start clusters. Tab 1110 further comprises view button 1124, notes button 1126 and add/view button 1128. View button 1124 allows a user to open a further window (not shown) and view the articles, prepositions, conjunctions and custom words, characters or otherwise that have been defined to start clusters. Finally, the add/view button 1128 allows a user to open a further window (not shown) and add words to a list of custom words that may start clusters. Although shown separately, view button 1124 and add/view button 1128 may be implemented using one button, that button allowing editing and viewing of the defined terms. Custom words that can start clusters can include any words. In one embodiment, such words are not any of the other types already set as being able to start clusters. In a further embodiment, a user may wish for only a few conjunctions to be able to start clusters. The user may then add those conjunctions to the custom word list, and de-select conjunctions so that they may not, as a general rule, start clusters.

Although tabs 1102, 1104, 1106, 1108, 1110 are shown and labeled, many other options may be available to a user. Such options may be presented in substantially the same manner, or in a different manner, such as a separate text file that may be edited, or registry settings. In addition, although option window 1100 may be accessible via display button 216 in compact mode, it may be accessed in other ways, from other modes.

Referring further to FIGS. 14A and 14B, tabs 1102, 1104, 1106, 1108, 1110 may further comprise user interface elements that enable the user to configure operation of various other software components of system 20 such as renderer component 35 (which may control, for example, the way any of the UIs 28 or screens described herein are displayed, for example with respect to their color, font, size, positioning and other characteristics), autosummary component 107 (allowing configuration of, for example, how long the summary may be relative to the original document being summarised), and ad integration component 1340 (allowing configuration of, for example, frequency of ads, location of ads, size of ads and other characteristics of ads—although it is to be understood that such settings may only be configurable by non-users such as manufacturers and may only be altered, for example, through software updates). Such configuration settings may be described, for example, with respect to Tables 1, 2 and 3.

It is to be understood that the screens shown in FIGS. 14A-B are exemplary only. Various configuration settings, as shown in FIGS. 14A-B and Tables 1-3 may be configurable by a user, such as using screens in these figures, or may simply be configurable settings. It is to be understood that as configuration settings and user configurable options change, so might the configurations settings files and the screens used to provide user configurable options. All of such variations are considered within the scope of the present invention.

### Table of Configuration Settings—Renderer Component

Table 1 below provides a summary of some of the possible configuration settings relating to renderer component 35. The table provides a description of the configuration setting, a selected value in one embodiment and whether the configuration setting may user configurable in the present embodiment. It is to be understood that there are many different descriptions, selected values, and user configurable combinations that are considered within the scope of the present invention.

Such configuration settings may relate to, for example:
Cluster shifting: providing an amount to shift if a cluster is deemed to be left heavy, right heavy, or neutral.
Document map: providing the number of levels (such as headings) to show as being open or expanded, for example in a default view.
Dates: providing whether a date can be altered (for example by a software component that recognises that the current format is harder to read than another format), and the format for a date to be changed to, for example to be read more easily.
Autosummary: how much of a summary to show, how many sentences to show, or how long the summary is desired to be.
Miscellaneous: whether to stop for section headings and/or figures and various pauses that may be add into cluster display.
Advertising: how long a rotation interval may be desired, or how many advertisements to show in a given period of time or relating to a given cluster or document.

TABLE 1
Configuration Settings - Renderer Component

| | | User |
|---|---|---|
| Cluster Shifting Configuration | Amount to Shift | Editable |
| Neutral | — | N |
| Left Heavy | Shift Right 1 | N |
| Right Heavy | Shift Left 1 | N |
| | Configurations | |
| Document Map | | |
| Default Number of Levels to open | 3 | Y |
| Dates | | |
| Date Alteration | OFF | Y |
| Format for Date change | dow, mmm dd, yy | Y |
| AutoSummary | | |
| Default percentace of summary to show | 25% | Y |
| Minimum Number of Sentences to show | 3 | N |
| Miscellaneous | | |
| Stop on Sections Headings (Stop, Pause, No) | NO | Y |
| Pause length in delays for Headings | 5 delays | N |
| Stop on Figures (Stop, Pause, No) | NO | Y |
| Pause length in delays for Figures | 10 delays | N |
| Advertising | | |
| Rotation interval in seconds | 120 | |

### Server Based System

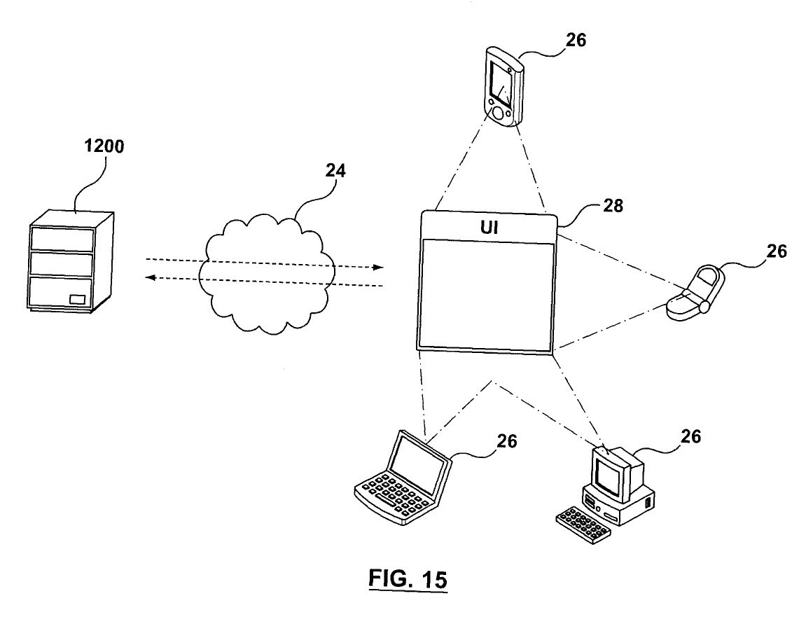

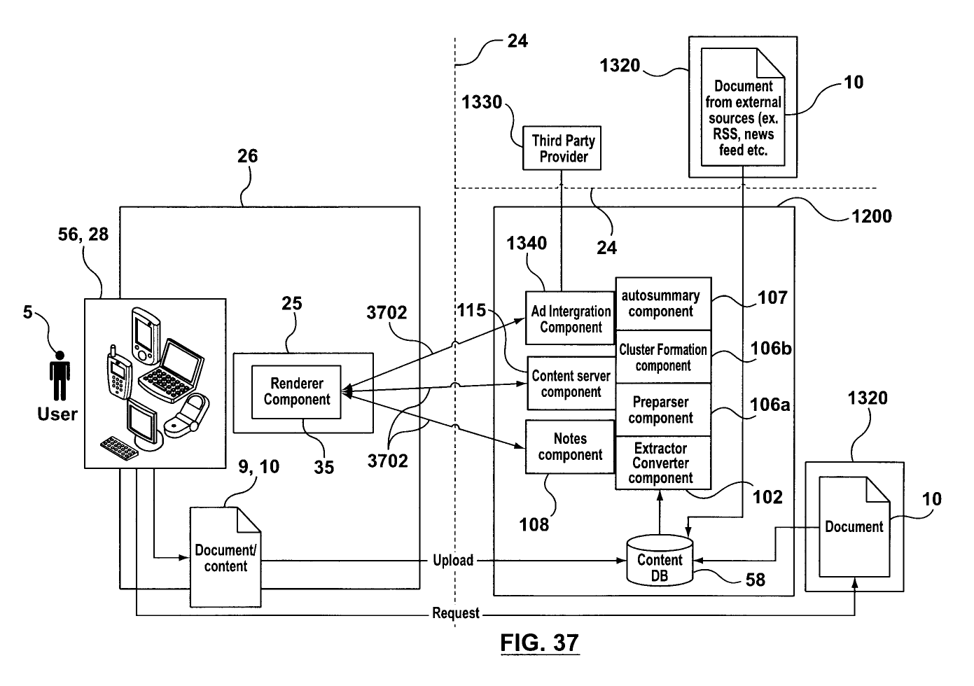

Referring to FIG. 15, an alternative embodiment of the present invention is shown further comprising server components 1200; with various portions of system 20 being located at server components 1200. Such alternative embodiment may be similar to that shown in FIG. 37. Like reference numbers are used to refer to like elements as shown throughout this application. Server components 1200 may comprise known server systems having the ability to run applications, store information, and various other functions as are customary for a server to perform. Server components 1200 may provide the processing required for operation of the system 20 and may also include a display for monitoring the system 20, or performing other portions of the system 20. In this alternative embodiment server components 1200 may implement converter components 102 and core components 104. Link 118 would then be used to provide the document to the user interface of the computing device 26 or to provide clusters of the document from the parsing component 106 for viewing on the user interface of the computing device 26. Link 118 could be a wired link, but would optimally be a wireless link. It is to be understood that any division of processing and division of converting, parsing and notes is contemplated depending on the demands and capabilities of the links 121, the particular computing device 26 (such as its processing power and storage), and the application either the notes component 108 or parsing component 106 are to be used for. By way of example, if the clusters of information are to be presented at regular, and fast intervals, such operation would require a reliable and fast communication network between the server components 1200 and the computing device (essentially link 118/121). A computing device located in an area of weak signal strength for a wireless network, or on a congested base station of the wireless network may not be suited for such operation. However, a PC 18, located on a high-speed LAN, may be well suited for such operation. Parsing and notes may also be implemented separately or only one may be implemented at all.

### Advertising Model

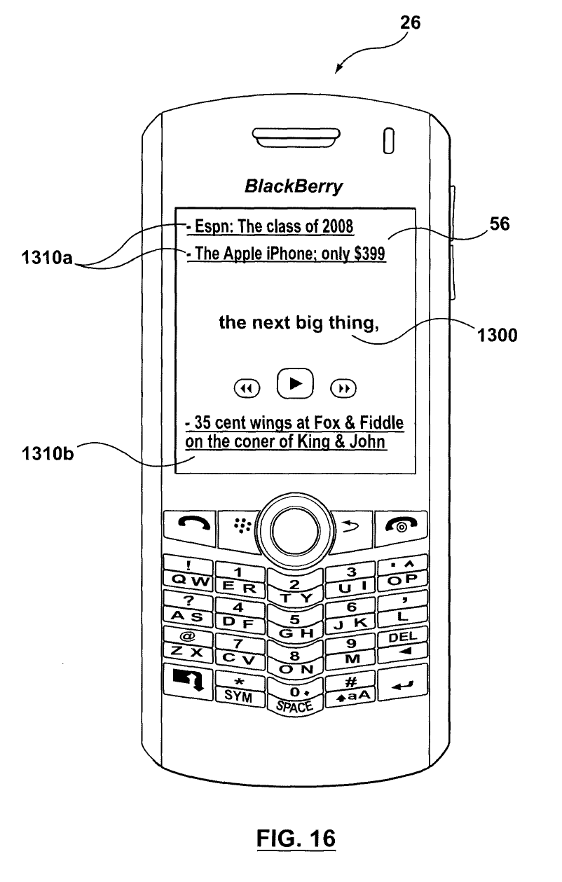

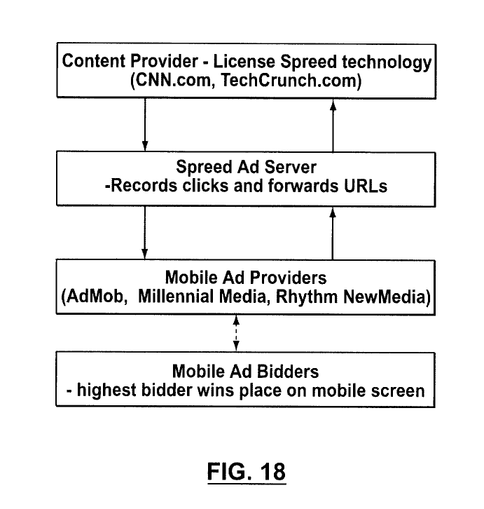

Referring to FIGS. 16 to 18, a system and method for delivering advertisements together with content is shown. “Content” is used herein to refer to any input data that has been parsed into clusters or otherwise modified for display with a limited number of characters visible at one time. The delivery of advertisements and content in this manner is particularly advantageous for use with computing devices 26 having relatively small display screens, such as cell phones and PDA's, where there is limited area on the display screen to display such items. It is conceivable that content might similarly be displayed on large screen displays in desired situations such as electronic billboards.

FIG. 16 depicts a computing device 26 having a display 56. Content 1300 is shown being displayed via UI 28 on the display 56. Advertisements 1310 are also displayed via UI 28 on display 56 adjacent to the content 1300. Advertisements 1310 can be selected for display either randomly or in accordance with predetermined criteria. For instance, advertisements 1310 can be selected according to the nature of the content 1300 selected for viewing by the user such as described in more detail below. Alternatively, advertisements 1310 can be delivered based on the location of the computing device 26, such as may be determined by a GPS provided with the computing device 26, based on demographics of the user as determined by previously uploaded user data, based on demographics associated with the style and model of computing device 26 being operated by the user or based upon other desired criteria. The content 1300 and advertisements 1310 are preferably displayed via UI 28 on the display 56 in a manner that optimizes the ability for the user to view the content 1300 and the advertisements 1310 in order to have the best impact upon the user. In the embodiment depicted in FIG. 16, the content 1300 is displayed centrally on the display 56 with links to content-based advertising 1310a displayed above the content 1300 and GPS-based advertising 1310b displayed below the content 1300. To be clear, the arrangement of the content 1300 and one or more advertisements 1310 can be varied according to preferences of a content provider or, optionally, preferences of the user. It is also conceivable that the user may opt for no advertising 1310 to be displayed with the content 1300. Such an option might have an associated cost premium for the user in order to receive the desired content.

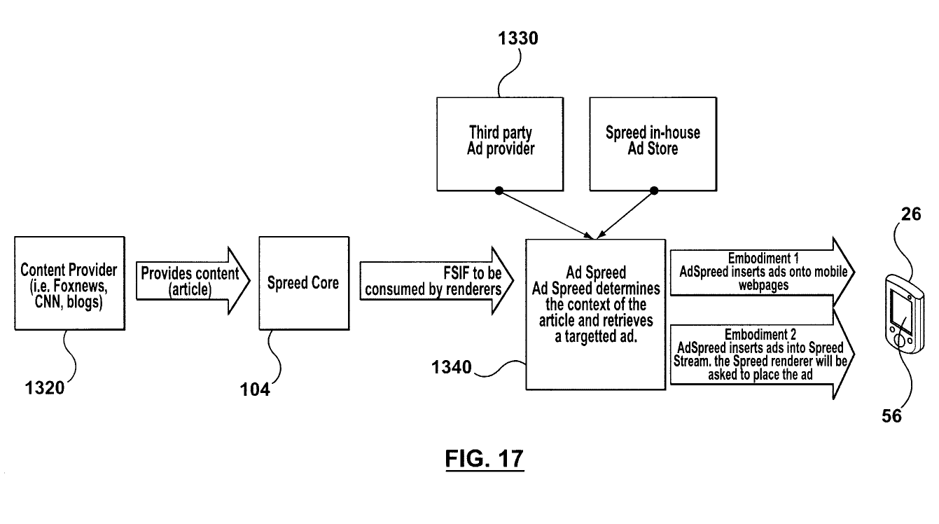

Referring to FIG. 17, a system for delivering the advertisements 1310 together with the content 1300 is shown. A content provider 1320, such as a news source, provides content 1300 for delivery to computing device 26. The content 1300 may comprise specific articles that a user may select for review via UI 28 on the computing device 26. The content 1300 may be generated using the converter components 102 and/or core components 104 as described herein or other suitable tools and techniques for modifying input data for display with a limited number of characters visible at one time. The content generation process may be conducted by the content provider 1320 or by an advertising provider or other third party for delivery to computing device 26 in accordance for instance with the server based model described and shown in FIG. 15. Alternatively, the content may be generated by user's computing device 26 in accordance for instance with the other embodiments described above.

The content 1300 provided by the content provider 1320 can be searched in its entirety by an advertising provider 1330 to identify advertising 1310 that suits the demographics of potential viewers of the content 1300. Alternatively, the content provider 1310 can provide key words associated with the content 1300 that can then be processed by the advertising provider 1330 to identify suitable advertisements to display with the content 1300. Such key key words may be obtained from FSIF 9c, for example, and may have been generated or identified by one or more of autosummary component 107, preparser component 106a and converter component 102. It will be appreciated that content provider 1320 and advertising provider 1330 can be separate entities or can operate within the same entity. It is also conceivable that there will be multiple advertising 1330 providers depending on factors such as the nature of the content 1300, the type of device 26 the content 1300 is being delivered to, the facility for bids for the placement of advertisements 1310 or other factors.

Once one or more advertisements 1310 have been selected for placement with the content 1300, the selected advertisements 1310 and the content 1300 may be delivered to the computing device 26 for access by the user via UI 28.

The advertising 1310 may be delivered to computing device 26 together with the content 1300 in a number of different ways. In one embodiment, the selected advertisements 1310 may be displayed on the display screen 56 of the computing device 26 adjacent to the content 1300 such as is depicted in FIG. 16. The user is thus able to view the content 1300 while the advertisements 1310 (or links to the advertisements 1310) are displayed adjacent to the content 1300. In an alternate embodiment, the advertisements 1310 may be inserted into the input file stream such that the advertisements 1310 are rendered on the display in conjunction with the content 1300. Such advertisements may still be presented adjacent to the content as depicted in FIG. 16, or may be presented at desired intervals between clusters.

The placement of advertisements 1310 in accordance with the present invention may be managed by an advertising provider broker 1340 that serves as a broker between the content provider 1320 and third party advertising providers 1330. For instance, the content provider 1320 or advertising provider broker 1340 may utilize the parsing component 106 in accordance with the present invention or other technology in order to generate content 1300 from one or more articles provided by the content provider 1320. The advertising provider broker 1340 may then forward the content 1300 to one or more third party advertising providers 1330 who perform a search on the content 1300 to identify one or more relevant advertisements 1310 to associate with such content 1300. The advertising provider broker 1340 will identify the highest bidder for advertising space among the third party providers 1330 (assuming multiple bids are received) and place a link to such bidder's advertisement 1310 for display on the display screen 56 of a user's computing device 26, together with the content 1300 provided by the content provider 1320.

Specifically, the following steps may be utilized in such an advertising model: (i) content 1300 from the webpage of the content provider 1320 is requested by a user via the UI 28 of user's computing device 26. The content 1300 is then generated for display on the computing device 26; (ii) concurrently, advertisements 1310 for display with the content 1300 are requested by the content provider 1320. The content provider 1320, for example, passes key words associated with the content 1300 to a server provided by the advertising provider broker 1340; (iii) the advertising provider broker 1340 passes the key words to one or more third party advertising providers 1330 and makes a record in its data base of the request from the content provider 1320 for advertisements 1310.

The third party advertising providers 1330 review the selection of advertisements 1310 they have available from their advertising bidders and select the highest bidder having advertising 1310 that meets the demographic (or other criteria) to present the advertising 1310 to the advertising broker 1340. The third party advertising providers 1330 present the selected advertisements 1310 to the advertising provider broker's 1340 server together with their bids.

The advertising provider broker 1340 selects (for example) the three highest bids and forwards the advertisements 1310 together with the advertising provider broker's 1340 server URL to the content provider 1320. Beforehand, the advertising provider broker 1340 records in its database the advertisements 1310 provided to the content provider 1320.

The content provider 1320 inserts the advertisements 1310 provided by the advertising provider broker 1340 into the input data stream which is then used to load onto the webpage visible to the user via VI 28 on the computing device 26. The webpage is now displayed to the user with the advertisements 1310 together with the content 1300 of the article parsed into clusters for display in accordance with the present invention.

If a user clicks one of the advertisements 1310, it is recorded in the advertising provider broker's 1340 database.

The advertising provider broker 1340 then forwards the user to the corresponding link of the advertisement 1310.

### By Way of Specific Example:

a user clicks on a link to an article regarding the Toronto Raptors basketball team that is provided by CNNSI. The Raptor's article is parsed into clusters in accordance with the present invention or other suitable technology and assembled as content 1300 to be displayed via UI 28 on the computing device 26. Alternatively, if the article has not yet been parsed into clusters, this process is conducted either through the content provider's server or through a parsing component or the like disposed on the computing device 26.

CNNSI then requests advertisements 1310 from the advertising provider broker 1340 server by, for example, passing key words from the article to the broker. In this case, the key words for instance might be “Raptors”, “Bosh”, and “playoffs”.

The advertising provider broker 1340 server then records the CNNSI request in its database and forwards the key words to a third party advertising provider 1330. The third party advertising provider 1330 then uses the key words to perform a search and find all bidders with relevant ads for placement with the identified content. The highest bidder is selected and then the ads are forwarded to the advertising provider broker's server.

For example, ten advertisements might be selected for delivery to the advertising provider broker's server. Out of the ten advertisements that are delivered to the server, the advertising provider broker 1340 then selects the highest three bidders and records them into its database. The broker then forwards the ads to the content provider 1320. As an example, one advertisement could be from ESPN, another could be Ticketmaster, and the last could be from Foot Locker using the GPS on the user's computing device to identify a sale currently occurring at a location nearby to the user.

The content provider 1320 then inserts the advertisements 1310 into the data stream that is then loaded into the browser of the computing device 26.

In addition to viewing the content by the content provider 1320, the user has the option of clicking on one of the advertisements 1310 presented together with the content 1300. If the user clicks on the ESPN advertisement, this is recorded in the database of the advertising provider broker. The advertising provider broker then finds the corresponding URL for the advertisement 1310 in its database.

The advertising provider broker 1340 then forwards to the user the advertisement selected by the user.

Accordingly, the present technology enables content providers 1320 to utilize space for advertisements 1310 on computing devices 26 such a device having relatively small screen sizes (such as cell phones and PDA's) where such space would normally not be available for such content providers. The technology provides content providers 1320 with a chance to earn revenues through mobile user access of their websites through advertisements 1310. The advertising providers 1330 have a new market to display their advertisements 1310 and earn a percentage for every click. The advertising provider broker 1340 is able to facilitate the placement of advertisements 1310 and make a percentage of revenues associated with such advertising. For instance, the advertising provider broker 1340 may record all of the clicks and know exactly how much money was generated by each advertising provider 1330. The advertising providers 1330 collect the revenues from the advertising bidders. They take their share and send the remainder of the revenues to the advertising provider broker 1340. The advertising provider broker 1340 pays out a percentage of the revenue to the content providers and keeps the remainder.

FIG. 19 is a block diagram of an alternate embodiment of system 20 in accordance with an embodiment of the present invention. System 20 in FIG. 19 may have similar elements, and be similar to, system 20 in FIG. 1. Like references are intended to be like elements and may be substantially similar to those elements unless further described herein. System 20 will be further described through description of its operation. System 20 as described and shown in FIG. 19 and all subject matter described and shown in relation to the subsequent figures comprise the currently preferred embodiment of the invention described herein.

Operation of system 20 may begin with content 10 being provided from an input data source to system 20, for system 20 to process. By way of example, user 5 may select content 10 or a document 9 and request or indicate that it is to be used in system 20. Such document 9 may be, for example, a Microsoft Word (trade-mark) document, Adobe (trade-mark) document, RSS feed, or other documents 9 or input data source. User 5 may select document 9 from, for example, storage 58 of computing device 26 or server component 1200, a third-party web site, content provider 1320, or any other remote or local file or document 9. Selection of file 9 need not be initiated by user 5. As an example, and as described herein, system 20 via, for example, content server 115 and/or converter components 102 may poll various web sites and content providers 1330 to receive content to be processed by system 20. As described herein, in one exemplary embodiment, system 20 may poll CNN.com every three hours for news feeds. Such news feeds may be processed by system 20 and stored in storage 58 so that user 5 may later request and view or otherwise manipulate the news feed (content 10) using system 20.

File 9 may then be provided to converter component 102 to be converted into system internal format (SIF) 9a. Conversion may be substantially as described herein. SIF 9a may include, for example, header information, table of contents identification, items of interest, or other information that may have been obtained from data that comprises something other than the body or text in document 9.

### Preparser Component

SIF 9a may then be provided to core component 104 and directed to preparser component 106a of parsing component 106. When SIF 9a is preparsed by preparser component 106a, further items of interest or special text may be identified, for example by preparser component 106a identifying spacing or other font/textual differences indicative of items of interest. Such further items of interest or special text may be labeled or otherwise identified and may include email addresses, postal codes or other section/heading information that, for example, a user may have put into a Microsoft Word (trade-mark) document simply by bolding or italicizing a portion of the document without using the ‘heading’ functionality of Microsoft Word. Such information may not be identified by converter component 102. After preparser component 106a operates on SIF 9a, the resulting file is now in a system internal format enhanced (SIFE) 9b. Such SIFE 9b may be provided to 106b for cluster formation and a copy thereof may be provided to auto-summary component 107, described herein, for performing summary processing. SIFE 9b may then be provided to cluster formation component 106b.

Cluster formation component 106b may process SIFE 9b to be displayed in clusters, as described earlier with respect to FIGS. 5-10 and 25-35. As a result of cluster formation component 106b operating on SIFE 9b, file 9 may be converted into final system internal format (FSIF) 9c. As shown in FIG. 19, FSIF 9c may be stored at storage 58.

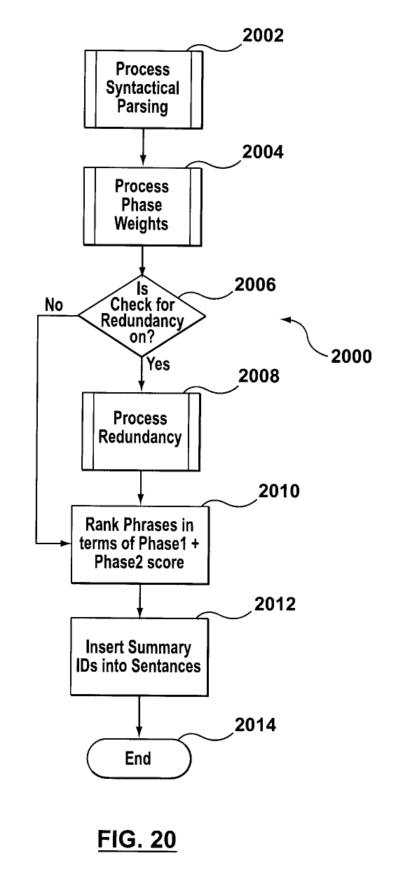

Autosummary component 107, as described herein and in particular with respect to FIGS. 20-23, may add information to FSIF 9c to allow the summary functionality of autosummary component 107 to be used, for example via navigation tabs 215b-c and the screens of FIGS. 38-39. It is to be understood that although not shown in FIG. 1, system 20 and/or core components 104 may further comprise autosummary component 107.

All, or substantially all, of the processing that occurred after, for example, a user indicated they wished to have file 9 operated on by system 20 may occur substantially automatically. FSIF 9c may be ready to be provided to device application 25 visible on display 56 and its UI 28, by content server component 115 communicating with renderer component 35. Content server component 115, device application 25, and renderer component 35 may be substantially as described herein and may allow user 5 to read file 9, via FSIF 9c, according to an aspect of the present invention.

User 5, as they are reading FSIF 9c, may add notes or flags to FSIF 9c, for example, using the functionality of notes component 108. To do so, notes component 108 may directly communicate with FSIF 9c through storage 58 or may communicate with content server component 115 to do so. Alternatively, notes component 108 and/or its functionality may be accessible by a device application 25 and/or rendered a component 35, such as via one or more APIs. In such embodiments notes and flags may be added to FSIF 9c by directly accessing FSIF 9c or by a content server component 115.

Advertisements may also be incorporated via ad integration component 1340. Such integration of advertisements may be substantially as described herein.

### Renderer Component

Renderer component 35 may interacts with user 5. It can run on any computing device 26 and any display or screen therefor. Renderer component 35 may interpret an FSIF 9c provided to it and display FSIF's 9c contents as required by the functionality that user 5 or another party or system is requesting (such as reading clusters, viewing a summary etc, view and add flags/notes). As such, rendered component 35, or other software components, may determine desired data from FSIF 9c for displaying on a display or UI.

Renderer component 35 emphasizes focus on the functionality being used, in an ergonomic way (such as preventing or reducing eye fatigue), while removing visual distractions. Renderer component 35 may produce all of the screens and displays described herein, with the attributes, desirable features and functionality related thereto. Renderer component 35 may alter or select fonts, contrast, colors, size of text, relative sizes, location of ads and other aspects of any of the screens or displays described herein.

Renderer component 35 may allow a user to interact with any of screens, displays and user buttons. Much of such interaction has been described herein with respect to the various screens and displays in the various Figures. As a further example, user 5 may be able to highlight a word or group of words and perform an Internet Dictionary or Thesaurus lookup, or an Internet keyword search based on the highlighted words. Such functionality may be enabled by renderer component 35.

Renderer component 35 may be responsible for displaying advertisements and may pull out ads that were inserted into an FSIF and place them on the screen or display. FSIF may contain many ads, such as one ad per sentences or cluster. However, renderer component 35 may not display every ad and may display ads according to a set of rules that may be specified, for example, in one or more configuration settings or options screen. Such settings or options screen may take into account the size of the relevant display—optionally displaying fewer or smaller ads on computing devices 26 having smaller displays 56 or UIs 28.

Ads may be displayed in reading, notes, items of interest, or autosummary views (as in FIGS. 2A-C, 12-13, 38 and 39 respectively) and may be displayed differently between such screens and during different operation of such screens. Such ads may be displayed anywhere on UI 28, but may preferably be displayed at or near the upper extremity of UI 28 or the lower extremity of UI 28, for example below the controls.

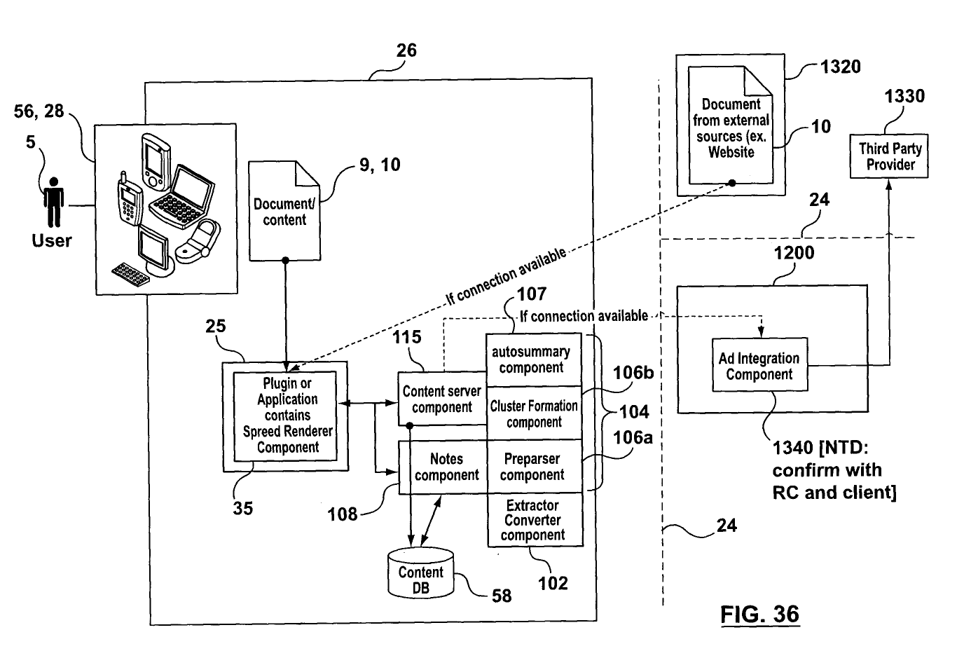

It is to be understood, with respect to FIG. 19 and system 20, that many variations of the illustrated embodiment are possible and are within the scope of the present invention. By way of example, notes component 108 and/or ad integration component 1340 may be part of core component 104, auto summary component 107 may not be part of core component 104, and various other components may implemented in the same module or may be more separate than shown in FIG. 19. Further, and as described herein with respect to FIGS. 36 and 37, any of the elements of system 20 may be located at the same location or may be remote from one another, and may be implemented using the same or different hardware and/or software modules. Any distribution of such elements and their functionality are considered within the scope of the present invention.

### Autosummary Component

FIGS. 20-23 are flow charts of process 2000 for autosummarising a document 9 or other input data source in accordance with an embodiment of the present invention. Process 2000 may be implemented, for example, in software and may be implemented, for example, by one or more of autosummary component 107, content server component 115 or renderer component 35.

Autosummarising may employ or include any suitable form of autosummary process, such as “abstraction” or “extraction”. One example of autosummary process may be found in Wang Zhiqi, Wang Yongcheng, Liu Chuanhan, and Liu Derong, “An Automatic Summarization Service System Based on Web Services” in Proc. Fifth International Conference on Computer and Information Technology (CIT'05), 2005, the entire contents of which are hereby incorporated herein. In one embodiment, process 2000 is an “extraction” technique where a subset of the full document or text is identified that reflects the contents of the entire text or document. Process 2000 may be used, for example, in conjunction with one or more other features of the present invention. Process 2000 may assist a reader, for example, in more quickly reading and understanding the contents of document 9. Process 2000 may be the final step in processing document 9 or may be in an intermediary step. By way of example, after process 2000 is executed the resultant summary (which may be referred to as summarised final system internal format (SFSIF)) may be displayed to a user of a mobile communication device or personal computer such as a laptop, allowing a user to more accurately and thoroughly analyse the document and perhaps to quickly re-read it via the summary. In another embodiment the resultant summary may be provided to another module that may, for example, read the summary out loud or simply display the SFSIF. In a further embodiment, the resultant text may simply be stored, for example, to be used at a later time. It is to be understood that after process 2000 is executed, instead of directly producing an SFSIF, information may be added to an FSIF that allows an SFSIF to be easily obtained (such as by renderer component 35 or content server 115). In a further example, user 5 may be presented an option to see the items of interest (as in FIG. 39) or a summary (as in FIG. 38) for a particular section, for example, that was just read.

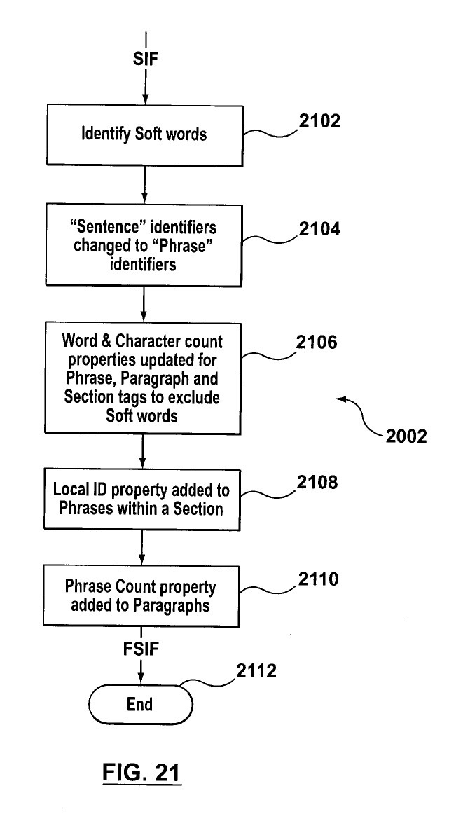

Process 2000 begins at 2002 where SIF 9b may be parsed according to its syntax, which may include tags such as XML tags or Regular Expressions, in order to detect textual structures and/or process syntactical parsing. Syntactical parsing, as at 2002, is further described herein and with respect to process 2002 in FIG. 21. Briefly, at 2002 process 2000 may identify textual structures such as sections, paragraphs, and sentences and add information to SIF related thereto. Further, various punctuation may be removed from the text, such as periods. The extent to which punctuation is removed may depend on, for example, whether the punctuation conveys expression that is meaningful for a given sentence, such as an exclamation mark or question mark. At 2002 “soft” words may be identified in the given sentences and text. The “soft” words may be preserved or may be removed in various aspects of the invention. In addition, at 2002, various attributes relating to the document or text that is being summarized may be determined and stored in the SIF. Exemplary attributes may include word counts, punctuation counts, and various other details relating to the document or text to be summarized.

The functionality described at 2002 may be performed by one or more modules or components of system 20, such as preparser component 106a or cluster formation algorithm 106b, which may be, for example, part of converter components 102, core components 104 or parsing components 106. It is to be further understood that the functionality described throughout process 2000 may be performed by one or more modules or components of system 20 that may be on the same or different hardware and may be local or remote from one another.

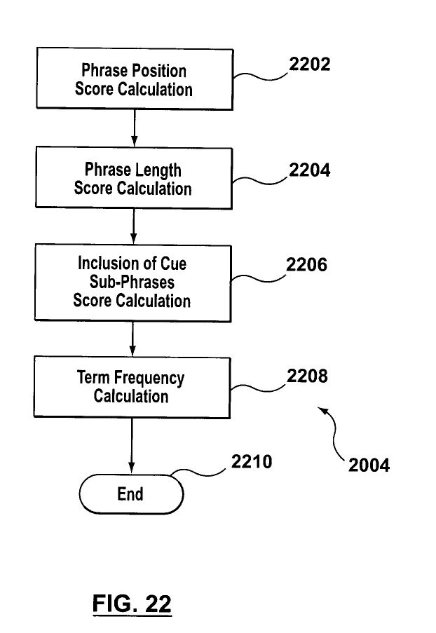

Process 2000 continues at 2004 where phrase weight or score may be processed. Such phrase weight may be used to determine whether a specific phrase should be included in the summary or whether it can be omitted. Phrase weighting, as at 2004, is further described herein and in particular with respect to process 2004 in FIG. 22. As used herein, the term “phrase weight” is used to indicate a relative importance of a phrase—where more important phrases may be given a higher weighting. Determining and/or calculating a phrase weight or score may involve many factors such as phrase position, phrase length, inclusion of cue subphrases, and term frequencies. Such concepts are further described with respect to process 2004 in FIG. 22. It is to be understood that various embodiments of these factors, and other factors that relate to the importance of a phrase in a particular document or text, may be used together in various combinations, omitted as necessary, and may be given different weights and relative weights to achieve optimal performance for any particular application. It is to be further understood that the term used, and the manner by which the weighting is calculated and measured may vary substantially while remaining within the scope of the present invention.

Process 2000 continues at 2006 to query whether checking for redundancy is enabled. If such check is not enabled, then process 2000 continues at 2010 where phrases may be ranked based on, for example, their phase 1 and phase 2 scores from process 2004 (as further described with respect to process 2004 in FIG. 22). It is to be understood that at 2010 the phrases, having been evaluated based on various factors, may then be ranked in order to best determine which phrases should be kept as part of the summary. The manner by which this is achieved and the criteria that are used may vary substantially while remaining within the scope for the present invention.

After a rank is determined at 2010, process 2000 may proceed to 2012 where summary identifiers are inserted into sentences of the SIF 9b, which may include a rank among non-redundant phrases or sentences, that may be identified as sentences with tags such as XML tags. Process 2000 then terminates at 2014, where a summary of document 9 originally provided to process 2000 is available to be used. As described herein, this may involve adding information to FSIF 9c that would allow another component to produce a summary.

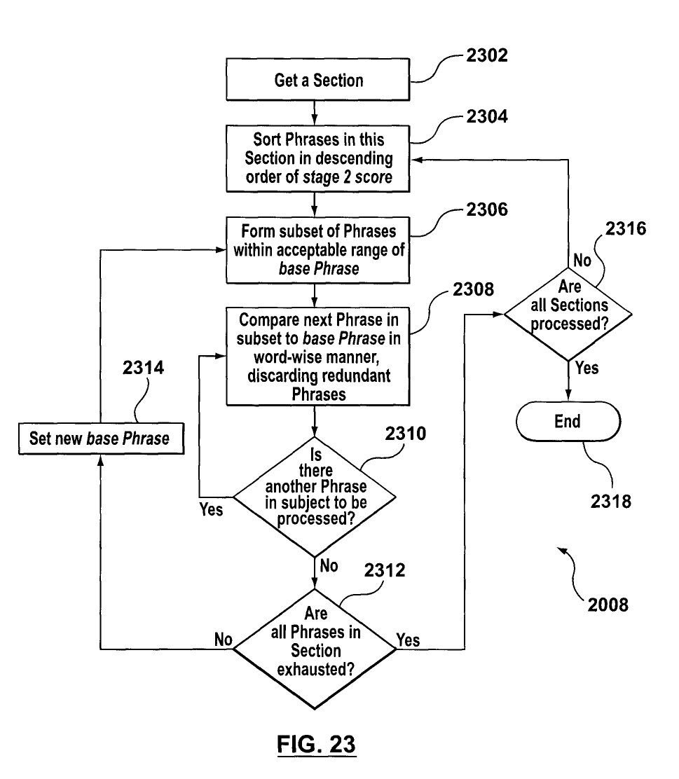

Returning to 2006, if the check for redundancy is enabled, then process 2000 continues at 2008 where redundancy checking and processing occurs. At 2008 process 2000 attempts to reduce the length of the summary by omitting redundant phrases from the summary. This may be accomplished in many ways and with various techniques. Processing redundancy at 2008 may include, for example comparing the number of times a word is used in a given document and keeping more words that are frequently used, comparing the similarities between phrases to attempt to omit phrases, for example by using tools such as a dictionary and/or a thesaurus, and considering punctuation within a particular phrase. For example, the check for redundancy may check sentences within a similar score range and may compare the sentences word-wise (each word of one sentence being compared to each word in the other, where such comparison may be enhanced through reference to a dictionary or thesaurus) for the same and/or synonymous word usage. A redundancy scoring system may be used to tabulate the number of synonymous words. The higher the redundancy score, the higher the likelihood that the sentences are redundant and that one of them may be discarded. It is to be understood that various other ways of determining redundancy in sections, phrases, and sentences are considered within the scope of the present invention. Exemplary techniques for omitting redundant phrases may be described herein and in particular with respect to process 2008 in FIG. 23.

FIG. 21 is a flowchart of process 2002 for syntactic processing. Process 2002 begins at 2102 where soft words are identified and may be removed or may simply involve identification thereof. Soft words may be words adding limited meaning to the sentence and may include words such as “a” and “the”. What constitutes a “soft word” may be determined, for example, by referring to a pre-defined list of soft words. Identification of soft words at 2102 may include, for example, noting their position, noting the number of occurrences for each soft word, or other functions that may be desirable to maintain properties and characteristics of the document or text being summarized, such as SIF 9b or a copy thereof.

Process 2002 then continues at 2104 where sentence identifiers are changed to phrase identifiers. Sentence identifiers, as contemplated herein, may include information embedded in FSIF 9c that identify a sentence, such as “<Sentence>”; may include information embedded in FSIF 9c that identify a phrase, such as “<Phrase>”. Process 2002, at 2104 may further involve amending characteristics or data stored with and associated with SIF 9b so as to indicate that a sentence has now become a phrase.

At 2106 various properties of SIF 9b and document 9 are amended or updated. Exemplary properties may include word and character counts, phrase counts, paragraph counts, section tags and whether to exclude soft words or not. Such amending or updating may further updating based on other portions of process 2002, such as the removal of periods or other sentence identifiers and the exclusion/identification of soft words.

Process 2002 then continues at 2108 where a further one or more properties may be added to each phrase within a section or within SIF 9b. Such property may indicate, for example, the location of the phrase within a paragraph, section or the document in its entirety, such as via one or more phrase IDs. Other properties that may be included comprise a cluster count, word count, one or more delay counts, an algorithm ID (for example to indicate which algorithm was used to parse the phrase), and a summary rank.

At 2110 phrase counts may be added to paragraphs within a section or SIF 9b in general. As a result of 2102 to 2110, an autosummary intermediate stream may be produced, or information may be produced to add to SIF 9b or FSIF 9c, by process 2002, and may be provided for further processing. Process 2002 then ends at 2112 and returns to process 2000 at 2004.

FIG. 22 is a flowchart of process 2004 for processing phrase weights. Assigning a weight to each phrase may be used to determine whether a specific phrase should be included in the summary or whether it may be omitted therefrom.

Process 2004 begins at 2202 where phrase position scores may be calculated. The position of a phrase within the document may be an important indication of a phrases importance; the weighting process may favor phrases closer to the start or end of a paragraph as these phrases typically contain information which introduces a new topic or that summarizes the topic discussed by the paragraph.

The local ID property, that may be identified in process 2002 for SIF 9b, may be used to determine the relative position of phrases within a paragraph. A position score may then be assigned to each phrase, for example based on a calculation which weights each phrase within the paragraph in a manner that is linearly proportional to it's position relative to the start and end of the paragraph, scaled by the length of the paragraph. The equation below further describes one embodiment for assigning position scores, which may be one portion of phrase scores:

$$position score = \{ \begin{matrix}{k}_{1} ( 1 - {α}_{i} - α \frac{β}{2} ) , & {α}_{i} \leq floor ( \frac{β}{2} ) & & \\ 0 , & {α}_{i} = ceil ( \frac{β}{2} ) , & β odd , & 1 < i \leq β \\ {k}_{1} ( {α}_{i} - ( ceil ( \frac{β}{2} ) + 1 ) ) , & {α}_{i} \geq ceil ( \frac{β}{2} ) & & \end{matrix}$$

Where:

β=paragraph phrase count
λᵢ=phrase local ID of ‘i’th phrase—it begins at 1
αᵢ=λᵢ/β, Normalized Phrase Local ID of ith Phrase
floor is a function which rounds its arguments to the next lowest integer
ceil is a function which rounds its arguments to the next highest integer
k₁=multiplicative constant which determines the relative importance of the Phrase Position score in the stage 1 score

Application of this equation to a paragraph having 13 phrases may result in phrase scores according to the graph below:

Process 2002 then proceeds at 2204 where a phrase length score is calculated. Phrases that are either too short or too long cannot, or do not, contain information that is as useful as those that are close to the median length of a phrase within a section. Therefore, each phrase is provided with a length score that is compared to the median length of a phrase in the current section or paragraph. The equation below further describes one embodiment for assigning length scores, which may make up a portion of the phrase score:

$$length score = \frac{100 - {( {γ}_{i} - {μ}_{γ} )}^{2}}{100}$$

### Where:

γᵢ=Word Cound of ‘i’th Phrase
μ_{γ}=mean length of Phrases in current Section
k₂=multiplicative constant which determines the relative importance of the Phrase Length score in the stage 1 score

Process 2004 then continues at 2206 to include cue sub-phrases scores as required. A cue sub-phrase may indicate that the given phrase is summarizing the document or section, or as in another way important for the summary and should be included. Exemplary cue sub-phrases may include, for example, “in conclusion” or “in this paper”. Additionally, there may be a distinction between cue sub-phrases at the beginning or at the end of a paragraph or section. Thus, cue sub-phrases may be weighted differently based on their location. The equation below further describes one embodiment for cue sub-phrase weighting:

$$cue score = \{ \begin{matrix}max ( position score ) , & \begin{matrix}conclusion - type cue sub - \\ Phrases present\end{matrix} \\ \begin{matrix}second - highest \\ position score ,\end{matrix} & \begin{matrix}introductory cue sub - \\ Phrases present\end{matrix} \\ 0 , & no cue sub - Phrase present\end{matrix}$$

Where:
max denotes the maximum function, which chooses the highest value of the function
k₃=multiplicative constant which determines the relative importance of the Cue score in the stage 1 score

After 2202, 2204, and 2206, process 2004 may determine a score based on the scores obtained during these processes. Such score may be a stage or phase 1 score of a phrase weight calculation or process. The equation below further describes one embodiment for calculating stage 1 scores:

Stage 1 score=(position score+length score+cue score)

Where:
m₁=multiplicative constant which determines the relative importance of the stage 1 score in the overall phrase score

It is to be understood that other factors may be considered in determining a phase 1 score. Such factors may be indicators that a phrase, paragraph or section are more important than other phrases, paragraphs or sections. One exemplary additional factor may be weighting where paragraphs (and possibly the phrases and/or sentences therein) are weighted more heavily if they are near the beginning or end of a section or of the document as such paragraphs may be more fundamental than, for example, paragraphs in the middle of a section or document.

Process 2004 then continues at 2208 to calculate a term frequency. The term frequency of a word may be the number of times the word appears in the document compared to, or divided by, the total number of words in the document or section. Soft words may be excluded for this determination, or may not. It is further contemplated that a term frequency may have attributes relating to the total number of words in the document or relating to the total number of words in a paragraph or section as different words may have different importance in particular sections or paragraphs. Such term frequency may be considered a stage or phase 2 score. The equation below further describes one embodiment for assigning or calculating a stage or phase 2 score:

stage 2 score=Σ(TFs for each word in Phrase)×(m₂)

Where:
m₂=multiplicative constant which determines the relative importance of the stage 2 score in the overall phrase score

After 2208, process 2004 may combine or add the stage 2 score with the stage 1 score previously calculated. This may result in an overall phrase score or phrase weight. Process 2004 may then end at 2210 and return to process 2000 at 2006.

FIG. 23 is a flowchart of process 2008 for reducing phrase redundancy. Reducing phrase redundancy may allow a summary to be shorter than the original document (ie a summary that is shorter than document 9 and/or SIF 9b) and/or remove or reduce repetition, while only removing less important phrases or information. Many approaches to reducing redundancy can be taken including commonality of terms between phrases—which may indicate that similar phrases are unnecessary duplicates.

Process 2008 begins at 2302 where the section is obtained that may be reduced to remove redundancy. Process 2008 continues at 2304 where phrases in the section are sorted; optionally according to their stage 2 score as calculated in 2004. Process 2008 may then proceed to 2306 where a subset of the phrases that fall within an acceptable range of a base phrase score may be kept (and not, for example, immediately omitted as being redundant) from the original phrases. By way of example, a base phrase of a particular section (which may be the original phrase or sentence being compared to, may be the highest scoring sentence in a paragraph or section, and may be the phrase others are compared against to identify similarity and/or redundancy) may have a score of 0.4 and a range may be determined to be acceptable having a plus or minus of 0.2. Therefore, any phrase having a stage 2 score between 0.2 and 0.6, at 2306 would remain part of the subset of phrases for further consideration and processing.

At 2308, the next phrase in the list of phrases is compared to the base phrase in a word-wise manner and redundant phrases are discarded. Comparing in a word-wise manner may involve comparing words in each phrase to determine whether that word, or a synonym therefore, appears in the other phrase. Dictionaries or other aids may assist in doing this comparison. If the next phrase is substantially similar to the base phrase, as determined for example using word based comparisons, then the next phrase may be discarded as being redundant with respect to the base phrase.

At 2310, process 2008 queries whether there is another phrase in the section to compare to the base phrase and if so, process 2008 returns to 2308. If there is no further phrase then process 2008 proceeds to 2312 where a query is made whether all phrases in the section are exhausted. If not, then process 2008 continues at 2314 where a new base phrase is set and process 2008 then continues at 2306 to once again to form a subset of phrases within an acceptable range of the base phrase. It is to be understood that when a new base phrase is set at 2314 that the acceptable range may be the same as, or different from, the prior base phrases acceptable range. Process 2008 then continues through 2308, 2310, and 2312 for that new base phrase.

Returning to 2312 if all phrases in a section have been exhausted then process 2008 continues at 2316 to query whether all sections have been processed. If there remain sections to process, then process 2008 returns to 2304 to process that section. If there are no more sections to process then 2008 terminates at 2318 and processing returns to process 2000 at 2010.

Process 2000 may then proceed as described herein to complete the autosummary processing.

It is to be understood that autosummary component 107 may operate separately from cluster formation component 106b. Each of autosummary 107 and cluster formation component 106b may add information to SIFE 9b to contribute to FSIF 9c but it is to be understood that each of these components may add the required information to allow their functionality to later be accessed, such as by renderer component 35.

### Table of Configuration Settings—Autosummary

Configuration settings, for any software components as described herein, such as renderer component 35, autosummary component 107 and core cluster component 106b, may be used to alter or affect any of the functionality of such software components or system 20 in general. Although several configuration settings are shown in Tables 1,2 and 3, it is to be understood that many others are possible and are considered within the scope of the present invention. Further, it is to be understood that such configuration settings may be implemented in many ways, as would be known to someone of ordinary skill in the art. Such implementation methods may include, for example, the use of global variables, a configuration file, or other ways for implementing such in computer software or hardware.

Table 2 below provides a summary of some of the possible configuration settings relating to autosummary component 107. The table provides a description of the configuration setting, and a selected value in one embodiment. It is to be understood that there are many different descriptions and selected values that are considered within the scope of the present invention.

Such configuration settings may relate to, for example:
Phrase weight calculation: specifying multipliers for phrase positioning, length, cue sub-phrases, stage 1 score and stage 2 score.
Reducing phrase redundancy: phrase-to-phrase comparison acceptable range of weightings, word-to-word comparison acceptable range of weightings and a threshold for stage 1, stage 2 or combined phrase score.

TABLE 2
Configuration Settings - Autosummary

Configuration A value

Phrase Weight Calculation

| | |
|---|---|
| Stage 1: Phrase Position, Length and the | |
| Inclusion of Cue Sub-Phrases | |
| Phrase Position multiplicative factor, k1 | 1 |
| Phrase Length multiplicative factor, k2 | 1 |
| Cue Sub-Phrases multiplicative factor, k3 | 1 |
| Stage 1 score multiplicative factor, m1 | 1 |
| Stage 2: Term Frequency | |
| Stage 2 score multiplicative factor, m2 | 1 |

Reducing Phrase Redundancy

| | |
|---|---|
| Phrase-to-phrase comparison acceptable range | +/−0.2 |
| Word-to-word comparison acceptable range | +/−0.002 |
| Threshold | 0.7(stage 2 score) |

### Parsing Component

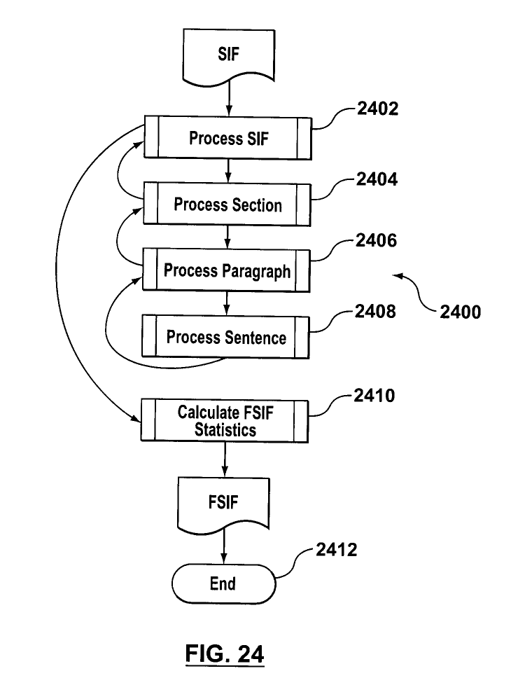

FIGS. 24-35 are flowcharts of process 2400 and other processes for forming clusters from a document or portion of text and may be a preferred embodiment therefor. When a modified document or a portion of text, such as SIFE 9b from system 20 in FIG. 19, is provided as an input to process 2400, process 2400 beings at 2402 to process SIFE 9b.

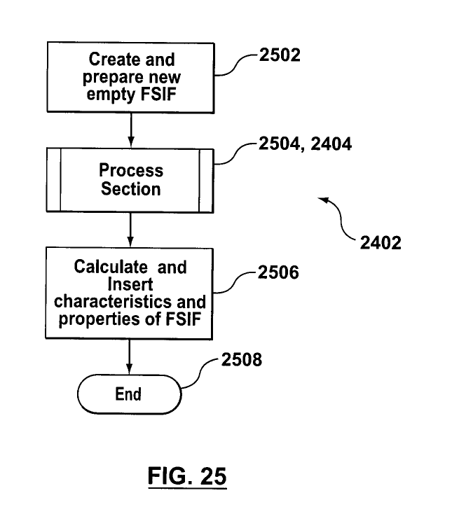

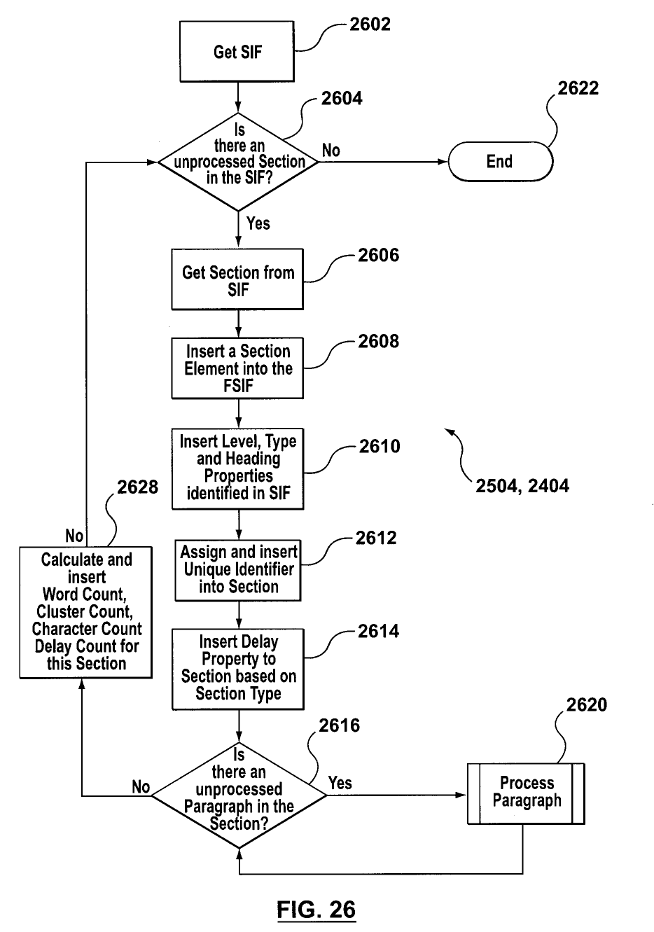

Processing SIFE at 2402 may be further described herein, for example, at process 2402 in FIG. 25 and may begin with creating a new FSIF, such as FSIF 9c, to populate with data. Processing at 2402 may further involve continuing to process each section in SIFE, using process 2504, 2404 in FIG. 26 as described herein.

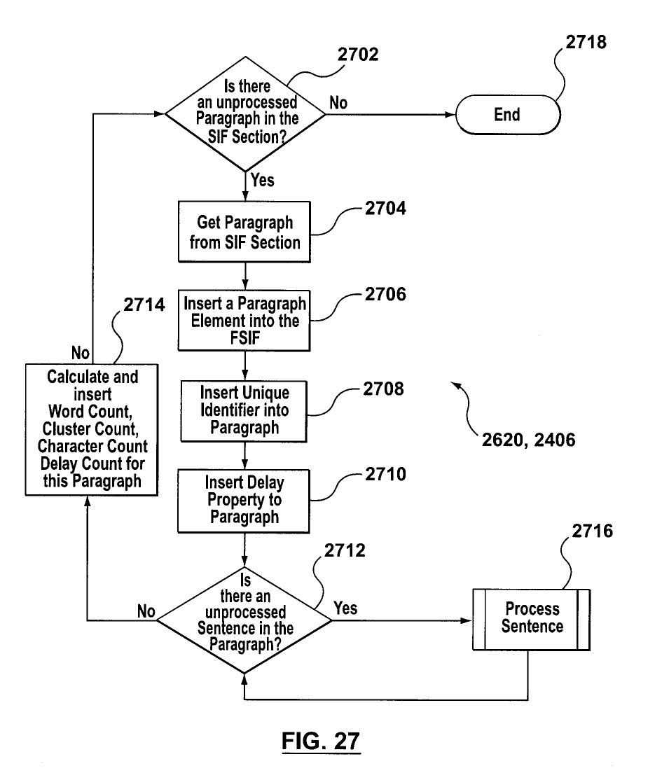

Processing a section at 2404 may be further described herein, for example, at process 2504 in FIG. 26 and may involve modifying and inserting properties relating to a section. Processing a section at 2404 may further involve processing each paragraph in the section, using process 2620, 2406 in FIG. 27, as described in.

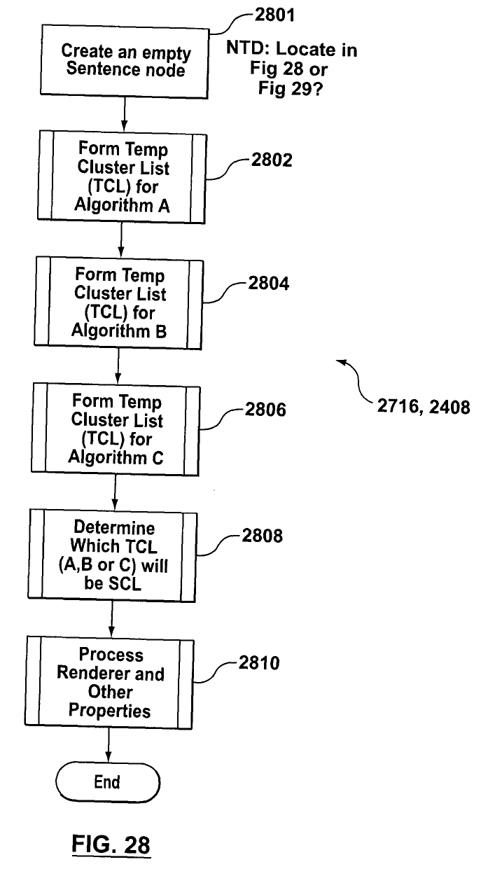

Processing a paragraph at 2406 may be further described herein, for example, at process 2620, 2406 in FIG. 26 and may involve modifying and inserting properties relating to the paragraph. Processing a paragraph at 2406 may further involve processing each sentence in the paragraph, using process 2716, 2408 in FIG. 28 as described herein.

Processing a sentence at 2408 may be further described herein, for example, at process 2716, 2408 in FIG. 28 and may involve parsing a sentence into one or more clusters.

Once each sentence is processed at 2716, 2408 then process 2400 returns to 2406 where calculations and various properties may be inserted with respect to the paragraph being processed. Once all paragraphs have been processed in such fashion (by inserting calculations and characteristics into header information relating to paragraph) then 2406 returns to process 2404 where each paragraph may be processed. Once each paragraph is processed, for example by calculating and inserting accounts and other properties with respect to the paragraph then 24 then at 2404 process 2400 may return to 2402.

It is to be understood, as shown by process 2400 in FIG. 24, that 2402 may not be fully completed until 2404 is completed, and 2404 may not be fully completed until 2406 is fully completed, and 2406 may not be fully completed until 2408 is fully completed. As such, when 2408 is completed this allows process 2400 to return to 2406. When 2406 is completed, this allows process 2400 to return to 2404. And likewise, when 2404 is completed, this allows process 2400 to return to 2402.

Process 2400 having continued from 2402 to 2408 and back up to 2402 via 2406 and 2404 process 2400 may continue to 2410 where various calculations, accounts and properties of this stream are added to the file. Process 2400 then creates the output file, the FSIF such as FSIF 9c, and terminates at 2412.

FIG. 25 is a flowchart of process 2402 for processing an FIS. Process 2402 begins at 2502 where a new SFIS object is created and prepared. Such creation and preparation may include creating a new and empty object, creating a new and empty section within the object that may, for example, have a level of 0, creating a heading property such as a name, and assigning a unique identifier to the new stream. At 2502 a SIF file may also be loaded into memory, such as RAM, to allowing accessing and manipulating its contents.

Process 2402 may then continue at 2504, 2404 to process a section. Such processing may be substantially as described herein and in particular with respect to process 2504, 2404 in FIG. 26. Once the processing of the section has completed, process 2402 continues at 2506 where calculations are made and information is inserted into the newly created object relating to the FSIF's properties. The calculations and insertions at 2506 may include word counts, cluster accounts, character counts, average words per cluster, standard deviation of the words per cluster, average characters per cluster and standard deviation of the characters per cluster. Other insertions may include information about a document, such as ISBN, publisher, published date, author, location of publication and title. Such calculations and insertions may further include calculating and inserting number A, B, and C algorithm choices. Further, at 2506, process 2402 may record the number of times that each of algorithm A, B and C are chosen as the best algorithm. This may be used to add further intelligence to process 2402 (such as learning which algorithm is optimal for, for example, a particular author, type of document, length of document, user or other feature of the use of process 2402) or for making changes to any of algorithms A, B and C to make them more effective.

After making such calculations in inserting such information at 2506, process 2402 terminates at 2508 and returns to process 2400 at 2410 as described herein with respect to process 2400.

It is to be understood with respect to process 2400 and all related processes that the calculations, information and data that is inserted, at any portion of any such processes, may relate to the new object or file, a section, a paragraph, a sentence, or an element in a sentence.

FIG. 26 is a flowchart of process 2504, 2404 for processing a section of a SIF. Process 2504 begins at 2602 where the SIF, such as SIF 9b, may be obtained. It is worth noting that at 2602 the SIF may already have been obtained, such as at 2402 of process 2400 where the document may have been provided as an input at 2402.

Process 2504 continues at 2604 and queries whether there is an unprocessed section in the file. If there is such a section then process 2504 continues at 2606 where that section is obtained from the SIF. This may involve reading a portion of the section and, for example, storing it in local memory.

Continuing with process 2504, at 2608, 2610, 2612, and 2614 various properties and information may be inserted into the newly created FSIF. Such information may include, for example, a section element, a level type and heading properties relating to the section, a section identifier, and a delay property for that section.

Process 2504 then continues at 2616 to query whether there is an unprocessed paragraph in the section that is currently being processed. If there is such an unprocessed paragraph, then process 2504 continues at 2620 to process that paragraph. Processing at 2620 is more fully described herein, for example, at 2620, 2406 in FIG. 27. Returning to 2616, if there are no further paragraphs to process then process 2504 continues at 2618 where calculations and insertion of information and data may be made. Such calculations and insertion of data may relate, for example, to the section that is being processed.

Process 2504 then returns to 2604 and queries whether there are unprocessed sections in the file. If there is at least one such section then process 2504 continues as described above to 2606 and on through 2608, 2610, etc. If however, at 2604, there is no further unprocessed section, then process 2504 continues to 2622 and terminates. This results in returning to process 2402 at 2506 as described herein.

FIG. 27 is a flowchart of process 2620, 2406 for processing a paragraph of a SIF. Process 2504 begins at 2702 and queries whether there is an unprocessed paragraph in the file. If there is such a paragraph then process 2620, 2406 continues at 2704 where that paragraph is obtained from the SIF. This may involve reading a portion of the paragraph and, for example, storing it in local memory.

Continuing with process 2620, 2406, at 2704, 2706, 2708 and 2710 various properties and information may be inserted into the newly created FSIF. Such information may include, for example, a paragraph element, a level type and heading properties relating to the paragraph, a paragraph identifier, and a delay property for that paragraph.

Process 2620, 2406 then continues at 2712 to query whether there is an unprocessed sentence in the paragraph that is currently being processed. If there is such an unprocessed sentence, then process 2620, 2406 continues at 2716 to process that paragraph. Processing at 2716 is more fully described herein, for example, at 2716, 2408 in FIG. 28. Returning to 2712, if there are no further sentences to process then process 2620, 2406 continues at 2714 where calculations and insertion of information and data may be made. Such calculations and insertion of data may relate, for example, to the paragraph that is being processed. Process 2620, 2406 then returns to 2702 and queries whether there are unprocessed paragraphs in the SIF. If there is at least one such paragraph then process 2620, 2406 continues as described above to 2704 and on through 2706, 2708, etc. If however, at 2702, there is no further unprocessed paragraph, then process 2620, 2406 continues to 2716 and terminates. This results in returning to process 2504 at 2616 as described herein.

FIG. 28 is a flow chart for process 2716, 2408 for processing a sentence. Process 2716, 2408 may process the sentences in the paragraphs and sections that are processed according to process 2400.

Processing a sentence may separate the sentence into appropriate clusters for later presentation such as via renderer component 35 on computing device 26. Processing may further calculate and/or add properties about the sentence to the eventual location of storage of the sentence, such as SIF 9b or FSIF 9c.

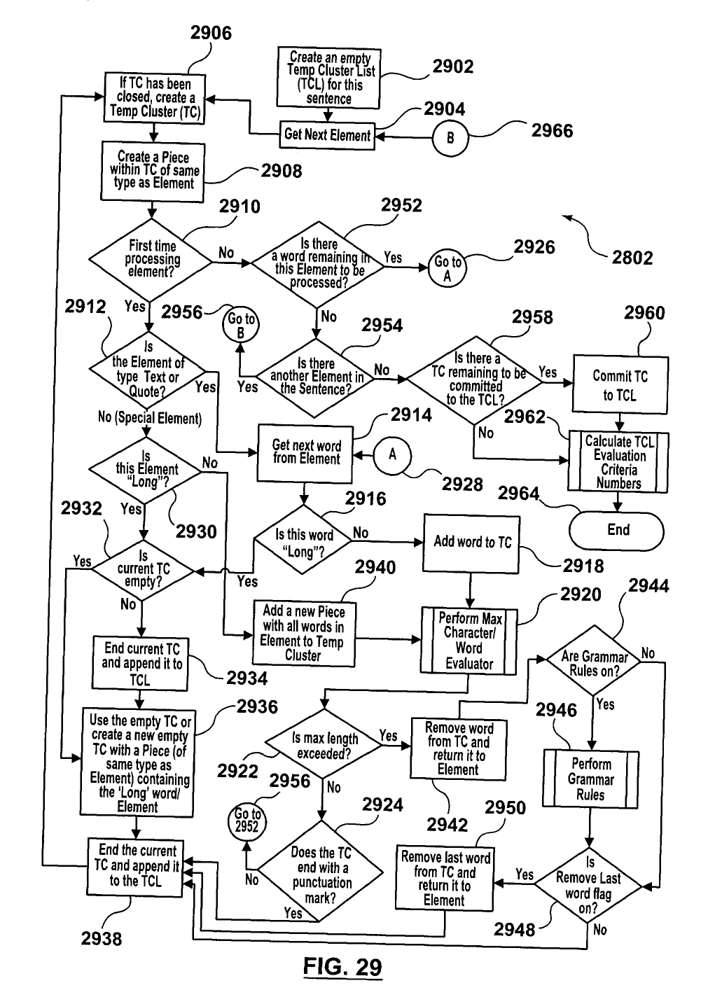

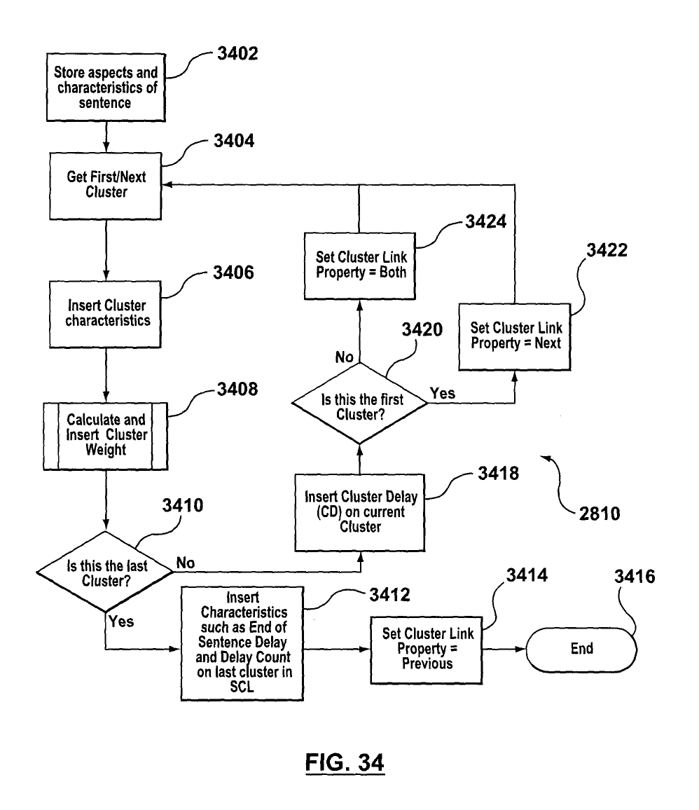

Process 2716, 2408 begins at 2801 where an empty sentence node may be created. This may allow a sentence to be read from the text to be processed, which may be, for example, SIF 9b. Process 2716, 2408 then continues at 2802, 2804 and 2806 to form a temporary cluster list using algorithms A, B, and C respectively. Forming temporary cluster lists may be further described herein and in particular with respect to process 2802 in FIG. 29. After process 2716, 2408 executes process 2802 for steps 2802, 2804, and 2806, it may continue at 2810 to process renderer and other properties. Processing renderer and other properties may be further described herein and in particular with respect to process 2810 in FIG. 34. When such processing is complete, process 2716, 2408 may terminate and return to process 2400 to continue at 2406 to allow processing of the paragraphs to finish, as described herein.

FIG. 29 is a flow chart of process 2802 for forming clusters from a SIF such as SIF 9b. Process 2802 may be implemented, for example, in software such as, for example, in parsing component 106 which may further include pre-parser component 106A and [quote] or cluster component 106B. It is to be understood that the exact ordering of process 2802 and its related processes may be varied and remain within the scope of the present invention. Further it is to be understood that one or more aspects of process 2802 and/or other related processes may be performed by different software components and/or hardware components.

Process 2802 begins at 2902 where an empty temporary cluster list (TCL) is created for the current sentence. At 2904 the next element is obtained from an element storage (where an element may be a node belonging to a SIF). At 2906 a temporary cluster is created. Then at 2908 a piece is created within the temporary cluster which is of the same type as the element that was received at 2904. Such piece may be used to hold the next element that is obtained; each cluster may therefore comprise one or more pieces.

At 2910, process 2802 queries whether this is the first time the element is to be processed and, if so, proceeds to 2912 to determine whether the element is of type ‘text’ or ‘quote’. If it is then at 2914 the next word is obtained from the element. At 2916, process 2802 queries whether the word that was obtained at 2914 is a long word. Such query may involve determining whether the word or element is longer than a set value for the maximum number of characters. If the word is not long then at 2918 the word is added to the temporary cluster and process 2802 continues to 2920.

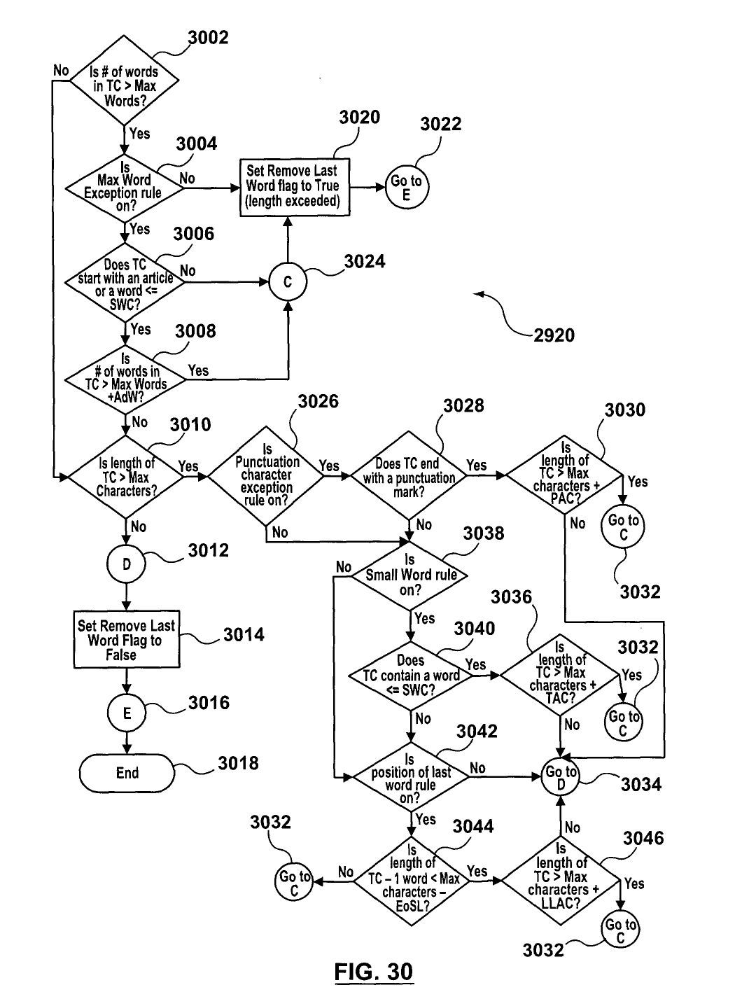

At 2920, a max character or a word length evaluation is performed. This process may be more fully described herein and in particular with respect to FIG. 30 and process 2920. Process 2920 may allow process 2802, at 2922, to determine whether the maximum length of the element has been exceeded and if so then at 2942 the word is removed from the temporary cluster and returned to element—to be added to a later cluster.

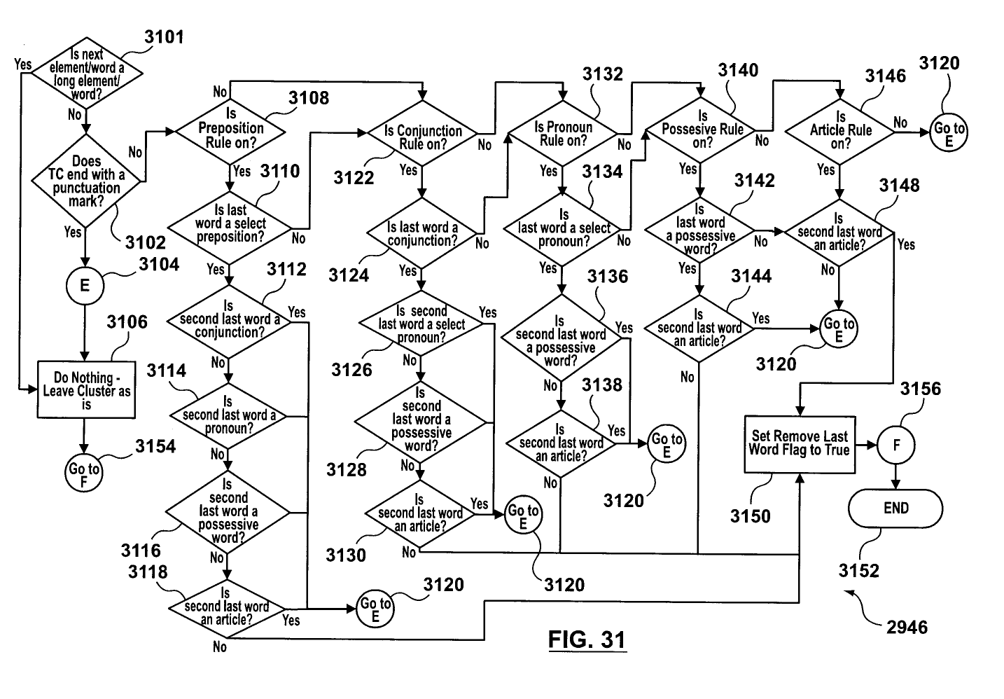

At 2944, the query is made whether grammar rules are enabled and if so then process 2802 proceeds to 2946 to perform the grammar rules. Such grammar rules may be more fully described herein and in particular with respect to FIG. 31 and process 2946. In general, at 2946, grammar rules are considered to determine whether the last word in the element is satisfactory. Depending on, for example what the last word is or would be, and what the second last word is or would be, grammar rules may require removal or addition of a word.

At 2948, a query is made whether the ‘remove last word’ flag has been turned on, and if so, then at 2950 the last word in the temporary cluster is removed and returned to the element. Process 2802 continues to 2938 and the current temporary cluster is ended and appended to the temporary cluster list. Process 2802 then returns to 2904 to begin a new temporary cluster for addition to the temporary cluster list. Returning to 2948, if the remove last word flag has not been turned on then process 2802 continues directly to 2938 as described herein.

Returning to 2922 if the max length is not exceeded, then process 2802 continues at 2924 to query whether the temporary cluster list ends with a punctuation mark, and, if so, process 2802 continues to 2938 as described herein. If not ending in a punctuation mark, process 2802 returns to 2952 as described herein.

Returning now to 2916, if the word is long then at 2932 the query is made whether the current temporary cluster is empty, and if not, then the current temporary cluster is ended and appended to the temporary cluster list at 2934, a new temporary cluster for the long word or element is created (if the current cluster is not empty) and the long word or element is added to that temporary cluster at 2936. Then at 2938 the newly-formed temporary cluster, with the long word or element is appended to the temporary cluster list and process 2802 returns to 2904 as described herein.

If the current temporary cluster is empty at 2932 then at 2936 the new temporary cluster is created and the long word or element is inserted. Process 2802 then continues at 2938 as described herein.

Returning to 2912, if the element is not of type ‘text’ or ‘quote’ then at 2930 a determination is made whether the element is long. If it is, then process 2802 proceeds to 2932 as described herein. If not, then at 2940 a new piece with all the words in the element is added to the temporary cluster and process 2802 proceeds to 2920 as described herein.

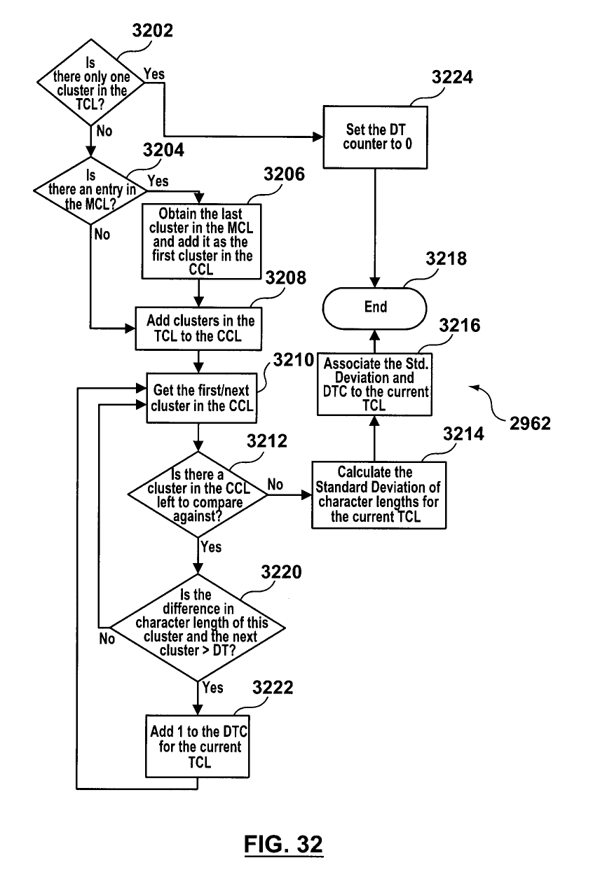

Returning to 2910, if the element is not the first one to be processed, then at 2952, a query is made whether there is a word remaining in the element that requires processing. If there is, then process 2802 continues to 2926, and on to 2928 which then proceeds to 2914 to get the next word from the element. Process 2802 then proceeds substantially as described herein from 2914. Returning to 2952 if there are no words remaining in the element then at 2954, a query is made whether there is another element in the sentence and if so process 2802 proceeds to 2956 and on to 2966 where the next element is obtained and process 2802 proceeds as described herein. If at 2954 there is no further element in the sentence then at 2958 if there is a temporary cluster remaining to be committed to the temporary cluster list then at 2960 such occurs. Continuing at 2962 calculations are made regarding temporary cluster list characteristics, such as evaluation criteria numbers, prior to process 2802 terminating at 2964. The process undertaken at 2962 may be more fully described herein and in particular with respect to FIG. 32. If at 2958 there is not a temporary cluster to be committed to the temporary cluster list, then process 2802 continues at 2962 as further described herein.

FIG. 30 is a flow chart of process 2920 for performing maximum character and maximum word evaluation. As with process 2802, the order of process 2920 may vary while remaining within the scope of the present invention. Further, process 2920 may be implemented using one or more software components that may be located on one or more hardware components such as are part of system 20.

Process 2920 begins at 3002 to query whether the number of words in the temporary cluster is bigger than the maximum number of allowable words in a cluster. The maximum number of allowable words may be a pre-determined number, and may be configurable, such as by user 5 or by an administrator or some other person responsible for implementation of process 2920 and/or system 20.

If the temporary cluster has more words than the maximum number, then at 3004, a query is made whether the max or exception rule is on, and if so, at 3006 the query is made whether a temporary cluster starts with an article or a word having a number of characters less than or equal to the threshold for a small word (SWC, which may further be specified or defined, for example in variables accessible by process 30, or by user 5 or an administrator). If so, then at 3008, a query is made whether the number of words in the temporary cluster is larger than the max number of words (which may be any defined number) plus a number of additional words allowed (AdW, which may further be specified or defined, for example in variables accessible by process 30, or by user 5 or an administrator). If it is not, then at 3010, a query is made whether the length of the temporary cluster is bigger than the max number of characters and if not, process 2920 continues at 3012 and on to 3014 to set the remove last word flag to false and then proceed to 3016 and to terminate at 3018. It is to be understood that setting the remove last word flag to false may be one way to ensure that the last word is not removed from the cluster. Other ways to do so are considered within the scope of the present invention.

Returning to 3010, if the length of the temporary cluster is larger than the max number of characters then at 3026 a query is made whether the punctuation character exception rule is on. If it is on, then at 3028, a query is made whether the temporary cluster ends with a punctuation mark. If so, then at 3030, a query is made whether the length of the temporary cluster is larger than the max characters plus an additional number of characters that may be allowed for the punctuation rule (PAC, which may further be specified or defined, for example in variables accessible by process 30, or by user 5 or an administrator). If so, then at 3032, process 2920 returns to 3024 which will be more fully described herein. Returning to 3030, if the length of the temporary cluster is not larger than max characters plus a number of additional characters with the punctuation rules, then process 2920 continues to 3034, as described herein.

Returning to 3026 and 3028, if the queries result in a negative response then process 2920 continues at 3038 to determine whether the small word rule is on. If it is, then at 3040, the query is made whether the temporary cluster contains a word that is smaller than the number of characters that defines the small word (SWC, which may further be specified or defined, for example in variables accessible by process 30, or by user 5 or an administrator). If so, then process 2920 continues at 3036 to query whether the length of the temporary cluster is larger than the max number of characters plus a number of additional characters for the small word rule (TAC, which may further be specified or defined, for example in variables accessible by process 30, or by user 5 or an administrator). If it is, then at 3032, process 2920 returns to 3024 as it will be more fully described herein. If not, then process 2920 continues to 3034, as described herein.

If at 3038, 3040 or 3036 the response is negative, then a query is made whether a position of last word rule is on. If it is, then at 3044, the query is made whether the length of the temporary cluster minus one word is less than the sum of the maximum number of characters minus the number of characters from the end of the second last word to max number of characters (EoSL). If not, then at 3032, process 2920 returns to 3024. A positive indication at 3044 causes a further query to be made at 3046 whether the length of the temporary cluster is bigger than the sum of the maximum number of characters and the number of additional characters for the long last word rule (LLAC). If so, then process 2920 proceeds to 3032 and then to 3024.

Returning to 3042 and 3046 if a negative response is received then process 2920 continues to 3034 and on to 3012 as described herein.

Returning to 3008, if a positive indication is received then process 2920 proceeds to 3024. From 3024 or if receiving a negative response at 3004, process 2920 continues at 3020 where the remove last word flag is set to true and process 2920 continues at 3022 and on to 3016 to terminate at 3018. It is to be understood that setting the remove last word flag to true may be one way to ensure that the last word is removed from the cluster. Other ways to do so are considered within the scope of the present invention, such as using a function call that returns a boolean indicator that may be set to true.

FIG. 31 is a flow chart of process 2946 to perform grammar rules on the text or file. Process 2946 may be implemented, for example, in software such as, for example, in parsing component 106 which may further include pre-parser component 106A and/or cluster component 106B. It is to be understood that the exact ordering of process 2946 and its related processes may be varied and remain within the scope of the present invention. Further it is to be understood that one or more aspects of process 2946 and/or other related processes may be performed by different software components and/or hardware components.

Process 2946 begins at 3101 to query whether the next element or word is a long element or word. If it is, then process 2946 continues at 3106, as described herein. If it is not, then process 2946 continues at 3102 to query whether the temporary cluster ends with a punctuation mark, such as an exclamation mark or question mark. If it does then process 2946 continues at 3104 and on to 3106 to do nothing and leave the cluster as it is. This may indicate, for example, that such an ending for a cluster is appropriate. Process 2946 may then proceed to 3154 and terminate, via 3156, at 3152. Returning to 3102 if the temporary cluster does not end with a punctuation mark then at 3108 process 2946 queries whether the preposition rule is on. If it is then process 2946 continues at 3110 to query whether the last word is a ‘select’ preposition. Determining whether a preposition is a ‘select’ preposition may be accomplished, for example, by referring to a list of selected prepositions.

If the last word is a select preposition then at 3112 a query is made whether the second last word is a conjunction. If it is not then at 3114 a query is made whether the second last word is a pronoun. If not then at 3116 a query is made whether the second last word is a possessive word. If not then at 3118 a query is made whether the second last word is an article. If not then process 2946 continues at 3150 where you remove last word flag is set to true and process 2946 terminates at 3152.

If a positive response is received at any of 3112, 3114, 3116 and 3118 then process 2946 continues to 3120 and on to 3104 and 3106, as described herein.

Returning to 3110 and 3108 if a negative response is received then process 2946 continues at 3122 with a query whether the conjunction rule is on. If so then a query is made whether the last word is a conjunction at 3124 and if so then process 2946 continues at 3126, 3128 and 3130 to determine whether the second last word is a select pronoun, a progressive possessive word, or an article, respectively. If any of the responses to these queries is affirmative then process 2946 continues to 3120 and on to 3104 and 3106 as described herein. However if all of these queries receive negative responses then process 2946 continues at 3150 as described herein.

Returning to 3122 and 3124 if a negative response is received to either of these queries then process 2946 continues at 3132 to query whether the pronoun rule is on. If it is then a query is made at 3134 whether the last word is a ‘select’ pronoun. Determination of ‘select’ pronouns may be substantially similar to determination of ‘select’ prepositions, for example. If, at 3134, the last word is a ‘select’ pronoun then at 3136 a query is made whether the second last word is a possessive word and if not then whether the second last word is an article at 3138. If the response to all of these queries is negative then process 2946 continues at 3150 as described herein. If however the response to any of these queries is affirmative then process 2946 continues at 3120 and on to 3104, as described herein.

Returning to 3132 and 3134, if a negative response is received to either query then at 3140 a query is made whether the possessive rule is on. If so then at 3142 a query is made whether the last word is a possessive word and if it is then the query is made at 3144 whether the second last word is an article. If it is not then process 2946 continues at 3150 as described herein. However if the response to 3144 is affirmative then process 2946 continues at 3120 as described herein.

Returning to 3140 if the possessive rule is not enabled then at 3146 a query is made whether the article rule is on. If it is not then process 2946 continues at 3120 as described herein. Returning to 3146 if a positive response is received, or a negative response is received from 3142, then at 3148 a query is made whether the last word is an article. If it is not then process 2946 continues to 3120 as described herein and if it is then process 2946 continues to 3150 as described herein.

It is to be understood that the grammar rules (preposition rule, conjunction rule, pronoun rule, possessive rule, article rule, and any others) may be used in any combination and in any order. In one embodiment, the article rule may be the most important to enable, and the preposition rule may be the least important to enable, to, for example, improve readability. The embodiment in FIG. 31 is only one variation—many others are considered within the scope of the present invention. Further, the combination of rules that may be enabled may be determined through software, such as by selecting options in software. This may be done, for example, by user 5, by an administrator, or may be an option that is specified in document 9 or by one or more software components, for example as they process SIF 9b or document 9.

FIG. 32 is a flow chart of process 2962 for a processing a sentence and calculating evaluation criteria values. Process 2962 may be implemented, for example, in software such as, for example, in parsing component 106 which may further include pre-parser component 106A and/or cluster component 1068. It is to be understood that the exact ordering of process 2962 and its related processes may be varied and remain within the scope of the present invention. Further it is to be understood that one or more aspects of process 2962 and/or other related processes may be performed by different software components and/or hardware components.

Process 2962 begins at 3202 with a query whether there is only one cluster in the temporary cluster list (TCL). If not, and there is more than one cluster in the TCL, then at 3204 a query is made whether there is an entry in the master cluster list (MCL). If there is such an entry then at 3206 the last cluster in the MCL is added as the first cluster in the compare cluster list (CCL) and process 2962 proceeds to 3208. If there is no entry in the master cluster list at 3204 then process 2962 proceeds directly to 3208.

At 3208 clusters are added from the TCL to the CCL. Process 2962 then continues at 3210 where the first or next cluster in the CCL is obtained and proceeding to 3212 a query is made whether there is still a cluster in the CCL to compare against. If there is such a cluster to compare against then at 3220 a query is made whether the difference in character length of the present cluster and the next cluster is less than the difference threshold (DT). If so then the difference threshold counter (DTC) is augmented by one for the current temporary cluster list and process 2962 returns to 3210. Process 2962 simply returns to 3210 to get the next cluster if at 3220 the difference is not greater than the difference threshold.

Returning to 3212 if there is not a cluster in the CCL to compare against then at 3214 the standard deviation of character lengths is calculated for the current temporary cluster list, and at 3216 the standard deviation and difference threshold counter are associated to the current temporary cluster list. Process 2962 then terminates at 3218, to return to process 2802 at 2948.

Returning to 3202 if there is only one cluster in a temporary cluster list then at 3224 the difference threshold counter is set to zero and process 2962 terminates similarly at 3218.

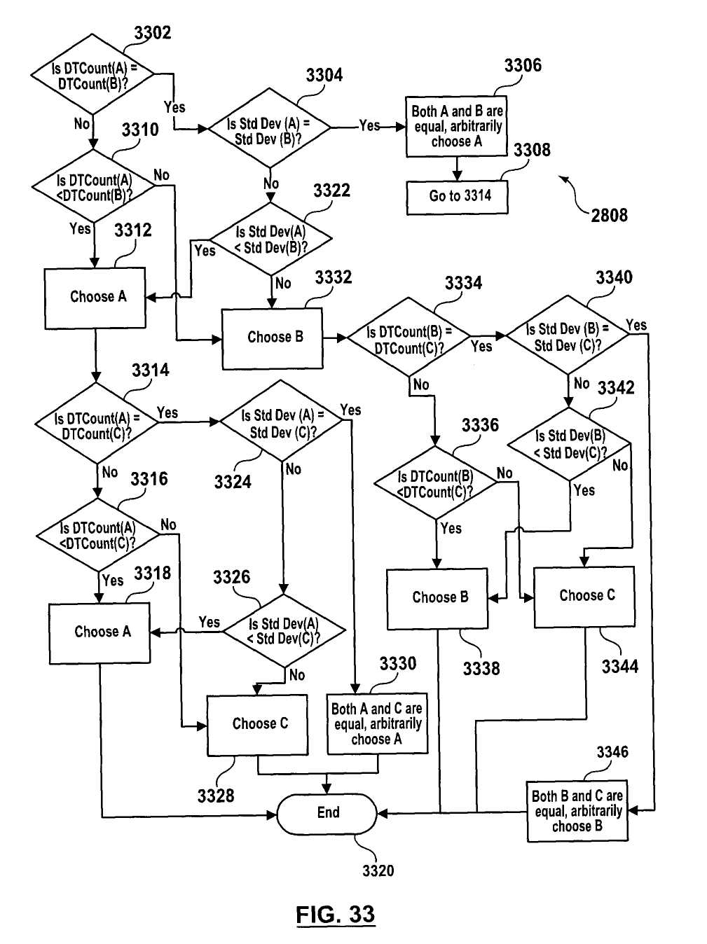

FIG. 33 is a flow chart of process 2808, 3300 for determining which temporary cluster will be the sentence cluster list. This may involve determining which cluster, of the clusters produced between algorithms A, B and C is most desirable to keep. Such may involve determining which algorithm has produced the most readable and understandable clusters; readability and ease of understanding may be two factors that change as a result of the algorithms using different configurations and/or configuration settings, as described herein and with respect to Tables 1-3.

Process 3300 begins at 3302 with a query whether the difference threshold counter (DTCount) for A (DTCount(A)) is equal to DTCount(B). If it is then at 3304 a further query is made whether the standard deviation of A (the standard deviation of the clusters produced by algorithm A) is equal to the standard deviation of B and if so then at 3306 both A and B are determined to be equal and A is arbitrarily chosen over B. Now A and C are to be compared against each other as process 3306 continues at 3314.

Returning to 3302 if the difference thresholds are not equal then at 3310 a query is made whether the DTCount of A is less than that of B and if so then A is chosen at 3312 and process 3300 continues to compare A to C. Returning to 3310 if the response is negative then B is chosen at 3332 and process 3300 continues to compare B to C.

Returning to 3304 if the standard deviations are not equal then process 3300 continues at 3322 to query whether the standard deviation of A is less than the standard deviation of B. If it is then A is chosen and process 3300 continues to 3314 to compare A and C. If the standard deviation of A is not less than the standard deviation of B at 3322 then B is chosen and process 3300 continues at 3334 to compare B and C.

Arriving at either 3334 (beginning of comparison of B and C) or 3314 (beginning of comparison of A and C) process 3300 compares these pairs in substantially the same manner as the comparison was made between A and B beginning at 3302.

It is to be understood that 3302, 3304, 3306, 3310, 3322, 3312 and 3332 may substantially correspond to 3314, 3324, 3330, 3316, 3326, 3318, and 3328 for comparing A and C, and 3334, 3340, 3346, 3336, 3342, 3338 and 3344 for comparing B and C.

FIG. 34 is a flow chart of process 3400 for inserting sentence attributes. Such insertion may be into, for example, SIF 9b to create FSIF. It is to be understood that many sentence, paragraph, section or other attributes may be inserted. Any of such attributes may be used to facilitate processing FSIF to achieve the various functionality of system 20 and the various components therein.

Process 3400 begins at 3402 where aspects and characteristics of a sentence are stored. Such may include the difference count in the sentence, which may be the number of times the character difference threshold was met as in process 2962. Aspects and characteristics that are stored may further include a standard deviation for the sentence, the chosen algorithm identifier, (which may be for example between A, B and C) and other aspects and characteristics that may be associated with the sentence. Such storage may be in storage 58 or, for example, in variables in one or more software modules implementing process 3400 or 2716, 2408, or 2400.

Process 3400 continues at 3404 where the first or next cluster is obtained. Cluster characteristics are then inserted for that cluster at 3406. Cluster characteristics that are inserted into the cluster may include a word count, a character count, a unique identifier and a piece count (which may be the number of pieces in a cluster). Inserting cluster characteristics may be accomplished by embedding information or data in SIF 9b that is located near the cluster or otherwise affiliated with the cluster.

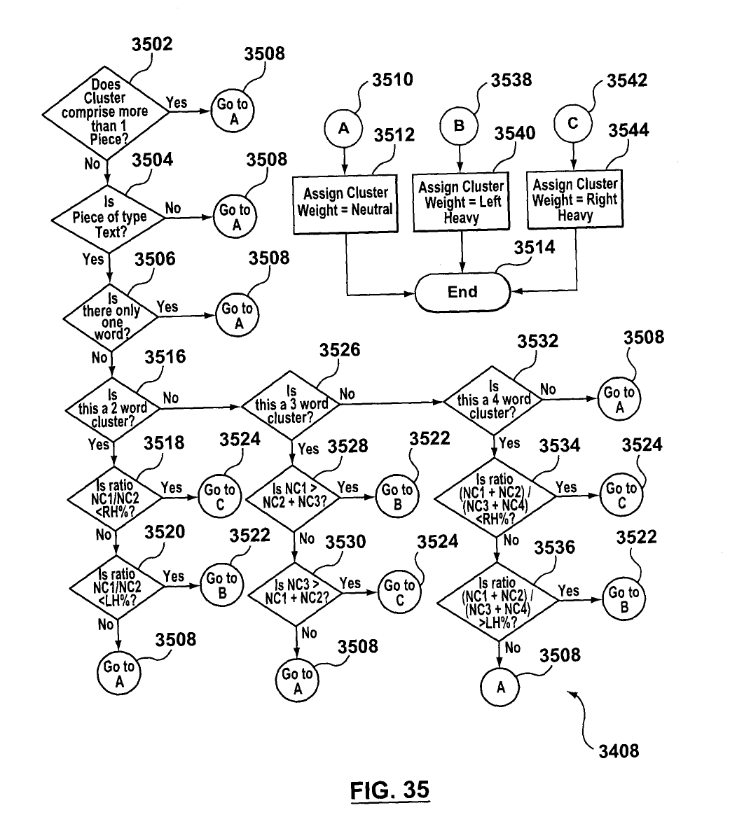

At 3408 cluster weights are calculated and inserted as more fully described herein and with respect to process 3408 in FIG. 35. Briefly, at 3408 a weighting of neutral, left heavy, or right heavy may be applied to a cluster depending on whether there are long words near the right or left of the cluster. Process 3400 then continues at 3410 to query whether this is the last cluster and if it is then process 3400 proceeds at 3412 to insert end of sentence delay on the last cluster in the sentence cluster list. Process 3400 then proceeds to 3414 where the cluster link property is set to previous and the process terminates at 3416.

Returning to 3410 if this is not the last cluster then at 3418 the cluster delay is inserted for the current cluster, and at 3420 a query is made whether this is the first cluster. If it is the first cluster then at 3422 the cluster link property is set to next and process 3400 re-commences at 3404. If this is not the first cluster at 3420 then process 3400 continues at 3424 and the cluster link property is set to ‘both’, and process 3400 proceeds from 3404.

FIG. 35 is a flow chart of process 3408 for inserting cluster rates or cluster shifting. Process 3408 may be used to determine whether a cluster is left heavy, in that there are longer words near the left side of the cluster, right heavy, in that there are longer words near the right side of the cluster, or neutral, in that there is no particular weighting between right and left sides. Process 3408 may be used, for example, to determine whether a cluster should be shifted left or right when it is displayed to a user. For example, if a cluster is left heavy then the cluster may be shifted to the right to ease a user's reading of the cluster.

Process 3408 begins at 3502 to determine whether the cluster is comprised of more than one piece. If it is then process 3408 proceeds to 3508 and 3510 and on to 3512 to assign a cluster weight of neutral and to terminate at 3514.

If the cluster is only one piece at 3502 then at 3504 a query is made whether the piece is of text type and if not then process 3408 proceeds to 3508 as described herein. If it is then at 3506 a query is made whether there is only one word and if so then process 3408 continues to 3508 as described herein.

If at 3506 there is more than one word then process 3408 proceeds to 3516. Beginning at 3516 process 3408 may compare ratios between the number of characters in each word on the left and right sides of a cluster to determine whether a weighting is desirable. At 3516 it is considered whether there are two words in a cluster, at 3526 three words at 3532 four words. From each of 3516, 3526, and 3532 process 3408 compares the number of characters in these words to determine whether the cluster is left heavy, right heavy or neutral.

If this is a two word cluster at 3516 then at 3518 a query is made whether the ratio of the number of characters in the first word divided by the number of characters in the second word is less than the right hand percentage, which may be specified to be any percentage. If the response is positive then process 3408 continues at 3524, to 3542 and at 3544 assigns the cluster rate or shifting to be right heavy and terminates at 3514. Returning to 3518 if the response is negative then process 3408 continues at 3520 to determine whether the ratio from 3518 is greater than the left heavy percentage. The left heavy percentage may be set as the right heavy percentages, and may be for example the inverse. If the response is positive then process 3408 continues at 3522, 3538 and at 3540 the cluster weight is assigned left heavy and process 3408 terminates at 3514. Returning to 3520 if the negative response is determined then process 3408 continues at 3508 as described herein.

If at 3516 the cluster is not two words then process 3408 continues at 3526 to query whether it is a three word cluster. If it is then at 3528 a query is made whether the number of characters in the first word is greater than the number of characters in the second and third words combined. If so then process 3408 continues at 3522 as described herein but if not process 3408 continues at 3530 to query whether the number of characters in the third word is greater than the number of characters in the first and second words. If so then process 3408 continues at 3524 as described herein and if not then continues at 3508 as described herein.

Returning to 3526 if it is not a three word cluster then at 3532 a query is made as whether it is a four word cluster. If it is not then process 3408 continues at 3508 as described herein. If it is a four word cluster then at 3534 the sum of the number of characters in words one and two is divided by the sum of the number of characters in words three and four. That value is compared to the right heavy percentage and if it is less than the right heavy percentage then process 3408 continues at 3524 as described herein. If it is not then the division of the sums in 3534 is compared to the left heavy percentage and if it is greater than the left heavy percentage then process 3408 continues at 3522 as described herein. If it is not greater than the left heavy percentage then process 3408 continues at 3508 as described herein.

Process 3408, in terminating at 3514, returns to process 2810 at 3408. As a result of process 3408, each cluster may have a neutral, left or right shift that may be associated with the cluster in SIF 9b or FSIF 9c.

### Table of Configuration Settings—Parsing a FSIF

Table 3 provides a summary of some of the possible configuration settings relating to parsing a document. Such configuration settings may be used by, for example, preparser component 106a and/or cluster formation component 106b. The table provides a description of the configuration setting, possible values, and a selected value in one embodiment. It is to be understood that there are many different descriptions, possible values, and selected values that are considered within the scope of the present invention.

Such configuration settings may relate to, for example:
Grammar related rules: whether various grammar rules are enabled.
Grammar related lists: providing a list of ‘selected’ prepositions or other parts of speech, or an indication of where to find such a list.
Length rules: indicating a maximum number of words or characters for a cluster, defining what constitutes a ‘long word’, ‘small word’, or ‘long last word’ (such as the number of characters), a number of additional words or characters over the maximum (AdW, PAC, TAC, LLAC), a difference between the end of the second last word's position and maximum characters (EsSL) and a character difference threshold which may be the length between 2 clusters that confuses the eye.

TABLE 3
Configuration Settings - Parsing

| | Exemplary | | | |
|---|---|---|---|---|
| Parameters | Possible Values | Algorithm A | Algorithm B | Algorithm C |
| Grammar Related Rules | | | | |
| All Grammar Rules | On/Off | On | On | On |
| Selected Preposition Rule | On/Off | On | On | On |
| Conjunction Rule | On/Off | On | On | On |
| Selected Pronoun Rule | On/Off | On | On | On |
| Possessive Word Rule | On/Off | On | On | On |
| Article Rule | On/Off | On | On | On |
| Grammar Related Lists | | | | |
| Qualifying Prepositions, | See List | | | |
| Pronouns, Conjunctions, | | | | |
| Possessive words, Punctuation | | | | |
| mark list | | | | |
| Length Rules | | | | |
| Maximum Number of Words | 2, 3, 4, 5, 6 | 4 | 3 | 4 |
| Maximum Number of | positive | 18 | 18 | 17 |
| Characters | integer | | | |
| Long Word Rule = same as | | | | |
| Maximum Number of | | | | |
| Characters Rule | | | | |
| Maximum Number of Words | On/Off | On | On | Off |
| Exception Rule | | | | |
| Number of Additional Words | 1, 2 | 1 | 1 | — |
| over Maximum (AdW) | | | | |
| Punctuation Character | On/Off | On | On | On |
| Exception Rule | | | | |
| Number of Additional | 1, 2 | 1 | 1 | 1 |
| Characters over Maximum for | | | | |
| Punctuation Rule (PAC) | | | | |
| Small Word Exception Rule | On/Off | On | On | Off |
| Number of Additional | 1, 2 | 1 | 2 | — |
| Characters over Maximum for | | | | |
| above Rule (TAC) | | | | |
| Maximum number of characters | 1, 2, 3 | 2 | 2 | 2 |
| that defines a “small word” | | | | |
| Long Last Word Exception Rule | On/Off | On | On | Off |
| Number of Additional | 1, 2 | 1 | 2 | Off |
| Characters over Maximum for | | | | |
| above rule (LLAC) | | | | |
| Difference between End of the | 4, 5, 6 | 4 | 5 | 6 |
| Second Last Word's position | | | | |
| and Max Characters (EoSL) | | | | |
| Charact Difference Threshold | positive | 5 | | |
| (CDT) length between 2 | integer | | | |
| clusters that confuses eye. Set | | | | |
| once and applied to all | | | | |
| Algorithms comparisons. | | | | |
| Cluster Shifting | | | | |
| Cluster Shifting | On/Off | | | |
| Neutral | no shift | | | |
| Left Heavy | Right 1 | | | |
| Right Heavy | Left 1 | | | |

### Parsing Sample

The following is an example of the parsing algorithm, showing the document and various stages along its processing towards becoming an FSIF such as FSIF 9c. An exemplary document 9 to be converted and parsed is shown in Table 4, below. As can be seen from Table 4, the source document comprises a single section, multiple paragraphs, and multiple sentences.

TABLE 3
Sample source document text
Introduction
This document is intended to outline the patent claims pertaining
to the Charting invention. This document, as a preliminary set of
claims, necessarily must be reviewed and undergo modifications
in order to refine the phrasing and scope of each claim and to
ensure that the invention is completely defined and protected by
those claims. An example of the Charting invention is shown here:

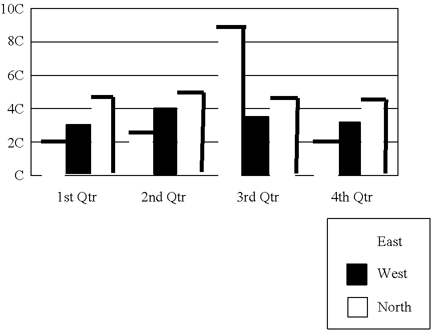

The invention was conceived in January, 2001 at a University of Toronto lab. It took three years of research and development to reach a breakthrough last summer.

Converter components 102 and preparser component 106a may produce SIF 9b from the input received from the native source document format's converter component 102. SIF 9b may be in Extensible Markup Language (XML) format and is shown below in Table 5 for the source document text illustrated in Table 4.

TABLE 5
SIF corresponding to Table 1 text (below)

<?xml version=“1.0” ?>

| | |
|---|---|
| <root | xmlns:xsi=“http://www.w3.org/2001/XMLSchemainstance” |

xmlns:xsd=“http://www.w3.org/2001/XMLSchema”>
<FSIF SIFID=“0” Heading=“Graph Preliminary Patent Claims v.1.0”>

<Section SIFID=“1” Type=“Basic” Heading=“Introduction” >

<Paragraph SIFID =“2”>

<Sentence SIFID =“3”>

<Element SIFID =“4”Type=“Text” FontFace=“Garamond” FontSize=“11”
FontStyle=“Plain” FontColour=“Black”> This document is intended to
outline the patent claims pertaining to the Charting invention.
</Element>

</Sentence>
<Sentence SIFID =“5”>

<Element SIFID =“6” Type=“Text” FontFace=“Garamond” FontSize=“11”
FontStyle=“Plain” FontColour=“Black”> This document, as a preliminary
set of claims, necessarily must be reviewed and undergo modifications
in order to refine the phrasing and scope of each claim and to ensure
that the invention is completely defined and protected by those
claims. </Element>

</Sentence>
<Sentence SIFID =“7”>

<Element SIFID =“8” Type=“Text” FontFace=“Garamond” FontSize=“11”
FontStyle=“Plain” FontColour=“Black”> An example of the Charting
invention is shown here:</Element>

</Sentence>
<Sentence SIFID =“9”>

<Element SIFID =“10” Type=“Special-Long-Figure” FontFace=“ ”
FontSize=“” FontStyle=“Plain” FontColour=“Black”>Chart.bmp</Element>

</Sentence>

</Paragraph>
<Paragraph SIFID =“11”>

<Sentence SIFID =“12”>

<Element SIFID =“13” Type=“Text” FontFace=“Garamond” FontSize=“11”
FontStyle=“Plain” FontColour=“Black”> The invention was conceived in
</Element>
<Element SIFID =“14” Type=“Text-Date” FontFace=“Garamond”
FontSize=“11” FontStyle=“Plain” FontColour=“Black”> January,
2001</Element>
<Element SIFID =“15” Type=“Text ” FontFace=“Garamond” FontSize=“11”
FontStyle=“Plain” FontColour=“Black”> at a</Element>
<Element SIFID =“16” Type=“Text-Place” FontFace=“Garamond”
FontSize=“11” FontStyle=“Plain” FontColour=“Black”> University of
Toronto</Element>
<Element SIFID =“17”Type=“Text ” FontFace=“Garamond” FontSize=“11”
FontStyle=“Plain” FontColour=“Black”> lab. </Element>

</Sentence>
<Sentence SIFID =“18”>

<Element SIFID =“19” Type=“Text” FontFace=“Garamond”
FontSize=“11” FontStyle=“Plain” FontColour=“Black”> It took three
years of research and development to reach a breakthrough last
summer. </Element>

</Sentence>
Process 2400 may produce FSIF 9c from SIF 9b. The following provides a example of process 2400 producing FSIF 9c from the SIF. The resulting FSIF can be described in XML format, as shown in Table 6.
Process 2400, at 2402-2412, is a high level description; more detail is provided in the ensuing processes and will be described herein to create an FSIF.
Starting at process 2402 in FIG. 25, the SIF is read at SIFID = “0”, and the following is created, at 2502:
< FSIF ID=“1” ClusterCount=“” WordCount=“” CharCount=“” DelayCount=“” Heading=“Chart Preliminary Patent Claims v.1.0 ” Publisher=“ ” PublishedYear=“” Location=“ ” ISBN=“” AvgWPC=“” AvgCPC=“” StdDevWPC=“” StdCPC=“” AlgACount=“ ” AlgBCount=“ ” AlgCCount =“” >

Since ‘heading’ is the only described attribute carried over from the SIF, the attributes such as ISBN, Publisher etc are left empty. At 2504, 2404 the example continues to process 2504, 2404 at FIG. 26.

At 2604, there is a check whether there is an unprocessed section in the SIF. Checking the SIF, SIFID=“1” is the only unprocessed section. At 2606, this Section (SIFID=‘1’) is retrieved. At 2608 and 2610, a section is added. At 2612, the ID is inserted. In this case, the next ID available is ID=“2”. At box 2614, the section is of type=“Basic”. Section delays, which may be from configuration settings, are set to 0. The resulting section looks like this:

< Section ID=“2” Type=“Basic” Heading=“Introduction”
ClusterCount=“” WordCount=“” CharCount=“” DelayCount=“”
Level=“1” Delay=“0” >

At 2616 there is an unprocessed Paragraph (SIFID=“2”) and carries on to process 2620 at FIG. 27.

At 2702 there is an unprocessed Paragraph (SIFID=“2”). At 2704, the paragraph is retrieved and a paragraph node is inserted into the FSIF at 2706. The delay property is added at 2710. The SIF is checked for sentences at 2712. Since one is found (SIFID=“3”), the process continues at process 2716, 2408 in FIG. 28. The resulting paragraph looks like this as processing continues at 2716, 2408:
<Paragraph ID=“3” ClusterCount=“ ” WordCount=“ ” CharCount=“ ” DelayCount=“ ” Delay=“0”>

An empty sentence may be created at 2802 (or at 2902). Process 2716 will attempt to process the sentence(s) using three different algorithm configurations (at 2802, 2804 and 2806) and the best algorithm will be chosen at 2808. In the present example, only Algorithm A will be described (at 2802). The result is:
<Sentence ID=“4” ClusterCount=“ ” WordCount=“ ” CharCount=“ ” DelayCount=“ ” Delay=“ ” DiffCount=“ ” AlgID=“ ”>

Processing then continues at process 2802 in FIG. 29.

Process 2802 in FIG. 29 is where the clusters are formed. At 2902, a Temporary Cluster List (TCL) is started. At 2904, the next Element SIFID=“4” is retrieved. At 2906, a new Temporary Cluster is formed (TC). At 2908, a Piece is created with the same type as the Element (SIFID=“4”). At 2910, it is determined that that this is the first time the Element has been processed and processing continues at 2912. The Element is of type Text and hence moves to 2914. The next word is taken (“This”) and a Long Word Check is performed at 2916, determining whether the word is long, as described herein.

As it was not a long word, the process proceeds from 2916 to 2918. The word this is added to the TC. At 2920, the process is passed to a Maximum Character and Word Evaluator in process 2920 in FIG. 30.

At 3002 the number of words in the TC (1 word) does not exceed the number of words permitted for Algorithm A of 4 words (as specified in configuration settings). The process then continues along the ‘No’ path to 3010. Here, the length in characters of the TC (4) is less than the maximum allowable number of characters for Algorithm A (18). The “Remove Last Word” flag is set to false at 3014. The process returns to process 2802 at 2922.

At 2922, since the maximum flag was set to false, the process continues at 2924. The TC does not currently end with a punctuation mark, and the process goes to 2952, where a check is made to see if there are more words in the Element. At 2952 an affirmative response is received and the next word retrieved is “document” found at 2914.

The process follows the path similar to the one described above. The next word “is” is added and the same procedure is followed along the same path. The process follows a different path when the word “intended” is added. The TC now has “This document is intended” and is checked following the same path. Once it reaches the Maximum Length Evaluator at 29020, it follows a different path.

At 3002, the maximum number of words is not extended, and the process continues to 3010 where the length of the TC is 25 characters and exceeds the 18 characters permitted. The process continues to 3026, the punctuation rule is ON for Algorithm A and proceeds to 3028. The temp cluster does not end in a punctuation mark, so the rule cannot be applied and the process moves to the next rule. At 3038, the Small Word rule is on, the process goes to 3040. The TC does contain a small word (“is”) that meets the criterion for a small word SWC<=2. Moving then to 3036, the length of the TC (25) is greater than Max Characters+TAC (18+1). Following the ‘Yes’ path, the process goes to 3020 where the remove last word flag is set to true.

The query at 2922 is affirmed as the maximum length is exceeded. The process continues to 2942, and the last word that was added to the temp cluster “intended” is now removed from the TC. The process moves on to 2944. The grammar rules are ‘On’ in the configuration of Algorithm A (as may be specified, for example, in configuration settings), and the process is now transferred to 2946 in FIG. 31.

Process 2946 starts at 3101, which determines whether the next word or element is a ‘long’ word. The next word is the word just removed—‘intended’—which is not a long word so process 2946 does not follow the ‘Yes’ path to termination but follows the ‘No’ path to 3102. Since the TC is now “This document is” and does not end in a punctuation mark 3102 follows the ‘No’ path to 3108. The preposition rule is on, 3108 flows to 3110. The last word “is” is not in the list of select prepositions (as determined with respect to configuration settings) and hence is not a select preposition. The process follows the No path to 3122. The conjunction rule is on and the word passes through to 3124. The word ‘is’ is not a conjunction, so the process follows the no path to 3132.

Similarly, the pronoun rule is on, so 3132 proceeds to 3134 where the word ‘is’ is not in the list of select pronouns. The process follows the no path and moves on 3140. The possessive rule is on, and the process moves to 3142. Since the word ‘is’ is not considered a possessive word according to the Possessive Word List in the configuration, the process moves to 3146. The article rule is on and the process moves to 3148. Since the word ‘is’ is not an article the process takes the no path to 3106 (do nothing). The process is returned to process 2802 at 2948.

Processing is returned to 2948 where the ‘remove last word’ flag not set. The process then follows to 2938 where the current TC is ended and it is appended to the TCL. Values such as Word Count, character count, Delay etc. are calculated and inserted.

<TCL>

<Cluster ID=“” PieceCount=“1” WordCount=“ 3” CharCount=“ 16”
Delay=“ 1” ClusterWeight=“ ” Link=“”>

<Piece ID=“ ” WordCount=“ 3” CharCount=“ 16” Type=“Text”
Region=“ ”> This document is
</Piece>

</Cluster >

</TCL>

The process continues at 2906 where a new Temp Cluster (TC) is started. At 2908, a Piece of the same type as the Element (SIFID=‘3’) is created. At 2910, it is determined that this SIF Element SIFID=‘3’ has been started previously, and the process continues to 2952. Since there are words remaining in this Element to be processed, the process moves to 2914. The next word (“intended”) is retrieved, and a long word check is performed. The process moves through, 2916, 2918, 2920, (max length not exceeded), 2922, 2924, 2952 and 2954. Where the next word “to” is added. The same procedure is applied and the word “outline” is added, although a different path is taken in process 2920.

The TC supplied to this routine is “intended to outline”. At 3002, the maximum number of words for Algorithm A (4) is not exceeded. The process moves to 3010 where the maximum number of characters rule is exceeded. The process follows 3026 and 3028 (does not end in a punctuation mark). At 3038, then 3040 a small word is discovered within the cluster. The process moves to determine if an exception to the maximum number of characters can be applied, at 3036. The length of the TC (19) is not greater than Max Characters (18)+TAC (number of additional characters for the small word rule). The process moves to accept the additional character and moves to 3026. The process returns to the calling process.

When the next word “the” is added to the TC, it fails the maximum length test and is subsequently removed. The TC is closed. The TCL now looks like this:

<TCL>

<Cluster ID=“” PieceCount=“1” WordCount=“ 3” CharCount=“ 16”
Delay=“ 1” ClusterWeight=“ ” Link=“”>

<Piece ID=“ ” WordCount=“ 3” CharCount=“ 16” Type=“Text”
Region=“ ”> This document is
</Piece>

</Cluster >
<Cluster ID=“” PieceCount=“1” WordCount=“3 ” CharCount=“20 ”
Delay=“ 1” ClusterWeight=“ ” Link=“ ”>

<Piece ID=“” WordCount=“ 3” CharCount=“20 ” Type=“Text”
Region=“Neutral”> intended to outline
</Piece>

</Cluster >

</TCL>

The algorithm continues on in the same manner. Only parts of the SIF that are processed differently from those above will be described in detail.

The words ‘the’, ‘patent’ and ‘claims’ are added individually, before the word ‘pertaining’ triggers the maximum number of characters rule.

<Cluster ID=“” PieceCount=“” WordCount=“ ” CharCount=“ ”
Delay=“ ” ClusterWeight=“ ” Link=“”>

<Piece ID=“ ” WordCount=“ ” CharCount=“ ” Type=“Text”
Region=“Neutral”> the patent claims
</Piece>

</Cluster >

The words ‘pertaining’, ‘to’, and ‘the’ are added to the next Cluster to be formed. The word “charting” is then retrieved at 2914. The long word check is passed (2916) and the word added to the TC (5122). The max length evaluator fails (at 2920, 2922) and the word is removed at 2942. The grammar rules are then checked for the TC that is “pertaining to the” (at 2944 and 2946). The process is passed on to process 2946 at 3101.

The temp cluster follows the path, 3101, 3102, 3108, 3110, 3122, 3124, 3132, 3134, 3140 and 3142. At 3146 and 3148, the last word is checked whether it is an article. Since the last word ‘the’ triggers the rule, the process goes to 5424 (3150 to remove) the last word by setting the flag to true.

The process returns at 2948 with the remove last word flag set to ‘true’. The process moves to 2950 where the last word ‘the’ is removed from the TC and returned to the SIF Element. The resulting TC looks like this:

<Cluster ID=“” PieceCount=“” WordCount=“ ” CharCount=“ ”
Delay=“ ” ClusterWeight=“ ” Link=“”>

<Piece ID=“ ” WordCount=“ ” CharCount=“ ” Type=“Text”
Region=“Neutral”> pertaining to
</Piece>

</Cluster >

The next cluster starts at 2908. A Piece of type Text is created at 2908 as the process has not moved out of the first SIF Element (SIFID=‘3’). The words left to process in this Element are “the charting invention.” Following a path similar to one described above, the words “the” and “charting” comprise the fifth cluster. Adding the word “invention” to this cluster triggers the Maximum Length Evaluator and is then left out.

<Cluster ID=“” PieceCount=“” WordCount=“ ” CharCount=“ ”
Delay=“ ” ClusterWeight=“ ” Link=“”>

<Piece ID=“ ” WordCount=“ ” CharCount=“ ” Type=“Text”
Region=“Neutral”> the charting
</Piece>

</Cluster >

Again the next TC is formed starting at 2906. A Piece of type Text is created at 2908. The query at 2910 evaluates to ‘No’ as this is not the first time this SIF Element has been processed. At 2952 the last remaining word in this Element to be processed is discovered and processing continues to 2914. A Long Word Check is performed at 2916 and evaluates to ‘No’. The process adds the word to the TC at 2918. The Maximum Length Evaluator at 2920 evaluates to false at 2922. At 2924, the word “invention.” does end in a punctuation mark. The presence of the punctuation mark causes the algorithm to close the TC and append it to the TCL.

The process continues at 2906. A new TC is created and 2908 creates a Piece of type Text within the TC. The Element has been previously processed, so 2910 moves to 2952. This time there are no words remaining to be processed in the Element and process moves to 2954. There are no more Elements in the Sentence (SIFID=‘3’), hence 2954 takes the ‘No’ path to 2958. There are no unfinished TC to be committed to the TCL and the process moves to process 2962 in FIG. 32.

Prior to process 2962, the TCL for Algorithm A looks like this:

<TCL AlgID=“A” >

<Cluster ID=“” PieceCount=“” WordCount=“ 3” CharCount=“16”
Delay=“ ” ClusterWeight=“ ” Link=“ ”>

<Piece ID=“ ” WordCount=“ 3” CharCount=“ 16” Type=“Text”
Region=“Neutral”> This document is
</Piece>

</Cluster >
<Cluster ID=“” PieceCount=“1” WordCount=“3 ” CharCount=“19 ”
Delay=“ ” ClusterWeight=“ ” Link=“ ”>

<Piece ID=“” WordCount=“ 3” CharCount=“19 ” Type=“Text”
Region=“Neutral”> intended to outline
</Piece>

</Cluster >
<Cluster ID=“” PieceCount=“” WordCount=“ 3” CharCount=“17 ”
Delay=“ ” ClusterWeight=“ ” Link=“ ”>

<Piece ID=“” WordCount=“3 ” CharCount=“ 17” Type=“Text”
Region=“Neutral”> the patent claims
</Piece>

</Cluster >
<Cluster ID=“” PieceCount=“” WordCount=“2 ” CharCount=“ 14”
Delay=“ ” ClusterWeight=“ ” Link=“ ”>

<Piece ID=“ ” WordCount=“ 2” CharCount=“ 14” Type=“Text”
Region=“Neutral”> pertaining to
</Piece>

</Cluster >
<Cluster ID=“” PieceCount=“” WordCount=“2” CharCount=“12”
Delay=“ ” ClusterWeight=“ ” Link=“ ”>

<Piece ID=“ ” WordCount=“ 2” CharCount=“12” Type=“Text”
Region=“Neutral”> the charting
</Piece>

</Cluster >
<Cluster ID=“” PieceCount=“” WordCount=“1 ” CharCount=“10 ”
Delay=“ ” ClusterWeight=“ ” Link=“ ”>

<Piece ID=“” WordCount=“1” CharCount=“10” Type=“Text”
Region=“Neutral”> invention.
</Piece>

</Cluster >

</TCL >

Starting at 3202, there is more than one cluster in the TCL. The process moves to 3204, since this TCL is the first Cluster List processed, there are no entries in the Master Cluster List (MCL). The process moves to 3208, where the Temp Cluster List is inserted into a Compare Cluster List. The process moves to 3210, where the first cluster is obtained. At 3212, a check is performed to see if there is a subsequent cluster to check against. There is, so the process moves to 3220. The difference in length of characters is compared between the two clusters (16 characters and 19 characters=3). The difference is then checked to see of it meets the Difference Threshold (DT=5) criterion found in the Configuration Spread Sheet. It does not; the process returns to 3210 and a comparison is made between clusters 2 and 3. The process continues until the last two adjacent clusters are compared. It is summarized below.

| Clusters | Difference in | Difference | |
|---|---|---|---|
| Compared | Characters | Threshold met | DT Counter |
| 1, 2 | 3 | No | 0 |
| 2, 3 | 2 | No | 0 |
| 3, 4 | 3 | No | 0 |
| 4, 5 | 2 | No | 0 |
| 5, 6 | 2 | No | 0 |

In this example, 3222 never occurred because the difference threshold of 5 characters was never met.

When there are no more clusters left to compare against, the process continues at 3214 where a standard deviation is calculated for the character lengths of the TCL.

In box 3216, the standard deviation and DT Counter values are added to the TCL. The result is:
<TCL AlgID=“A” StdDev=“3.326” DTC=“0”> . . . </TCL>

The process now returns to the calling process at 2802.

The process returns from 2962 and is passed back to the calling process, process 2716, to continue at 2806 where the same process occurs except this time the configuration settings for Algorithm B are used. Details of this process are Similar to the above and are not described. The same process is also used for Algorithm configuration C (at 2806) and is not described in detail. It is to be understood that Algorithms A, B and C may vary substantially or largely as a result of differences in configuration settings. For example, each algorithm may have a column in a configuration file with settings or values that they use to effect process 2400 and other processes.

Running through the results we end up with 3 TCLs shown here:

< TCL AlgID=“A” StdDev=“3.326” DTC=“0” > . . . </TCL >

< TCL AlgID=“B” StdDev=“3.527” DTC=“1” > . . . </TCL >
< TCL AlgID=“C” StdDev=“3.608” DTC=“0” > . . . </TCL >

The process now moves on to process 2806 in FIG. 33.

The process starts at 3202 where the Difference Threshold Count (DTC) of Algorithm A against that of Algorithm B. At ‘No’ response is obtained and goes to 3404 which evaluates ‘true’ as the DTC of A is less than DTC B. The process moves to 3312 where Algorithm A is chosen above Algorithm B. The process moves to 3314. Here the DTC of A and DTC of C are equal, so the process is passed to 3324. At 3324, the standard deviations are compared. As they are not equal (A=3.326 while C=3.608) the process moves to 3326. Since the standard deviation of A is lower than C, 3326 evaluates positively and the process moves to 3318 to choose A. The TCL is chosen to be Algorithm A. The process is returned to calling process 2716. The process is returned at 2808 and proceeds to 2810 in FIG. 34.

This process aims to insert the TCL into the FSIF started above. The Sentence currently takes this form.
<Sentence ID=“4” ClusterCount=“ ” WordCount=“ ” CharCount=“ ” DelayCount=“ ” DiffCount=“ ” AlgID=“ ”>

At 3402, the Difference Count of the chosen algorithm (A) is stored in the DiffCount attribute.
<Sentence ID=“4” ClusterCount=“ ” WordCount=“ ” CharCount=“ ” DelayCount=“ ” DiffCount=“0” AlgID=“ ” StdDev=“ ”>

At 3402, the standard deviation of the chosen algorithm (A) is stored in the StdDev attribute. The Algorithm Identifier is then chosen, still at 3402. The first TC is chosen at 3404, the word count is inserted on the Cluster at 3406, followed by the character count. It is to be understood that these values may have been calculated before for use in the TC and just carried over to the Clusters used in the Sentence. A sequential and unique identifier (ID) is inserted at 3406 for Clusters and Pieces. The number of Pieces belonging to the Cluster is inserted, still at 3406.

At 3408, the process is transferred to process 3408 in FIG. 35, passing in the Cluster:

<Cluster ID=“5” PieceCount=“1” WordCount=“ 3” CharCount=“16”
Delay=“ ” ClusterWeight=“ ” Link=“ ”>

<Piece ID=“ 6” WordCount=“ 3” CharCount=“ 16” Type=“Text”
Region=“Neutral”> This document is
</Piece>

</Cluster >

At box 3502, it is determined that only one Piece is present in this Cluster, the process proceeds to 3504. At 3504, it is determined that the Piece is of type Text. Following the yes path to 3506, there is more than one word in this Cluster, so the process continues to 3516. This is not a two word cluster, the process follows the ‘No’ path to 3126. At 3526, it is determined that this is a 3 word Cluster. The process continues along the ‘Yes’ path to 3528. At 3528, the number of characters in word 1 (4) is checked to see if it is greater than the number of characters in Words 2 and 3 combined (10). This evaluates to false and the process moves to 3530. At 3530, a check is made to see if the length of word 3 (2) is greater than the length of words 1 and 2 combined (12). It is not, and the process moves to 3512 where the Cluster is assigned a Cluster Weight of Neutral. The process then returns to the calling process in FIG. 34 at 3410.

The process returns at box 3410, where it is determined that there are more Clusters to be processed. The process continues at 3410 where the Delay attribute is set. In the configuration spreadsheets, a Cluster Delay is set to 1. At 3420, it is determined that this is the first Cluster and the process continues to 3422. The Link attribute is set to “Next”. The process now returns to 3404. The process continues for all the Clusters in the TCL until a Cluster list is produced.

<Cluster ID=“5” PieceCount=“” WordCount=“ 3” CharCount=“16”
Delay=“ 1” ClusterWeight=“ ” Link=“ Next”>

<Piece ID=“ 6” WordCount=“ 3” CharCount=“ 16” Type=“Text”
Region=“Neutral”> This document is
</Piece>

</Cluster >
<Cluster ID=“7” PieceCount=“1” WordCount=“3 ” CharCount=“20 ”
Delay=“ 1” ClusterWeight=“ ” Link=“ Both”>

<Piece ID=“8 ” WordCount=“ 3” CharCount=“20 ” Type=“Text”
Region=“Neutral”> intended to outline
</Piece>

</Cluster >
<Cluster ID=“9” PieceCount=“” WordCount=“ 3” CharCount=“17 ”
Delay=“ 1” ClusterWeight=“ ” Link=“ Both ”>

<Piece ID=“10” WordCount=“3 ” CharCount=“ 17” Type=“Text”
Region=“Neutral”> the patent claims
</Piece>

</Cluster >
<Cluster ID=“11” PieceCount=“” WordCount=“2 ” CharCount=“ 14”
Delay=“ 1” ClusterWeight=“ ” Link=“ Both ”>

<Piece ID=“12 ” WordCount=“ 2” CharCount=“ 14” Type=“Text”
Region=“Neutral”> pertaining to
</Piece>

</Cluster >
<Cluster ID=“13” PieceCount=“” WordCount=“2” CharCount=“12”
Delay=“ 1” ClusterWeight=“ ” Link=“ Both ”>

<Piece ID=“ 14” WordCount=“ 2” CharCount=“12” Type=“Text”

Region=“Neutral”> the charting

</Piece>

</Cluster >
<Cluster ID=“15” PieceCount=“” WordCount=“1 ” CharCount=“10 ”
Delay=“ 1” ClusterWeight=“ ” Link=“ Previous ”>

<Piece ID=“16” WordCount=“1” CharCount=“10” Type=“Text”

Region=“Neutral”> invention.

</Piece>

</Cluster >

The process is then returned to calling process 2716 and proceeds to 2810 where various characteristics and data, such as the sum of the number of delays, are determined or counted and inserted in the sentence. The sentence is finalized and takes the form:

<Sentence ID=“4” ClusterCount=“6” WordCount=“14” CharCount=“0” DelayCount=“6” Delay=“0” DiffCount=“0”
AlgID=“A” StdDev=“3.326” >

<Cluster ID=“5” PieceCount=“” WordCount=“ 3” CharCount=“16” Delay=“ 1” ClusterWeight=“ ” Link=“
Next”>

<Piece ID=“ 6” WordCount=“ 3” CharCount=“ 16” Type=“Text” Region=“Neutral”> This document
is
</Piece>

</Cluster >
<Cluster ID=“7” PieceCount=“1” WordCount=“3 ” CharCount=“20 ” Delay=“ 1” ClusterWeight=“ ” Link=“
Both”>

<Piece ID=“8 ” WordCount=“ 3” CharCount=“20 ” Type=“Text” Region=“Neutral”> intended to
outline
</Piece>

</Cluster >
<Cluster ID=“9” PieceCount=“” WordCount=“ 3” CharCount=“17 ” Delay=“ 1” ClusterWeight=“ ” Link=“ Both
”>

<Piece ID=“10” WordCount=“3 ” CharCount=“ 17” Type=“Text” Region=“Neutral”> the patent
claims
</Piece>

</Cluster >
<Cluster ID=“11” PieceCount=“” WordCount=“2 ” CharCount=“ 14” Delay=“ 1” ClusterWeight=“ ” Link=“ Both
”>

<Piece ID=“12 ” WordCount=“ 2” CharCount=“ 14” Type=“Text” Region=“Neutral”> pertaining to
</Piece>

</Cluster >
<Cluster ID=“13” PieceCount=“” WordCount=“2” CharCount=“12” Delay=“ 1” ClusterWeight=“ ” Link=“ Both
”>

<Piece ID=“ 14” WordCount=“ 2” CharCount=“12” Type=“Text” Region=“Neutral”> the charting
</Piece>

</Cluster >
<Cluster ID=“15” PieceCount=“” WordCount=“1 ” CharCount=“10 ” Delay=“ 1” ClusterWeight=“ ” Link=“
Previous ”>

<Piece ID=“16” WordCount=“1” CharCount=“10” Type=“Text” Region=“Neutral”> invention.
</Piece>

</Cluster >

</Sentence >

The process is now returned to calling process 2620 at 2712. There is another Sentence to be processed and the process is transferred back to process 2716. For the sake of brevity, other Sentence formations are not going to be described in detail.

Once all the sentences have been processed, 2712 takes the “No” path to 2714. Here the Word Count, Cluster Count, Character Count and Delay Counts are inserted on the Paragraph Node.

Taking into account all the Sentences to be processed for the Paragraph with ID=‘3’, we obtain this result.
<Paragraph ID=“3” ClusterCount=“27” WordCount=“63” CharCount=“366” DelayCount=“26” Delay=“0”>

The process then moves from 2628 to 2604. The process is returned to calling process 2504 at 2616. There is one more paragraph to be processed (SIFID=‘11’) but it will not be described in detail. Once all the paragraphs are processed, the process moves from 2616 to 2628 where the Word Count, Cluster Count, Character Count, and Delay Count are calculated and inserted.

The Section now looks like this:

< Section ID=“2” Type=“Basic” Heading=“Introduction”
ClusterCount=“39” WordCount=“90” CharCount=“530”
DelayCount=“38” Level=“1” Delay=“0” >

When there are no more Sections to be processed, control is transferred back to calling process 2402 to 2506, where the Word Count, Cluster Count, Character Count, Delay Count are all tabulated and added. Process 2402 continues at 2506 where the Average Words per Cluster, Standard Deviation of Words per Cluster, Average Characters per Cluster, Standard Deviation of Words per Cluster are inserted and the number of times algorithm A B and C were selected are tabulated and inserted. The resulting FSIF node is thus:

<SpreedStream ID=“1” ClusterCount=“39” WordCount=“90” CharCount=“530” DelayCount=“38” Heading=“Chart
Preliminary Patent Claims v.1.0 ” Publisher=“ ” PublishedYear=“” Location=“ ” ISBN=“” AvgWPC=“2.30”
AvgCPC=“11.58” StdDevWPC=“0.970” StdCPC=“4.72” AlgACount=“5” AlgBCount=“0 ” AlgCCount =“0” >

Once 2506 is complete, the Cluster Formation Algorithm is complete. The final product is shown in Table 6.

TABLE 6
The Completed FSIF

<FSIF ID=“1” ClusterCount=“” WordCount=“” CharCount=“” DelayCount=“” Heading=“Chart Preliminary Patent
Claims v.1.0 ” Publisher=“ ” PublishedYear=“” Location=“ ” ISBN=“” AvgWPC=“” AvgCPC=“” StdDevWPC=“” StdCPC=“”
AlgACount=“ ” AlgBCount=“ ” AlgCCount =“” >

< Section ID=“2” Type=“Basic” Heading=“Introduction” ClusterCount=“39” WordCount=“77” CharCount=“452”
DelayCount=“38” Level=“1” Delay=“0” >

<Paragraph ID=“3” ClusterCount=“27” WordCount=“63” CharCount=“366” DelayCount=“26” Delay=“0”>

<Sentence ID=“4” ClusterCount=“6” WordCount=“14” CharCount=“89” DelayCount=“6” Delay=“0”
DiffCount=“0” AlgID=“A” StdDev=“3.326” >

<Cluster ID=“5” PieceCount=“” WordCount=“ 3” CharCount=“16” Delay=“ 1” ClusterWeight=“ ”
Link=“ Next”>

<Piece ID=“ 6” WordCount=“ 3” CharCount=“ 16” Type=“Text” Region=“Neutral”> This
document is
</Piece>

</Cluster >
<Cluster ID=“7” PieceCount=“1” WordCount=“3 ” CharCount=“20 ” Delay=“ 1” ClusterWeight=“ ”
Link=“ Both”>

<Piece ID=“8 ” WordCount=“ 3” CharCount=“20 ” Type=“Text” Region=“Neutral”>
intended to outline
</Piece>

</Cluster >
<Cluster ID=“9” PieceCount=“” WordCount=“ 3” CharCount=“17 ” Delay=“ 1” ClusterWeight=“ ”
Link=“ Both ”>

<Piece ID=“10” WordCount=“3 ” CharCount=“ 17” Type=“Text” Region=“Neutral”> the
patent claims
</Piece>

</Cluster >
<Cluster ID=“11” PieceCount=“” WordCount=“2 ” CharCount=“ 14” Delay=“ 1” ClusterWeight=“ ”
Link=“ Both ”>

<Piece ID=“12 ” WordCount=“ 2” CharCount=“ 14” Type=“Text” Region=“Neutral”>
pertaining to
</Piece>

</Cluster >
<Cluster ID=“13” PieceCount=“” WordCount=“2” CharCount=“12” Delay=“ 1” ClusterWeight=“ ”
Link=“ Both ”>

<Piece ID=“ 14” WordCount=“ 2” CharCount=“12” Type=“Text” Region=“Neutral”> the

charting

</Piece>

</Cluster >
<Cluster ID=“15” PieceCount=“” WordCount=“1 ” CharCount=“10 ” Delay=“ 1” ClusterWeight=“ ”
Link=“ Previous ”>

<Piece ID=“16” WordCount=“1” CharCount=“10” Type=“Text” Region=“Neutral”>

invention.

</Piece>

</Cluster >

</Sentence >
<Sentence ID=“17” ClusterCount=“16” WordCount=“40” CharCount=“229” DelayCount=“16” Delay=“0”
DiffCount=“2” AlgID=“A” StdDev=“3.646” >

<Cluster ID=“18” PieceCount=“1” WordCount=“2” CharCount=“14” Delay=“ 1” ClusterWeight=“ ”
Link=“ Next ”>

<Piece ID=“19 ” WordCount=“2” CharCount=“14” Type=“Text” Region=“Neutral”>This
document,
</Piece>

</Cluster >
<Cluster ID=“20” PieceCount=“” WordCount=“ 3” CharCount=“ 16” Delay=“ 1” ClusterWeight=“ ”
Link=“ Both ”>

<Piece ID=“21 ” WordCount=“3” CharCount=“16” Type=“Text” Region=“Neutral”> as a
preliminary
</Piece>

</Cluster >
<Cluster ID=“22” PieceCount=“” WordCount=“ 3” CharCount=“ 15” Delay=“ 1” ClusterWeight=“ ”
Link=“ Both ”>

<Piece ID=“23 ” WordCount=“ 3” CharCount=“ 15” Type=“Text” Region=“Neutral”> set
of claims,
</Piece>

</Cluster >
<Cluster ID=“24” PieceCount=“” WordCount=“ 3” CharCount=“ 19” Delay=“ 1” ClusterWeight=“ ”
Link=“ Both ”>

<Piece ID=“25 ” WordCount=“ 3” CharCount=“ 19” Type=“Text” Region=“Neutral”>
necessarily must be
</Piece>

</Cluster >
<Cluster ID=“26” PieceCount=“” WordCount=“ 1” CharCount=“ 8” Delay=“ 1” ClusterWeight=“ ”
Link=“ Both ”>

<Piece ID=“27 ” WordCount=“ 1” CharCount=“ 8” Type=“Text” Region=“Neutral”>

reviewed

</Piece>

</Cluster >
<Cluster ID=“28” PieceCount=“” WordCount=“ 2” CharCount=“ 11” Delay=“ 1” ClusterWeight=“ ”
Link=“ Both ”>

<Piece ID=“29 ” WordCount=“ 2” CharCount=“ 11” Type=“Text” Region=“Neutral”> and
undergo
</Piece>

</Cluster >
<Cluster ID=“30” PieceCount=“” WordCount=“ 1” CharCount=“ 13” Delay=“ 1” ClusterWeight=“ ”
Link=“ Both ”>

<Piece ID=“ 31” WordCount=“ 1” CharCount=“ 13” Type=“Text” Region=“Neutral”>

modifications

</Piece>

</Cluster >
<Cluster ID=“32” PieceCount=“” WordCount=“ 4” CharCount=“ 18” Delay=“ 1” ClusterWeight=“ ”
Link=“ Both ”>

<Piece ID=“33” WordCount=“ 4” CharCount=“ 18” Type=“Text” Region=“Neutral”> in
order to refine
</Piece>

</Cluster >
<Cluster ID=“34” PieceCount=“” WordCount=“ 2” CharCount=“ 12” Delay=“ 1” ClusterWeight=“ ”
Link=“ Both ”>

<Piece ID=“35 ” WordCount=“ 2” CharCount=“ 12” Type=“Text” Region=“Neutral”> the
phrasing
</Piece>

</Cluster >
<Cluster ID=“36” PieceCount=“” WordCount=“ 4” CharCount=“ 17” Delay=“ 1” ClusterWeight=“ ”
Link=“ Both ”>

<Piece ID=“37 ” WordCount=“ 4” CharCount=“ 17” Type=“Text” Region=“Neutral”> and
scope of each
</Piece>

</Cluster >
<Cluster ID=“38” PieceCount=“” WordCount=“ 4” CharCount=“ 19” Delay=“ 1” ClusterWeight=“ ”
Link=“ Both ”>

<Piece ID=“39 ” WordCount=“ 4” CharCount=“ 19” Type=“Text” Region=“Neutral”>
claim and to ensure
</Piece>

</Cluster >
<Cluster ID=“40” PieceCount=“” WordCount=“ 3” CharCount=“ 18” Delay=“ 1” ClusterWeight=“ ”
Link=“ Both ”>

<Piece ID=“41 ” WordCount=“ 3” CharCount=“ 18” Type=“Text” Region=“Neutral”> that
the invention
</Piece>

</Cluster >
<Cluster ID=“42” PieceCount=“” WordCount=“ 2” CharCount=“ 13” Delay=“ 1” ClusterWeight=“ ”
Link=“ Both ”>

<Piece ID=“43” WordCount=“ 2” CharCount=“ 13” Type=“Text” Region=“Neutral”> is
completely
</Piece>

</Cluster >
<Cluster ID=“44” PieceCount=“” WordCount=“ 1” CharCount=“ 7” Delay=“ 1” ClusterWeight=“ ”
Link=“ Both ”>

<Piece ID=“ 45” WordCount=“1” CharCount=“ 7” Type=“Text” Region=“Neutral”>

defined

</Piece>

</Cluster >
<Cluster ID=“46” PieceCount=“” WordCount=“ 2” CharCount=“ 13” Delay=“ 1” ClusterWeight=“ ”
Link=“ Both ”>

<Piece ID=“47” WordCount=“ 2” CharCount=“ 13” Type=“Text” Region=“Neutral”> and

protected

</Piece>

</Cluster >
<Cluster ID=“48” PieceCount=“” WordCount=“ 3” CharCount=“ 16” Delay=“ 1” ClusterWeight=“ ”
Link=“ Previous ”>

<Piece ID=“49” WordCount=“ 3” CharCount=“ 16” Type=“Text” Region=“Neutral”> by
those claims.
</Piece>

</Cluster >

</Sentence >
<Sentence ID=“80” ClusterCount=“4” WordCount=“9” CharCount=“48” DelayCount=“4” Delay=“0”
DiffCount=“2” AlgID=“A” StdDev=“5.354” >

<Cluster ID=“51” PieceCount=“” WordCount=“ 3” CharCount=“ 13” Delay=“ 1” ClusterWeight=“ ”
Link=“ Next ”>

<Piece ID=“ 52” WordCount=“ 3” CharCount=“ 13” Type=“Text” Region=“Neutral”> An
example of
</Piece>

</Cluster >
<Cluster ID=“53” PieceCount=“” WordCount=“ 2” CharCount=“ 12” Delay=“ 1” ClusterWeight=“ ”
Link=“ Both ”>

<Piece ID=“ 54” WordCount=“ 2” CharCount=“ 12” Type=“Text” Region=“Neutral”> the

charting

</Piece>

</Cluster >
<Cluster ID=“55” PieceCount=“” WordCount=“ 3” CharCount=“ 18” Delay=“ 1” ClusterWeight=“ ”
Link=“ Both ”>

<Piece ID=“56” WordCount=“ 3” CharCount=“ 18” Type=“Text”
Region=“Neutral”>invention is shown
</Piece>

</Cluster >
<Cluster ID=“57” PieceCount=“” WordCount=“ 1” CharCount=“ 5” Delay=“ 1” ClusterWeight=“ ”
Link=“ Previous ”>

<Piece ID=“58” WordCount=“ 1” CharCount=“ 5” Type=“Text” Region=“Neutral”> here:
</Piece>

</Cluster >

</Sentence >
<Sentence ID=“59” ClusterCount=“1” WordCount=“0” CharCount=“0” DelayCount=“0” Delay=“0”
DiffCount=“2” AlgID=“A” StdDev=“na” >

<Cluster ID=“60” PieceCount=“” WordCount=“” CharCount=“” Delay=“ 0” ClusterWeight=“ ” Link=“
None”>

<Piece ID=“61” WordCount=“” CharCount=“” Type=“Special-Long-Figure”
Region=“Neutral”> Chart.bmp
</Piece>

</Cluster >

</Sentence >

</Paragraph>
<Paragraph ID=“62” ClusterCount=“6” WordCount=“14” CharCount=“86” DelayCount=“6” Delay=“0”>

<Sentence ID=“63” ClusterCount=“6” WordCount=“14” CharCount=“86” DelayCount=“6” Delay=“0”
DiffCount=“2” AlgID=“A” StdDev=“6.369” >

<Cluster ID=“64” PieceCount=“” WordCount=“ 3” CharCount=“ 17” Delay=“ 1” ClusterWeight=“ ”
Link=“ Next ”>

<Piece ID=“ 65” WordCount=“ 3” CharCount=“ 17” Type=“Text” Region=“Neutral”> The
invention was
</Piece>

</Cluster >
<Cluster ID=“66” PieceCount=“” WordCount=“ 1” CharCount=“ 12” Delay=“ 1” ClusterWeight=“ ”
Link=“ Both ”>

<Piece ID=“67” WordCount=“ 1” CharCount=“ 12” Type=“Text” Region=“Neutral”>

conceived

</Piece>

</Cluster >
<Cluster ID=“68” PieceCount=“2” WordCount=“ 3” CharCount=“ 15” Delay=“ 1” ClusterWeight=“ ”
Link=“ Both ”>

<Piece ID=“ 69” WordCount=“ 1” CharCount=“ 2” Type=“Text” Region=“Neutral”> in
</Piece>
<Piece ID=“70” WordCount=“ 2” CharCount=“ 13” Type=“Text-Date” Region=“Neutral”>
January, 2001
</Piece>

</Cluster >
<Cluster ID=“71” PieceCount=“1” WordCount=“ 2” CharCount=“ 4” Delay=“ 1” ClusterWeight=“ ”
Link=“ Both ”>

<Piece ID=“72” WordCount=“ 2” CharCount=“ 4” Type=“Text” Region=“Neutral”> at a
</Piece>

</Cluster >
<Cluster ID=“73” PieceCount=“1” WordCount=“ 3” CharCount=“ 21” Delay=“ 1” ClusterWeight=“ ”
Link=“ Both ”>

<Piece ID=“74” WordCount=“ 3” CharCount=“ 21” Type=“Text-Place”
Region=“Neutral”> University of Toronto</Piece>

</Cluster >
<Cluster ID=“75” PieceCount=“1” WordCount=“ 1” CharCount=“ 4” Delay=“ 1” ClusterWeight=“ ”
Link=“ Previous ”>

<Piece ID=“76” WordCount=“ 1” CharCount=“ 4” Type=“Text ” Region=“Neutral”>

lab.</Piece>
</Cluster >

</Sentence >
<Sentence ID=“77” ClusterCount=“6” WordCount=“14” CharCount=“78” DelayCount=“6” Delay=“6”
DiffCount=“2” AlgID=“A” StdDev=“6.164” >

<Cluster ID=“78” PieceCount=“2” WordCount=“ 4” CharCount=“ 18” Delay=“ 1” ClusterWeight=“ ”
Link=“ Next ”>

<Piece ID=“ 79” WordCount=“ 2” CharCount=“ 7” Type=“Text ” Region=“Neutral”> It
took </Piece>
<Piece ID=“ 80” WordCount=“ 1” CharCount=“ 11” Type=“Text-Period of Time”
Region=“Neutral”> three years</Piece>

</Cluster >
<Cluster ID=“81” PieceCount=“1” WordCount=“ 2” CharCount=“ 11” Delay=“1” ClusterWeight=“ ”
Link=“ Both ”>

<Piece ID=“82 ” WordCount=“ 2” CharCount=“ 11” Type=“Text ” Region=“Neutral”> of
research </Piece>

</Cluster >
<Cluster ID=“83” PieceCount=“1” WordCount=“ 3” CharCount=“ 18” Delay=“1” ClusterWeight=“ ”
Link=“ Both ”>

<Piece ID=“ 84” WordCount=“ 3” CharCount=“ 18” Type=“Text ” Region=“Neutral”> and
development to </Piece>

</Cluster >
<Cluster ID=“85” PieceCount=“1” WordCount=“ 1” CharCount=“ 5” Delay=“ 1” ClusterWeight=“ ”
Link=“ Both ”>

<Piece ID=“86” WordCount=“ 1” CharCount=“ 5” Type=“Text ” Region=“Neutral”>

reach </Piece>
</Cluster >
<Cluster ID=“87” PieceCount=“1” WordCount=“ 3” CharCount=“ 19” Delay=“ 1” ClusterWeight=“ ”
Link=“ Both ”>

<Piece ID=“88” WordCount=“ 3” CharCount=“ 19” Type=“Text ” Region=“Neutral”> a
breakthrough last </Piece>

</Cluster >
<Cluster ID=“89” PieceCount=“1” WordCount=“ 1” CharCount=“ 7” Delay=“ 1” ClusterWeight=“ ”
Link=“ Previous”>

<Piece ID=“ 90” WordCount=“ 1” CharCount=“ 7” Type=“Text ” Region=“Neutral”>
summer.</Piece>

</Cluster >

</Sentence >

</Paragraph>

</Section >

</FSIF >

### Other Examples

Although the parsing process was described with respect to one example, such example did not reveal all of the nuances of such processing. A few of such nuances will be further described, with illustrations provided where appropriate.

In looking at the FSIF in Table 6, the cluster with ID=‘60’ contains a chart. The chart originates in the portion of the SIF described here:

<Sentence SIFID =“9”>

| <Element SIFID =“10” Type=“Special-Long-Figure” | |
|---|---|
| FontFace=“ ” FontSize=“” | FontStyle=“Plain” |

FontColour=“Black”>Chart.bmp</Element>

</Sentence>

Attaching to process 2716 in FIG. 28 at (or wherever an empty Sentence node is created) the process moves on to 2804.

Starting at 2902, a Temp Cluster List (TCL) is created. Then at 2904, the next Element (SIFID=‘10’) is retrieved. At 2906, a new empty TC is created. At 2908, a Piece is created with the same type as the SIF Element. In this case, the type is “Special-Figure”. The Element (SIFID=‘10’) has not been previously processed, so the path follows the yes path to 2912. The Element is not of type Text or Quote, and the path follows the ‘No’ (Special Element) path.

Here a Long Element/Word check is performed. In this case, the figure is ‘Long’ at 2930, and proceeds to 2932. Because the TC is empty, 2932 leads to 2936. At 2936, a Piece is inserted to the TC containing the Long Special Element. The process continues to 2938. The current TC is closed and it is appended to the TCL. The values for Word Count, CharCount are calculated and inserted. The process moves onto the next Element.

The resultant FSIF node that fits into the Sentence is this:

<Sentence ID=“59” ClusterCount=“1” WordCount=“0” CharCount=“0”
DelayCount=“0” Delay=“0” DiffCount=“2” AlgID=“A” StdDev=“na” >

<Cluster ID=“60” PieceCount=“” WordCount=“” CharCount=“”
Delay=“ 0” ClusterWeight=“ ” Link=“ None”>

<Piece ID=“61” WordCount=“” CharCount=“”
Type=“Special-Long-Figure” Region=“Neutral”> Chart.bmp
</Piece>

</Cluster >

</Sentence >

Because this is a special figure, the Word Count and Character Count are left empty.

A second nuance is observed with respect to the conjunction grammar rule and a long word at the end of a cluster. An example of applying the conjunction grammar rule can be found in ID=‘26’ and ID=‘28’:

<Cluster ID=“26” PieceCount=“” WordCount=“ 1” CharCount=“ 8”
Delay=“ 1” ClusterWeight=“ ” Link=“ Both ”>

<Piece ID=“27 ” WordCount=“ 1” CharCount=“ 8”
Type=“Text” Region=“Neutral”> reviewed
</Piece>

</Cluster >
<Cluster ID=“28” PieceCount=“” WordCount=“ 2” CharCount=“ 11”
Delay=“ 1” ClusterWeight=“ ” Link=“ Both
”>

<Piece ID=“29 ” WordCount=“ 2” CharCount=“ 11”
Type=“Text” Region=“Neutral”> and undergo
</Piece>

</Cluster >

Following how this was created begins with looking at SIF (SIFID=‘6’). The parsing process has to process the Element and starts a new Temp Cluster adds the word “reviewed” to the TC from the Element. Turning to 2952 in process 2802, another word remains in the Element SIFID=‘6’ to process. The process follows the ‘yes’ path to 2964, where the next word “and” is retrieved. A long word check is performed on the word (“and”) at 2918. Since this process has been previously described, it is not described now. The long word check is negative and the word is added to the TC at 2918.

The process moves on to 2920. Again, because this has been described previously, it is not described in detail here. However, the maximum length is not exceeded. The process flows from 2922 to 2924, which evaluates negatively, as the temp cluster does not end with a punctuation mark. The process then returns to 2952 to check if more words are available to be processed in the Element SIFID=‘6’.

Since there are more words, the process moves to 2914 where the word “undergo” is retrieved. A Long Word Check is performed at 2916. It returns negative and the word is now added to the TC at 2918. The TC now contains the words “reviewed and contains”. The process moves to 2920.

In process 2920 the last word may be long. In process 2920 in FIG. 30, the TC fails on maximum characters at 5305. It then follows 3026 and 3028 (no punctuation to break on), and on to 3038 and 3040 (no small word exception rule). Process continue to 3042, where the configuration spreadsheet indicates that the position of last word rule is on.

The process moves to 3044, where the length of the TC subtract one word (“reviewed and”) is 12 characters long is compared to the maximum allowable number of characters minus End of Second Last word position (EoSL) which may be defined in the algorithm configuration spreadsheet This is calculated as 18−5=13. Since the 12 characters is less than the 13 characters, 3044 evaluates to true. The process moves to 3046, where the length in characters of the TC (“reviewed and undergo”) (20 characters) is compared against the maximum characters allowed (18) plus additional characters allowed for a Long Last Word (LLAC=1 character).

Since the length of the TC is 20 characters and Maximum characters plus the exception is 19 characters, 3046 evaluates to Yes and the process continues to 3020 where the flag to remove the last word is set to true. The long last word exception was not long enough to include the word ‘undergo’. The process reverts back to the calling function.

The process returns from 2920, and at box 2922, the maximum length has been exceeded, the word ‘undergo’ is removed from the TC and returned to the Element found at SIFID=‘6’. At 2944, the grammar rules are found to be on. At 2946 the process is transferred to process 2946 in FIG. 31.

The grammar rules start at 3101 to evaluate the TC—“reviewed and”. Box 5401 evaluates the next word “undergo” to discover whether it is a long word, which it is not. The process continues to 3102, which evaluates to false as the TC does not end in a punctuation mark. The process moves to 3108 to find the preposition rule to be on. At 3110, the last word is evaluated against a list of prepositions. It is not a preposition and the process moves to 3122 where the conjunction rule is found to be on, and the process moves to 3124. The last word ‘and’ is a conjunction. The positive evaluation at 3124 results in moving to 3126, to check whether the second last word is a select pronoun. It is not, at the process moves to 3128 to evaluates the second last word against a list of possessive words. The second last word “reviewed” is not a possessive word nor is it an article (evaluated at box 3130). The no path is then followed from 3130 to 3150 where the flag to remove the last word “and” is set to true. The process returns to calling process 2946 at 2948, with last paragraph where the remove last word flag is found to be true. The last word ‘and’ is removed at 2950 and returned to its SIF Element. The process moves to 2938, where the current TC is ended and is appended to the TCL. The current TC is now the single word “reviewed” and can be seen at ID=‘26’. The process then starts again at 2906. The formation of the next cluster is not described in detail. However, the words that were removed from the TC just formed end up being included in the subsequent cluster ID=‘28’ and consists of the words “and undergo”.

Another nuance is seen where Cluster ID=‘68’ contains two Pieces, one of which is of type Date.

<Cluster ID=“68” PieceCount=“2” WordCount=“ 3” CharCount=“ 15”
Delay=“ 1” ClusterWeight=“ ” Link=“ Both ”>

<Piece ID=“69 ” WordCount=“ 1” CharCount=“ 2”
Type=“Text” Region=“Neutral”> in
</Piece>
<Piece ID=“70” WordCount=“ 2” CharCount=“ 13”

Type=“Text-Date” Region=“Neutral”> January, 2001

</Piece>

</Cluster >

The cluster is formed when processing the SIF at Elements SIFID=‘13’ and SIFID=‘14’.

<Element SIFID =“13” Type=“Text” FontFace=“Garamond”
FontSize=“11” FontStyle=“Plain” FontColour=“Black”> The invention
was conceived in </Element>
<Element SIFID =“14” Type=“Text-Date” FontFace=“Garamond”
FontSize=“11” FontStyle=“Plain” FontColour=“Black”> January,
2001</Element>

The previous Cluster to the ones about to be created had the words “was conceived”. The word “in” is the next word to be processed. Joining the algorithm at process 2802 at 2906, a TC is created. Moving to 2908, a Piece is created of Type=“Text”. Box 5105 evaluates to no as this Element has already been subjected to processing. Box 5113 evaluates to true as there are words to be evaluated. The process moves to 2914, where the word ‘in’ is retrieved, a Long Word check is performed at box 2916 and it evaluates to no. The word is then added to the TC at 2918.

A Maximum Character/Word Evaluation is performed at 2920 and this evaluates to no at 2922. The process moves to 2924 where it is determined that the TC does not end in a punctuation mark. The process then returns to 2952. There are no more words to in this Element (SIFID=‘13’) left to process. The process moves along the “no” path to 2954, where there is another Element to process. The algorithm continues at box 2904, where the next Element (SIFID=‘14’) is retrieved. Since the current TC is not closed, no new TC is created at 2906. At 2908, a new Piece of type Text-Date is created. Note that this is the second Piece that is created within the TC. At 2910 a determination is made that this is the initial processing of Element SIFID=‘14’.

The process moves to 2912, where it is determined that the Element is of type Text and moves to 2914 to retrieve the next Word from the Element. Elements of type Text-Date are treated as single word. Hence, the Word being considered in this case is “January, 2001”. A Long Word Check is performed at 2916. The Word being considered is not deemed long and is added to the TC at 2918. The process continues on to 2920, 2922, 2924, 2952. The process find that the current TC cannot be added to and hence takes the form:

<Cluster ID=“68” PieceCount=“2” WordCount=“ 3” CharCount=“ 15”
Delay=“ 1” ClusterWeight=“ ” Link=“ Both ”>

<Piece ID=“ 69” WordCount=“ 1” CharCount=“ 2”
Type=“Text” Region=“Neutral”> in
</Piece>
<Piece ID=“70” WordCount=“ 2” CharCount=“ 13”

Type=“Text-Date” Region=“Neutral”> January, 2001

</Piece>

</Cluster >

FIG. 36 is a block diagram of system 20 in accordance with an embodiment of the present invention. Like references are intended to refer to like elements unless specifically discussed otherwise. As shown in the embodiment of FIG. 36, much of system 20 may be at computing device 26.

For example, computing device 26 may comprise notes component 108 and content server component 115. As such, autosummary component 107, cluster formation component 106b, preparser component 106a, and converter component 102 may also be at computing device 26.

Computing device 26 may further comprise device application 25 that has renderer component 35. Renderer component 35 and/or device application 25 may communicate with, and access the functionality of, content server component 115, notes component 108 and ad integration component 1340 (such as via server component 1200). Such functionality, and ways to access it, are further described herein. Device application 25, with renderer component 35, may control UI 28 on display 56, allowing user 5 to interact with system 20 and use its functionality.

As shown in FIG. 36, server component 1200 may comprise ad integration component 1340.

In operation of the embodiment of system 20 in FIG. 36, user 5 may have different ways of using and accessing the functionality described above and herein. In one embodiment, content 10 or document 9 located at device 26 (optionally in storage 58) may be processed by one or more components at computing device 26 and then can be accessed and viewed using device application 25 and renderer component 35 on UI 28 of display 56 by user 5. In such an embodiment, ad integration component 1340, located at server component 1200, may add advertisements to content 10 that may be viewed on display 56 and/or UI 28.

In a further embodiment, user 5 may request remote documents or other content 10 located at content provider 1320 or at any other remote location external to computing device 26 that may have content 10 or document 9. User 5 may indicate they wish to use the functionality of system 20 to view or otherwise manipulate content 10. By way of example, a user 5 may select a link on a web page being displayed by device application 25 and indicate, for example by right clicking and selecting a menu option (not shown) indicating that they wish to view this link using the functionality of system 20. Upon making such indication, a request may be sent, via communication network 24 (if a connection is available, such as if a wireless network is accessible), to content provider 1320 to access content 10. Content provider 1320 may then provide content 10 to computing device 26, such as via communication network 24, and allow it to be stored at storage 58. Once content 10 is provided from content provider 1320 to storage 58 this embodiment may proceed substantially as the earlier-described embodiment, with various components operating on content 10 and then allowing content 10 to be viewed or otherwise used by device application 25 and renderer component 35.

A further embodiment of operation may involve computing device 26 automatically polling one or more content providers 1320 for content 10 to store at storage 58 and process using one or more components so that one or more of content server 115, notes component 108 and ad integration component 1340 can communicate with device application 35 to access content 10 and functionality of those components. For example news feeds may be polled at regular intervals by computing device 26 so user 5 can always easily read current news using device application 35 and renderer 25. This may allow them to, for example, read the news more quickly, receive a summary of the news, add notes to news articles or items, and potentially be provided advertisements relating directly to the news content that they want to read. User 5 may, for example via renderer component 25 or device application 35, specify what content providers 1320 to poll and what content 10 to download to computing device 26 for processing.

FIG. 37 is a block diagram of system 20 in accordance with an embodiment of the present invention. As shown in the embodiment of FIG. 37, server component 1200 may comprise much of system 20. For example, ad integration component 1340, notes component 108 and content server component 115 may be located at server component 1200. As such, autosummary component 107, cluster formation component 106B, preparser component 106A, and converter component 102 may also be at content provider 1200. As shown in FIG. 37, content provider 1200 may further have storage 58.

As such computing device 26 may have device application 25 that has renderer component 35. Renderer component 35 and/or device application 25 may communicate with, and access the functionality of various components at server component 1200 such as ad integration component 1340, content server component 115 and notes component 108. Computing device 26 then, with device application 25 and renderer component 35, may control UI28 on display 56, allowing user 5 to view the functionality of system 20.

Like references are used to denote like elements and therefore, for example, device application 25 via renderer 35 may access the functionality of ad integration component 1340 as described with respect to FIGS. 16 to 18, notes component 108 as described with respect to 11a-13c, and of content server 115, including auto summary component 107 as described with respect to FIGS. 20-23, and the conversion and cluster formation of converter component 102, preparser component 106A and cluster formation component 106B as described with respect to FIGS. 5-10 and 25-35.

In operation, user 5 may have different ways of using and accessing the functionality described above and herein. In one embodiment content 10 located at device 26 (optionally in storage 58 not shown) may be sent to storage 58 at server component 1200 via communication network 24. It is to be understood that content 10 may be sent or may be uploaded and the manner by which it arrives at storage 58 can vary. Content 10, having arrived at storage 58 may then be processed by one or more components at server component 1200 (such as to produce FSIF 9c) and then can be accessed and viewed using device application 25 and renderer component 35 on UI28 of display 56 by user 5. Such viewing and accessing may be accomplished by renderer component 35 communicating with one or more of ad integration component 1340, content server component 115 and notes component 108, such as via communication link 3702 which may be, for example, a wireless link or a wired link.

In a further embodiment user 5 may request a document or other content 10 and indicate they wish to use the functionality of system 20. By way of example, user 5 may select a link on an FTP site being displayed by device application 25 and indicate, for example by right clicking and selecting a menu option (not shown) that they wish to view this link using the functionality of system 20. Upon making such indication, a request may be sent via communication network 24 to content provider 1320 to access content 10 or document 9. Content provider 1320 may then provide content 10 to server component 1200 and allow it to be stored at storage 58. Providing the content from content provider 1320 to service component 1200 may be by communication network 24 which may be the same as, or different from, communication network 24 used to make the request of content provider 1320. Once content 10 is provided from content provider 1320 to storage 58 this embodiment may proceed substantially as the earlier-described embodiment.

A further embodiment may involve server component 1200 polling one or more content providers 1320 for content 10 to store at storage 58 and process using one or more components so that one or more of content server 115, notes component 108 and ad integration component 1340 can communicate with device application 35 to access content 10 and functionality of those components. For example news feed may be polled at regular intervals by server component 1200 so user 5 can always easily read current news using device application 35 and renderer 25. This may allow them to, for example, read the news more quickly, receive a summary of the news, add notes to news articles or items, and potentially be provided advertisements relating directly to the news content that they want to read. Server component 1200 may automatically push some or all of such polled content to computing device 26 and renderer component 35 or may await a request from user 5 of computing device 26.

Device application 35 may be, for example, a web browser having a component that consists of renderer component 35, a standalone application or a plug-in into another application such as Microsoft Word (trade-mark) or another commonly used application. It is to be understood therefore that renderer component 35 may be built in directly to device application 25, or may simply be accessed by device application 25 in any way or means as known to those as skill in the art, such as via a dynamic link library (DLL), a plug-in, .NET objects (trade-mark), COM+ objects, Java objects (trade-mark), or another manner.

FIG. 38 is a display 3800 for an implementation of autosummary component 107 in accordance with an embodiment of the present invention. Display 3800 may be a user interface, such as an embodiment of UI 28, that may comprise summary window 3802 for displaying summary 3826 comprising one or more summary phrases 3804, in one or more summary sections 3808 from a summarised document having summary title 3806. Display 3800 may further comprise summary user control 3816, which may further comprise summary reduction factor 3818, increase summary length button 3820 and decrease summary length button 3822.

Display 3800 may allow a user, such as user 5, to view a summary that has been generated from an original document. In addition display 3800 may allow user 5 to exercise some control over the manner in which the summary is generated and/or presented. For example, user 5 may select a certain number of the top ranking sentences from the original document to be displayed (ranked, for example, in order of decreasing relevance) or may indicate the extent to which the summary is desirably shorter than the original document (such as by specifying a fraction or percentage of the length of the summary relative to the original, optionally using increase summary control 3820 and decrease summary control 3822).

Summary window 3802 is an area of the user interface that may display summary 3826 of a document 9. Summary 3826 may be obtained from, for example, FSIF 9c and may be presented as a bulleted list of one or more summary phrases 3804, in one or more summary sections 3808 having summary title 3806. Summary 3826 may also be presented in another summary form. Summary sections 3808 and summary phrases 3804 may be displayed in the same order as they appear in the original text. This ordering may be facilitated through the use of a unique identifier which may be assigned to each sentence or phrase by core component 104, for example during process 2400.

Depending on the length of summary 3826, it may not appear in full in summary window 3802 at one time. User may scroll through summary 3826 using scrollbar at 3810, as is known to Microsoft Windows (trade-mark) applications. It is to be understood that scrolling through summary 3826 may be implemented in any form, including the use of buttons, sliders or user input of information.

Summary control 3816 may allow specifying characteristics of summary 3826. Exemplary characteristics may include the length of the summary (for example as a percentage of the length of document 9 or FSIF 9c, or as a total number of phrases) The number of phrases to be displayed in summary window 3802 maybe determined as a potentially adjustable percentage of sentences from the overall number of non-redundant sentences in the document. Summary control 3816 may allow user 5 to adjust one or more of such characteristics. In one embodiment, summary control 3816 may allow user 5 to control the length of summary 3826 as a percentage of document 9 or FSIF 9c. The current percentage may be displayed at summary reduction factor 3818. User 5 may be able to increase the length of the summary by using increase summary control 3820 or decrease the length of summary 3826 using decrease summary control 3822. Increase summary control 3820 and decrease summary control 3822 may be implemented in any form, including buttons, sliders, or user input of information. Adjusting the percentage may immediately alter summary 3826 or may require further interaction or processing.

Close window button 3824 may be substantially like a Microsoft Windows (trade-mark) application button that closes a window.

FIGS. 39a-b are displays 3900 for an implementation of points of interest in accordance with an embodiment of the present invention. Points of interest may be implemented, for example, by autosummary component 107 or preparser component 106a. Either or both of such components may embed information in SIF 9b to indicate points of interest that may later be identified by renderer 35, for example, to create and show display 3900. Display 3900 may be a user interface, such as an embodiment of UI 28, that comprises key figures area 3902 which may further comprise one or more key figures 3904 having descriptors 3906, key word area 3912 which may further comprise one or more key words 3914 and scroll bar 3916, and selected interest point area 3908 which may further comprise close window button 3910.

Displays 3900 may present to user 5 items, or points of interest, from an original document. Such may occur, for example, with respect to items that may be difficult for a user to retain when reading the document according to one aspect of the present invention. In such an embodiment, display 3900 may be presented after user 5 has read the document, and can serve as a reminder of key words, key figures and other points of interest from a document such as document 9 or FSIF 9c. Display 3900 may present, for example, proper names, dates, numbers, tables, figures, and images, some of which may not be easily read using the reading functionality of system 20. Items, or points of interest, may be organized into one or more categories based on their format, content or other characteristics. In one embodiment, the items are organized into two groups: key figures and key words.

Key figure area 3902 may present one or more key figures. Such figures may be identified from an original document and may be identified, for example, by core components 104 while being parsed. Identification may involve, for example, inserting an identifier in SIF 9b, by core component 104 as SIF 9b is being parsed into FSIF 9c. Key figures may include figures, images, tables, appendices, bibliographies or other graphical or non-textual items. Key figures may be presented, in key figure area 3902, using thumbnails or icons (as at 3904) or in another graphical fashion, and may have a descriptor 3906 associated therewith, which may provide textual information about the key figure, such as a name or other descriptor.

Icons 3904 and/or descriptor 3906 may also allow a user to control display 3900 and key figure area 3902. For example, a user may interacting with them in any way such as by touching them using a touch-screen device or using a computer mouse to point and click. This may display the key figure in selected interest point area 3908, as described herein. Icons 3904 and/or descriptor 3906 may further allow user 5 to access further functionality, such as by right-clicking a mouse over them and selecting from a list of menu items. Such functionality may include, for example, conducting a search of web pages (or other media) on the Internet (or other communications networks 24 and storage 58) for references to the item corresponding to 3904 or to its descriptor 3906.

Key figure area 3902 and/or display 3900 may further comprise close window button 3922, which may be substantially similar to buttons in Microsoft Windows (trade-mark) that close windows.

Key word area 3912 may present one or more key words 3914. Such words may be identified from an original document and may be identified, for example, by core components 104 while being parsed. Identification may involve, for example, inserting an identifier in SIF 9b, SIF 9b is being parsed into FSIF 9c. Key words 3914 may include proper names, places, dates, numbers (all types), email addresses, equations, and URLs. Key words 3914 may be presented, in key word area 3912 in textual or in another graphical fashion. Key words 3914 in key word area 3912 may also allow a user to control display 3900. For example, a user may select a key word which may cause it to be displayed in selected interest point area 3908, as described herein. Key word area 3912 may further comprise scrollbars 3920 which may be substantially as known in Microsoft Windows (trade-mark) applications. It is to be understood that key figure area 3902 and selected point of interest area 3908 may also have scrollbars 3920, although they are not shown. Such may depend on, for example, whether there is more information to be shown that can be shown without scrolling. Key words 3914 may further allow user 5 to initiate other functionality. This may be accomplished, for example, by right clicking on them to access a menu of functionality (not shown). Such functionality may include allowing user 5 to conduct a search of web pages (or other media) on the Internet (or other communications networks 24 and storage 58) for references to key word 3914.

Selected interest point area 3908 may present, in greater detail, one or more points of interest. Selected interest point area 3908 may further allow user 5 to access further functionality as described herein—such as initiating a web search for related content. Selected interest point area 3908 may display a selected key word 3914 or key figure such as via icon 3904. It is to be understood that selected interest point area 3908 may essentially operate to provide more details about a selected point of interest. The exact details, the manner selected interest point area 3908 is opened or initiated, and the functionality user 5 may have as a result of selected interest point area 3908 can vary substantially while remaining within the scope of the present invention. It is to be understood that selected interest point area 3908 may be closed, never opened, not visible, or not covering any portion of display 3900. Such an embodiment may be shown at FIG. 39b. This may allow, for example, user 5 to more clearly see all of the points of interest on display 3900.

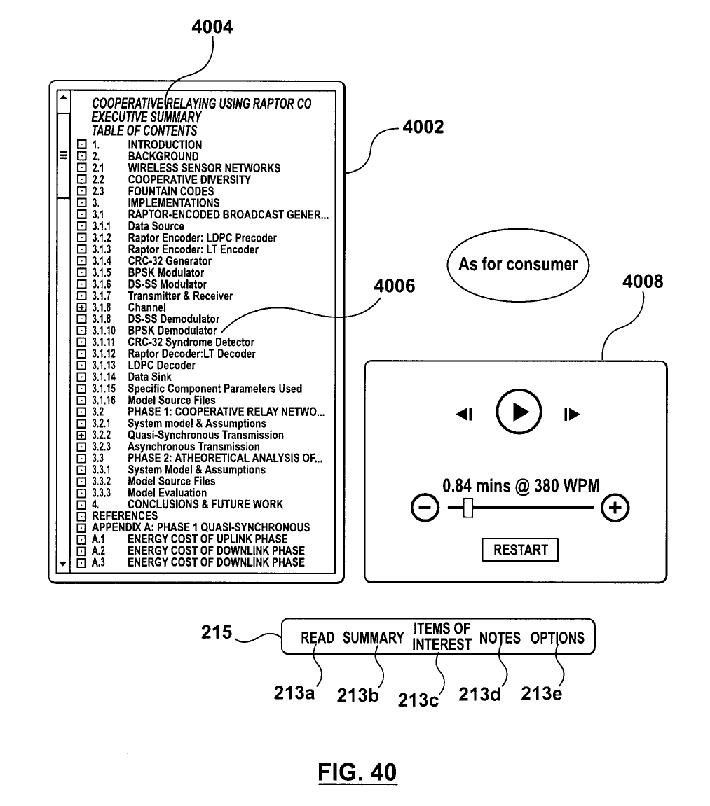

FIG. 40 is a display for an implementation of a system in accordance with an embodiment of the present invention. Display 4000 comprises cluster from file 230, reading options bar 4008, items of interest window 4002 which further comprises one or more document map items 4004 and one or more sections 4006, and navigation bar 215. Cluster from file 230 and the portion of display 4000 it is on, and navigation bar 215 may be substantially as described herein.

Reading options bar 4008 may comprise one or more user interface elements or controls that allow a user to affect their reading of a document 9 or content 10 such as from an FSIF 9c. Reading options bar 4008 may comprise any one or more of the elements of FIGS. 2A-C such as display component 224, software application 234, menu options 236, sidebar 238, page indicator 240, software application UI 242, scroll bars 244, and parsing display 246, as described herein and with respect to FIGS. 2A-C. It is to be understood that reading options bar 4008 may comprise any type of user interface element that may be used to affect or alter any aspects of reading an FSIF 9c.

Document map window 4002 may present user 5 with one or more document map items 4004 and/or sections 4006. Document map window for example via document map items 4004 and/or sections 4006 may allow user 5 to know where they are in FSIF 9c that they are reading. This may be accomplished, for example, by section 4006 that the user is currently reading, being differently indicated than other sections 4006. For example, section 4006 being read may be indicated, in document map window 4002, in bold or another color of font, though it is to be understood that many ways of indicating may be employed. Further, document map window 4002, for example via document map items 4004 and/or sections 4006, may allow user 5 to select the next section 4006 they wish to read. User 5 may select and begin reading another section 4006 at any time, and may do so, for example by clicking on section 4006 that they wish to read.

Although both shown in FIG. 40, document map window 4002 and cluster from file 230 may only be visible at different times. By way of example, if computing device 26 has a small screen, only one or the other may be visible. User 5 may be able to interact with computing device 26 to select between reading and viewing document map window 4002 and may still be able to select section 4006, when document map window 4002 is visible, and have cluster from file 230 be displayed and begin allowing user 5 to read FSIF 9c. Continuing with the example of computing device 26 having a small screen, if a user is reading FSIF 9c, they may select to view document map window 4002 to allow them to see where they are within the document. Instead of selecting a new section 4006 to read, user 5 may simply return to reading the section they are currently reading, knowing where they are in the document. As a further example, document map window 4002 may automatically be displayed during reading of FSIF 9c. This may occur, for example, each time a section is finished when reading.

If computing device 26 has a large screen, both document map window 4002 and cluster from file 230 may be displayed. This may allow user 5 to more easily determine what section they are reading—as they are reading the section. User 5 may then also be more easily able to select a new section 4006 to read. Although it is contemplated that both document map window 4002 and cluster from file 230 may be displayed if a screen permits, this may be configurable by any of the software components, user 5 or based on other factors, for example, FSIF 9c that is being read.

Section 4006 may be an indicator of a section in the document. Section 4006 may have been identified by one or more of preparser component 106a, converter component 102, or any other software component. Such identification may have been accomplished, for example, by embedding information in SIF 9a, resulting in SIFE 9b, or by embedding information in FSIF 9c. Section 4006 may be identified by referring to header information embedded in the original document 9 (such as header or other information in a Microsoft Word (trade-mark) document) or by noting a text that may actually be a section (such as when a creator of document 9 uses bold fonts, different font sizes, or other ways to identify a section instead of using headers that are part of an application such as Microsoft Word).

Document map items 4004 may be an indicator of other non-standard textual information in the document. Document map items may include a table of contents, an executive summary, an appendix, tables, figures, or any other such information. Document map items may be identified similarly to sections 4006. It may be possible to specify what non-standard textual information is to be included as either one or more document map items 4004 or one or more sections 4006. Such may be a configurable setting, such as configurable by user 5, or may be set in software, which may result in it being configurable only in creating or installing software.

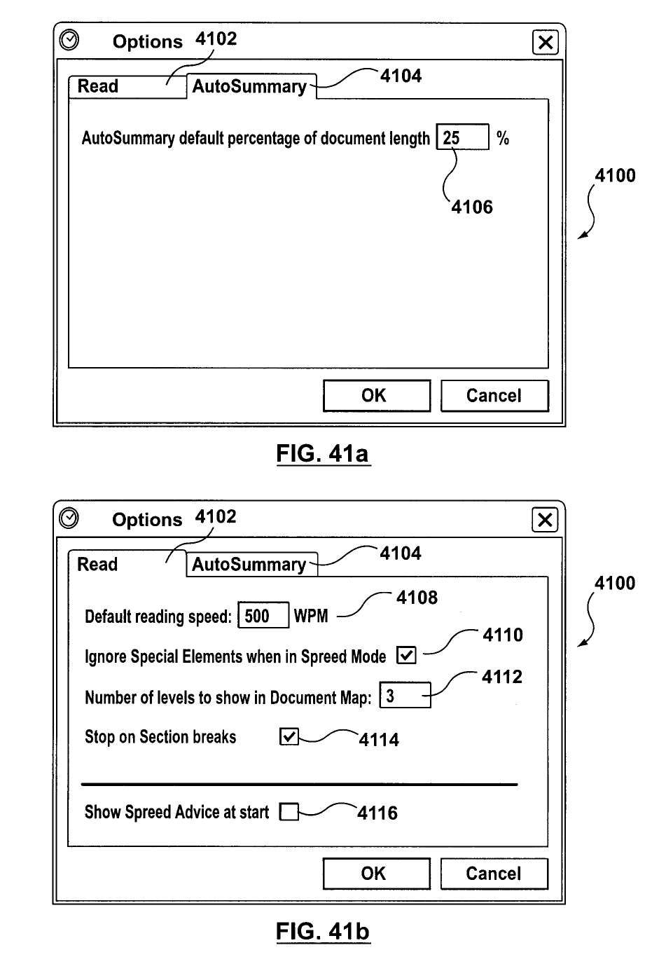

FIGS. 41a and 41b show two different option screens 4100 for a computing device implementation of the system in accordance with an embodiment of the present invention. Screens 4100 may replace all or portions of options window 1100, augment options window 1100, or be integrated therewith. Integration may include, for example, options tabs 4102, 4104, relating to reading and autosummary configurations respectively, substantially being one or more of tabs 1102, 1104, 1106, 1108, 1110.

Option screens 4100 may enable user 5 to configure operation of various other software components, or functionality, of system 20 such as renderer component 35 (which may control, for example, the way any of the UIs 28 or screens described herein are displayed, for example with respect to their color, font, size, positioning and other characteristics), autosummary component 107 (allowing configuration of, for example, how long the summary may be relative to the original document being summarised), and ad integration component 1340 (allowing configuration of, for example, frequency of ads, location of ads, size of ads and other characteristics of ads—although it is to be understood that such settings may only be configurable by non-users such as manufacturers and may only be altered, for example, through software updates). Such configuration settings may be described, for example, with respect to Tables 1, 2 and 3.

Option screens 4100 may further comprise one or more user interface elements that enable the user to configure software components or alter functionality. Exemplary user interface elements comprise autosummary percentage 4106 reading speed 4108, ignore special elements 4110, document map levels 4112, section break stop 4114, and show reading device 4116. Any one or more of such user interface elements may display, or allow configuration of, any one or more configuration settings (that may be described with respect to Tables 1-3). Such user interface elements in FIGS. 41a-b may be substantially similar to aspects of FIGS. 14A-C that may similarly display or allow configuration of any one or more configuration settings.

It is to be understood that the screens shown in FIGS. 41a-b are exemplary only. Various configuration settings, as shown in FIGS. 14A-B, FIGS. 41a-b and Tables 1-3 may be configurable by a user, such as using screens in these figures, or may simply be configurable settings that software or various processes access to alter functioning (as described herein and with respect to processes such as process 2400 or process 2000). It is to be understood that as configuration settings and user configurable options change, so might the configurations settings files and the screens used to provide user configurable options. All of such variations are considered within the scope of the present invention.

While the foregoing invention has been described in detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

1-17. (canceled)

18. A computer implemented method for parsing text from an input data source into clusters for display, said method comprising the steps of:
(i) receiving text from an input data source;
(ii) parsing said text into a cluster by adding consecutive words or elements from a character stream to said cluster until one or more predetermined cluster maximums are exceeded;
(iii) removing a last word from the cluster until said cluster maximums are no longer exceeded;
(iv) applying predetermined grammar rules to a last word and a second last word of the cluster and further removing one or more last words from the cluster if required according to said predetermined grammar rules; and
(v) repeating steps (ii)-(iv) until text has been formed into clusters.

19. A method as claimed in claim 18, wherein said step of applying said grammar rules includes the step of querying whether the second last word is a conjunction.

20. A method as claimed in claim 18, wherein said step of applying said grammar rules includes the step of querying whether the second last word is a pronoun.

21. A method as claimed in claim 18, wherein said step of applying said grammar rules includes the step of querying whether the second last word is a possessive word.

22. A method as claimed in claim 18, wherein said step of applying said grammar rules includes the step of querying whether the second last word is an article.

23. A method as claimed in claim 18, wherein said step of applying said grammar rules includes the step of querying whether the last word is a select preposition and, if so, querying whether the second last word is selected from the group of a conjunction, a pronoun, a possessive word or an article.

24. A method as claimed in claim 18, wherein said step of applying said grammar rules includes the step of querying whether the last word is a conjunction and, if so, querying whether the second last word is selected from the group of a select pronoun, a possessive word or an article.

25. A method as claimed in claim 18, wherein said step of applying said grammar rules includes the step of querying whether the last word is a select pronoun and, if so, querying whether the second last word is selected from the group of a possessive word or an article.

26. A method as claimed in claim 18, wherein said step of applying said grammar rules includes the step of querying whether the last word is a possessive word and, if so, querying whether the second last word is an article.

27. A method as claimed in claim 18, wherein following step (i) and prior to step (ii), said method further comprising the step of converting said text from said input data source to a desired format for further processing and wherein steps (ii)-(v) are performed using said converted text.

28. A computer readable medium containing a set of instructions for instructing a computing device to perform a method for parsing text from an input data source into clusters for display, said method comprising the steps of:
(i) receiving text from an input data source;
(ii) parsing said text into a cluster by adding consecutive words or elements from a character stream to said cluster until one or more predetermined cluster maximums are exceeded;
(iii) removing the last word from the cluster until said cluster maximums are no longer exceeded;
(iv) applying predetermined grammar rules to last word and second last word of the cluster and further removing one or more last words from the cluster if required according to said predetermined grammar rules; and
(v) repeating steps (ii)-(iv) until text has been formed into clusters.

29. A computer readable medium as claimed in claim 28, wherein said step of applying said grammar rules includes the step of querying whether the second last word is a conjunction.

30. A computer readable medium as claimed in claim 28, wherein said step of applying said grammar rules includes the step of querying whether the second last word is a pronoun.

31. A computer readable medium as claimed in claim 28, wherein said step of applying said grammar rules includes the step of querying whether the second last word is a possessive word.

32. A computer readable medium as claimed in claim 28, wherein said step of applying said grammar rules includes the step of querying whether the second last word is an article.

33. A computer readable medium as claimed in claim 28, wherein following step (i) and prior to step (ii), said method further comprising the step of converting said text from said input data source to a desired format for further processing and wherein steps (ii)-(v) are performed using said converted text.

34. A computing device including a computer readable medium containing a set of instructions for instructing the computing device to perform a method for parsing text from an input data source into clusters for display, said method comprising the steps of:
(i) receiving text from an input data source;
(ii) parsing said text into a cluster by adding consecutive words or elements from a character stream to said cluster until one or more predetermined cluster maximums are exceeded;
(iii) removing the last word from the cluster until said cluster maximums are no longer exceeded;
(iv) applying predetermined grammar rules to last word and second last word of the cluster and further removing one or more last words from the cluster if required according to said predetermined grammar rules; and
(v) repeating steps (ii)-(iv) until text has been formed into clusters.

35. A computing device as claimed in claim 34, wherein said step of applying said grammar rules includes the step of querying whether the second last word is a conjunction.

36. A computing device as claimed in claim 34, wherein said step of applying said grammar rules includes the step of querying whether the second last word is a pronoun.

37. A computing device as claimed in claim 34, wherein said step of applying said grammar rules includes the step of querying whether the second last word is a possessive word.

38. A computing device as claimed in claim 34, wherein said step of applying said grammar rules includes the step of querying whether the second last word is an article.

39. A computing device as claimed in claim 34, wherein following step (i) and prior to step (ii), said method further comprising the step of converting said text from said input data source to a desired format for further processing and wherein steps (ii)-(v) are performed using said converted text.
